(19) United States
(12) Patent Application Publication
(10) Pub. No.: US 2007/0203949 A1
(43) Pub. Date: Aug. 30, 2007

(54) PARTS MARKING SYSTEM AND METHOD

(76) Inventors: Nancy Regan, Madison, AL (US); Mitchell R. Friedman, Flemington, NJ (US); John S. Goolsby, Huntsville, AL (US); Jinxiu S. Knoll, Tony, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/684,364

(22) Filed: Mar. 9, 2007

Related U.S. Application Data
(60) Provisional application No. 60/780,528, filed on Mar. 9, 2006.

(51) Int. Cl. G06F 7/00

(52) U.S. Cl. 707/104.1

(57) ABSTRACT

A parts marking system has memory for storing data indicative of at least one algorithm associated with at least one direct parts marking (DPM) technique and logic that displays a graphical user interface comprising at least one text field associated with at least one function, functional failure, failure mode, and failure effect associated with the at least one DPM technique.

### CROSS-REFERENCE

This application claims priority to U.S. Provisional Application No. 60/780,528, entitled “Parts Marking System and Method,” filed on Mar. 9, 2006, which is incorporated herein by reference.

### BACKGROUND

Oftentimes, large entities, e.g., a government or a large corporation, manage and maintain numerous assets such as fleets of vehicles or other heavy equipment, e.g., delivery trucks or tanks. In so managing and maintaining, these large entities sometimes find it difficult to gather and retain complete and reliable information for life cycle management of property and equipment. Thus, such entities are oftentimes unable to determine that all assets are reported, verify the existence of inventory, substantiate the amount of reported inventory and property, or optimally use historical information for physical asset management.

In light of the foregoing, it is difficult for the large entities to achieve goals of financial reporting and accountability, e.g., legislative goals set for government entities related to financial reporting, accountability, and life cycle management. In this regard, the entities are oftentimes unable to know the quantity, location, condition, and value of assets it owns, safeguard its assets from physical deterioration, theft, loss, or mismanagement, prevent unnecessary storage and maintenance costs or purchase of assets already on hand, and determine the full costs of programs that use these assets, e.g., government programs.

Thus, it is possible that those who manage government assets are not receiving accurate information for making informed decisions about future funding, oversight of federal programs involving inventory, and operational readiness.

As an example, each vehicle in a large fleet is made up of a plurality of parts, each of which is owned and inventoried by the entity. However, information related to parts used in maintenance or parts that are already installed on vehicles can be difficult to track.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a part marking system (PMS) in accordance with an exemplary embodiment of the present disclosure.

FIG. 2 depicts exemplary implementation data, algorithms, and marking options for use in the PMS of FIG. 1

FIG. 3 depicts exemplary marking options for use in the PMS of FIG. 1.

FIG. 4 is a block diagram illustrating a more detailed depiction of the parts marking system of FIG. 1.

FIG. 5 is a depiction of an exemplary facilitator menu graphical user interface (GUI) of the parts marking system of FIG. 2.

FIG. 6 is a depiction of an exemplary Add/Search GUI of the parts marking system of FIG. 2.

FIG. 7 is a depiction of an exemplary “When to Mark Part” GUI of the parts marking system of FIG. 2.

FIG. 8 is a depiction of an exemplary “Main” GUI of the parts marking system of FIG. 2.

FIG. 9 is a depiction of an exemplary “Part Number Status Lists” GUI of the parts marking system of FIG. 2.

FIG. 10 is a depiction of an exemplary “Approval Status Update” GUI of the parts marking system of FIG. 2.

FIG. 11 is a depiction of an exemplary parts marking procedure generated by the parts marking system of FIG. 2.

FIG. 12 is a depiction of an exemplary “Compare and Transfer Data” GUI of the parts marking system of FIG. 2.

FIG. 13 is a depiction of an exemplary “General” GUI of the parts marking system of FIG. 2.

FIG. 14 is a depiction of an exemplary “Label Analysis” GUI of the parts marking system of FIG. 2.

FIG. 15 is a depiction of an exemplary “Information Worksheet” GUI of the parts marking system of FIG. 2.

FIG. 16 is a depiction of an exemplary “Label Consequences” GUI of the parts marking system of FIG. 2.

FIG. 17 is a depiction of an exemplary Direct Parts Marking (DPM) GUI of the parts marking system of FIG. 2.

FIG. 18 is a depiction of an exemplary DPM algorithm GUI of the parts marking system of FIG. 2.

FIG. 19 is a depiction of an exemplary “Enter Decision” GUI of the parts marking system of FIG. 2.

FIG. 20 is a depiction of an exemplary advantages versus limitations GUI corresponding to laser bonding of the parts marking system of FIG. 2.

FIG. 21 is a flowchart illustrating an exemplary parts marking process performed using the parts marking system of FIG. 2.

FIG. 22 is a flowchart illustrating exemplary architecture and functionality of parts marking logic of the parts marking system of FIG. 2.

FIG. 23 is a depiction of another exemplary “Main” GUI entitled “Edit Parts Marking Record Page” of the parts marking system of FIG. 2.

FIG. 24 is a depiction of a “Record Status History” GUI of another embodiment of the parts marking system of FIG. 2.

FIG. 25 is a depiction of a “Parts marking procedure History” GUI of another embodiment of the parts marking system of FIG. 2.

FIG. 26 is a depiction of a “Historical Date Tracking” GUI of another embodiment of the parts marking system of FIG. 2.

FIG. 27 is depiction of another “General” GUI of another embodiment of the parts marking system of FIG. 2.

FIG. 28 is a depiction of an “Other PN” GUI of another embodiment of the parts marking system of FIG. 2.

FIG. 29 is a depiction of an “Excel Spreadsheet Check” GUI of another embodiment of the parts marking system of FIG. 2.

FIG. 30 is a depiction of a “Master: Form” GUI of another embodiment of the parts marking system of FIG. 2.

FIG. 31 is a depiction of another exemplary “DPM” GUI of another embodiment of the parts marking system of FIG. 2.

FIG. 32 is a depiction of another exemplary “DPM” GUI of another embodiment of the parts marking system of FIG. 2 exhibiting a “CHEM ETCH” analysis area.

FIG. 33 is a depiction of another exemplary “DPM” GUI of another embodiment of the parts marking system of FIG. 2 exhibiting a “DOT PEEN” analysis area.

FIG. 34 is a depiction of another exemplary “DPM” GUI of another embodiment of the parts marking system of FIG. 2 exhibiting a “LASER ETCH” analysis area.

FIG. 35 is a depiction of another exemplary “DPM” GUI of another embodiment of the parts marking system of FIG. 2 exhibiting an “INK JET” analysis area.

FIG. 36 is a depiction of another exemplary “DPM” GUI of another embodiment of the parts marking system of FIG. 2 exhibiting an “INK STENCIL” analysis area.

FIG. 37 is a depiction of another exemplary “DPM” GUI of another embodiment of the parts marking system of FIG. 2 exhibiting a “LASER BOND” analysis area.

FIG. 38 is a depiction of another exemplary “DPM FMEA” GUI of another embodiment of the parts marking system of FIG. 2.

FIG. 39 is a flowchart illustrating exemplary architecture and functionality of parts marking logic of the parts marking system of FIG. 2.

FIG. 40 is a depiction of an exemplary “System, Subsystem, Parent-Child Info” GUI of another embodiment of the parts marking system of FIG. 2.

FIG. 41 is a block diagram depicting a parts marking server system in accordance with an embodiment of the present disclosure.

FIG. 42 is a block diagram illustrating a more detailed depiction of the parts marking server of FIG. 41.

FIG. 43 depicts an exemplary “Add/Search” GUI of the parts marking server of FIG. 41.

FIG. 44 depicts an exemplary search result listing GUI of the parts marking server of FIG. 41.

FIG. 45 depicts an exemplary “Item Details” GUI of the parts marking server of FIG. 41.

FIG. 46 depicts an exemplary “Candidate Analysis” GUI of the parts marking server of FIG. 41.

FIG. 47 depicts an exemplary label analysis main GUI of the parts marking server of FIG. 41.

FIG. 48 depicts an exemplary label analysis listing GUI of the parts marking server of FIG. 41.

FIG. 49 depicts an exemplary label analysis GUI of the parts marking server of FIG. 41.

FIG. 50 depicts an exemplary label information worksheet GUI of the parts marking server of FIG. 41.

FIG. 51 depicts an exemplary DPM analysis main GUI of the parts marking server of FIG. 41.

FIG. 52 depicts an exemplary “Update Tool” GUI of the parts marking server of FIG. 41.

FIG. 53 depicts an exemplary “Parts Marking Procedure Reports” GUI of the parts marking server of FIG. 41.

FIG. 54 depicts an exemplary “Parts Marking Procedure” GUI of the parts marking server of FIG. 41.

FIG. 55 depicts an exemplary print marking GUI of the parts marking server system of FIG. 41.

FIG. 56 depicts an exemplary “Facilitator” GUI of the parts marking server system of FIG. 41.

FIG. 57 depicts a flowchart illustrating exemplary architecture and functionality of the parts marking server system depicted in FIG. 41.

### DETAILED DESCRIPTION

Embodiments of the present disclosure generally pertain to parts marking systems and methods. Specifically, a parts marking system (PMS) of the present disclosure facilitates making optimal choices regarding the application of an identifier on a part, hereinafter referred to as an “object identifier” (OI), e.g., a two-dimensional matrix (“2-D Matrix”), and the object identifier's location on the part. Furthermore, the system facilitates in identifying a technically appropriate parts marking application. Exemplary types of marking applications include, but are not limited to labels, dot peen (DP) marking, laser bond (LB) marking, ink jet (IJ) marking, and chemical etching (CE). Note that such list is not exhaustive and other parts marking applications in other embodiments are possible. Note that label refers to any article that can be attached to an object for identification or description purposes, e.g., a slip, a tag, a data plate, or tape.

When determining whether a label is technically appropriate for a part and determining what type of label is technically appropriate for the part, an exemplary PMS is used to perform a label analysis. A label analysis, among other things, includes identifying functions, functional failures, failure modes, failure effects, and consequences associated with each label analysis. Additionally, the label analysis may include determining where on the part to place a label, where geographically the part will be labeled, and when the label will be placed on the part. Notably, the PMS provides a proactive analysis technique that enables the identification of plausible failure modes related to marking a part with a particular label, so that appropriate action can be identified to manage the consequences of such plausible failure modes.

Furthermore, when determining whether a direct parts marking (DPM) application, e.g., Dot Peen (“DP”) marking, Laser Bond (“LB”) marking, Ink Jet (“IJ”) marking, or Chemical Etching (“CE”) is technically appropriate, an exemplary PMS is used to facilitate a direct parts marking (DPM) analysis. In the DPM analysis, the PMS facilitates selecting options corresponding to particular technical limitations associated with available parts marking applications. Whether a parts marking application is technically appropriate for a particular part depends on a plurality of factors, which are described further herein.

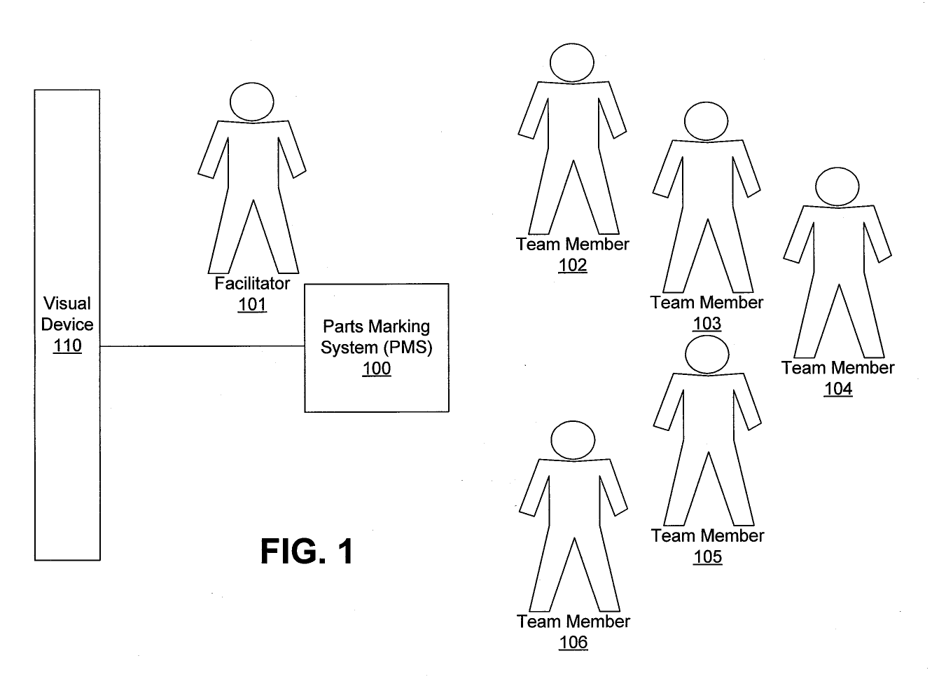

FIG. 1 illustrates a PMS 100 in accordance with an exemplary embodiment of the present disclosure. Prior to beginning a parts marking analysis using the PMS 100 in accordance with an exemplary embodiment, a facilitator 101 and any required team members gather implementation strategy data related to the types of parts that are to be marked, the kinds of materials that the parts will consist of, entity restraints related to the marking of parts, e.g., government regulations or corporate guidelines, monetary factors related to the marking of parts, safety factors, whether the entity desires to track particular parts, and the like. In addition, technical limitations corresponding to specific equipment that may be used to perform DPM techniques is gathered. Such list is not exhaustive, and other types of factors may be considered in other embodiments.

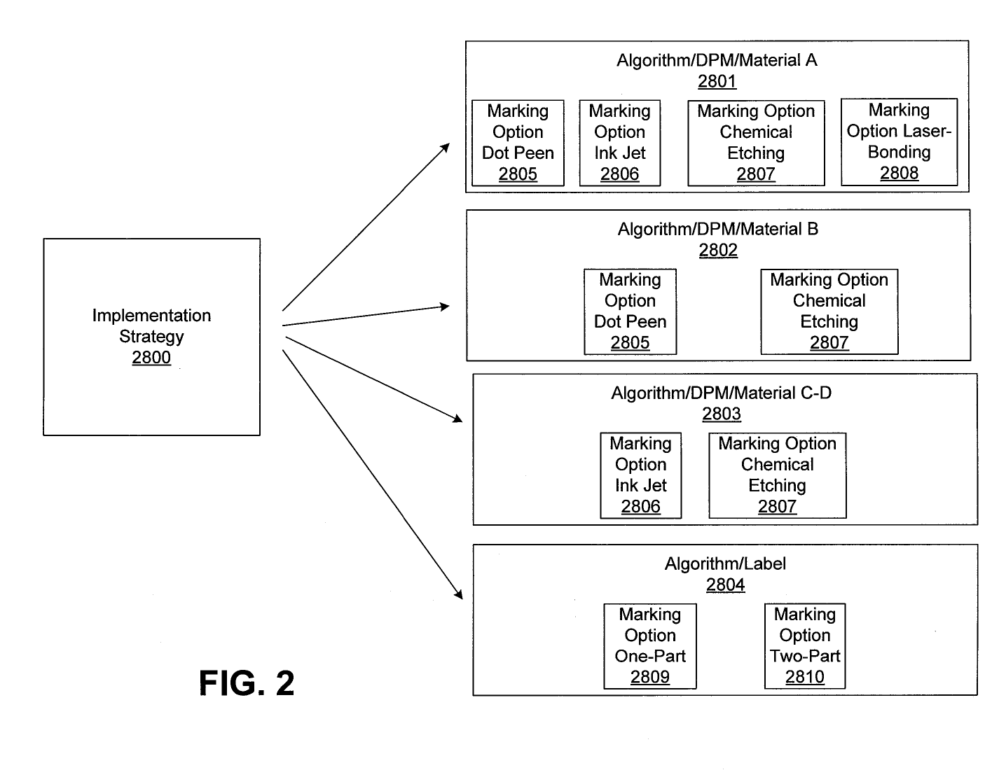

The PMS 100 is then configured to reflect such gathered information, which will now be described in more detail with reference to FIGS. 2-4.

After the PMS system 100 is configured according to the implementation information and strategies, the facilitator 101 gathers with a plurality of team members 102-106. The facilitator 101 requests data identifying a part for analysis, which is described in more detail hereafter, and the facilitator 101 queries the team members 102-106 in accordance with the implementation strategy data with which the PMS system 100 was configured. In this regard, the PMS system 100 provides a plurality of options from which the facilitator 101 may select corresponding to particular factors, as described herein, related to the implementation strategy. The team members 102-106 preferably communicate data corresponding to such requests to the facilitator 101. The number of team members 102-106 shown in FIG. 1 is merely an exemplary number and other numbers of team members are possible in other embodiments.

Notably, the facilitator 101 leads a parts marking analysis for an identified part(s) by requesting particular data from the team members 102-106 associated with the implementation strategies. In particular, the facilitator 101 and the team members 102-106, hereinafter referred to as the PMS team, perform a parts marking analysis so that an optimal marking application and marking location for the identified part is achieved.

As the facilitator 101 queries the team members 102-106, the team members 102-106 provide information corresponding to the queries of the facilitator 101. The facilitator 101 enters data or selects displayed options corresponding to the information provided from the team members 102-106 into the PMS 100. Furthermore, as the facilitator 101 enters the data into the PMS 100, the PMS 100 communicates the entered data to the visual device 110. Such process is described in more detail throughout the present disclosure.

The team members 102-106 preferably comprise a group of individuals who are knowledgeable in a particular technical area directly related to the identified part. For example, if the part that is the subject of the analysis pertains to the aerospace industry, the team members 102-106 may comprise a system engineer, a mechanic, a depot representative, a person responsible for technical publications, a maintenance test pilot, an instructor pilot, a crew member, and/or an original equipment manufacturer (OEM). Such a team comprising the members 102-106 provides a knowledge base relative to the technical area that is being analyzed. Note that the depot is a maintenance area, where particular pieces of equipment are taken, for example, to be overhauled or repaired.

During the course of an analysis by the team members 102-106 and the facilitator 101 using the PMS 100 of the present disclosure, there may be required data identified during the analysis that the team members 102-106 are unable to provide. In such a scenario, the PMS 100 retains information corresponding to the data needed for a complete analysis, so that such data may be sought from other sources, e.g., other experts not on the team.

Prior to initiating the parts marking analysis, the facilitator 101 preferably compiles implementation information and strategies related to a plurality of assets and corresponding parts. Thus, some information related to such parts is already stored in the PMS. For example, the implementation information and strategies may identify a list of parts that are to be marked, including part numbers, common names for the parts, nomenclature related to the parts, and the like. Additionally, the implementation information and strategies may include a list of marking equipment available, for example, dot peen equipment, laser-bonding equipment, chemical etching equipment, and/or ink jet equipment. The marking equipment information may further comprise technical limitations associated with the marking equipment available. Additionally, there may be desired factors associated with marking the selected parts. For example, an entity may desire to mark all parts that cost more than $10,000, mark each part that may result in safety consequences if the part fails, mark each part that may result in environmental consequences if the part fails, or mark each part that the entity desires to track generally. Note that the options for inclusion in the parts marking implementation and strategies noted above are merely exemplary.

Such information and strategies may change and adapt depending upon the use of the PMS 100.

The parts marking analysis preferably comprises numerous parts. For example, the analysis might comprise a label analysis for determining the physical aspects of the label, i.e., one-part label, two-part label, and/or other type of label known in the art and for determining if a label is a possible marking technique for a particular part. Further, the PMS team populates an information worksheet, which includes functions, functional failures, failure modes, and failure effects, as described hereinabove, and a label consequences analysis to determine the consequences of a label falling off of a particular location and any other applicable failure modes. Furthermore, the PMS team might analyze the use of DPM for a particular part, including separately analyzing the use of a particular DPM technique for each part.

FIG. 2 further illustrates how the PMS 100 uses a portion of the implementation strategy data 2800 that is gathered by the facilitator 101 or other individual(s). As described herein, the PMS 100 is to be used by the facilitator 101 and the PMS team to determine how a part will be marked, e.g., a label or via DPM, the location on the part where the part will be marked, and marking instructions technically appropriate for each part.

Further as described herein, the implementation strategy data 2800 comprises data indicating the types of DPM equipment that will be used and the type of labels that may be used to mark particular parts. Furthermore, the implementation strategy data 2800 may comprise data defining the technical limitations of the DPM equipment and/or the technical limitations of the labels. For example, some DPM techniques may only be able to be used on certain types of metals, e.g., aluminum or titanium, or some labels may not be applicable to a part because of the label's technical limitations, e.g., the label's size or the type of adhesive that is used on a particular label.

Therefore, the PMS 100 is configured such that marking options identified in the implementation strategy data 2800 are those desired by the implementing entity, mandated by the available equipment, or necessary for a particular part material and are available for selection by the facilitator 101 as identified by the PMS team. Data that may be identified in implementation information and strategies and used to configure the PMS system 100 will be identified throughout.

As shown in FIG. 2, the implementation strategy data 2800 is preferably used to generate a plurality of algorithms 2801-2804. An “algorithm” in this disclosure is a compilation of technical limitations associated with one or more particular parts marking techniques, and the technical limitations may be expressed in the form of questions having selectable options, e.g., yes/no, 1/0, or the like. The algorithms 2801-2804 are generated based upon the implementation information and strategies, including the type of mark, e.g., label or DPM and the type of equipment that will be used to adhere the mark to the part or directly mark the part in order to determine one or more technically appropriate marking techniques.

Therefore, an exemplary algorithm 2801 may be generated for determining a technically appropriate DPM technique for a part consisting of a particular material, “Material A,” where a plurality of options is available. Note that exemplary materials might be, for example, aluminum, titanium, rubber, composite, or the like. Such list is exemplary, and other types of materials are possible in other embodiments.

For example, the algorithm 2801 indicates that for DPM for a part consisting of Material A, the following marking techniques are available, including a “Dot Peen Marking Option” 2805, an “Ink Jet Marking Option” 2806, a “Chemical Etching Marking Option” 2807, and a “Laser-Bonding Marking Option” 2808. As will be described further herein, while each of these techniques may be available, the parts marking analysis will further indicate, based upon any technical limitations of the equipment or the technique, which of the marking options 2805-2808 is technically appropriate for the particular part.

In another example, the exemplary algorithm 2802 may be generated for determining a technically appropriate DPM technique for a part consisting of a particular material, “Material B,” where only two marking options are available. Notably, the algorithm 2802 indicates that the “Dot Peen Marking Option” 2805 and the “Chemical Etching Marking Option” 2807 are technically possible for “Material B” and so is available for analysis. As described herein, while each of these techniques may be available, the parts marking analysis will further indicate, based upon any technical limitations of the equipment or the technique, which of the marking options 2805 and/or 2807 is technically appropriate and therefore possible for the particular part.

In another example, the exemplary algorithm 2803 may be generated for determining a technically appropriate DPM technique for a part consisting either of “Material C” or “Material D.” In this regard, a particular algorithm 2803 may be used for parts consisting of different kinds of metals. For example, the algorithm 2803 may be used to analyze parts consisting of titanium or consisting of aluminum. The algorithm 2803 indicates two available marking options “Ink Jet” 2806 and “Chemical Etching” 2807.

In another example, the exemplary algorithm 2804 may be generated for determining a technically appropriate label for a part. In this regard, a particular algorithm 2804 may be used to determine whether a “One-Part Label Marking Option” 2809 or a “two-part Label Marking Option” 2810 is desirable. As described further herein, such an algorithm 2804 for determining whether a label should be used and what type of label should be used may include a failure modes and effects analysis, as described further herein.

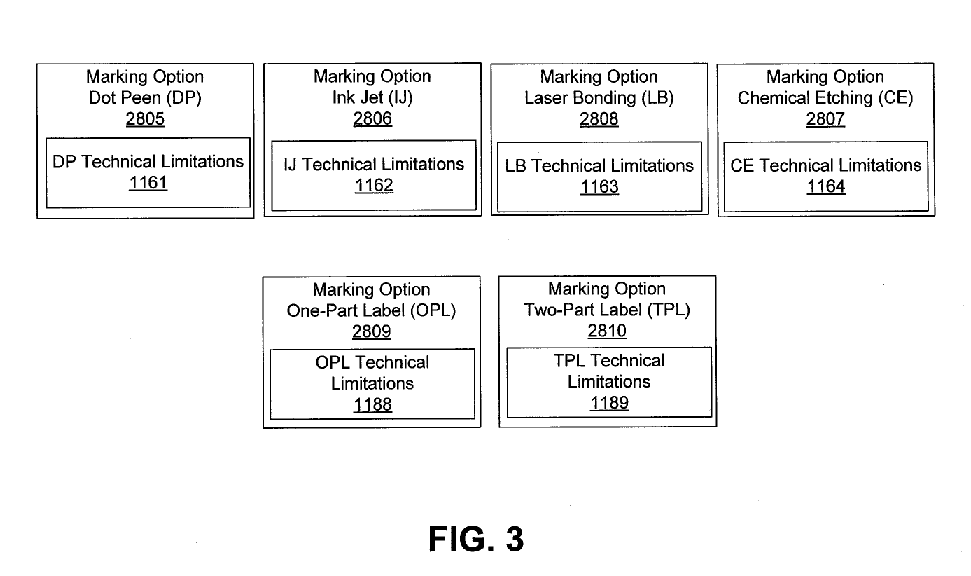

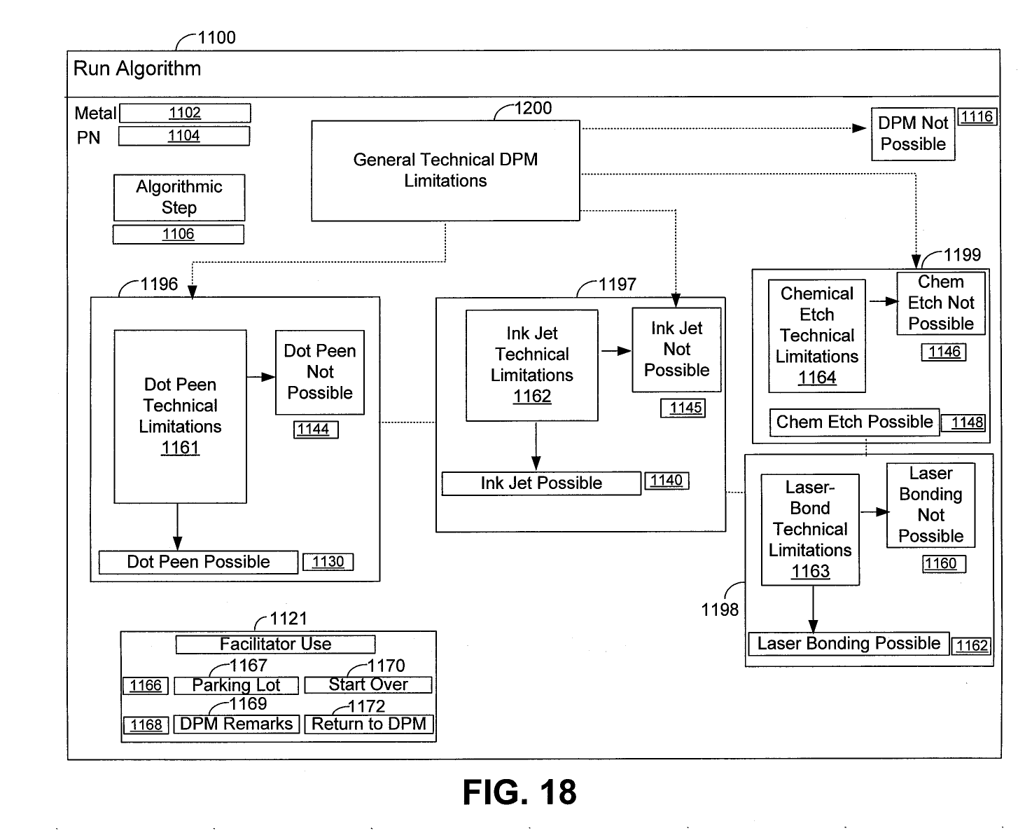

FIG. 3 further describes the marking options 2805-2810. In this regard, each marking option that is available in a particular algorithm 2801-2804 (FIG. 2) further comprises a plurality of technical limitations 1161-1164 and 1188-1189. For example, the “Dot Peen Marking Option” for a particular metal, e.g., aluminum, may only be plausible if the part under analysis is less than or equal to “54” on the Rockwell Hardness C-Scale, if the part is not used in a high pressure operating context, or the part is greater than 0.020 inches thick. Thus each of the foregoing is a “DP Technical Limitation” 1161 corresponding to the particular marking option, e.g., dot peen. Such technical limitations are preferably displayed to the facilitator 101 and/or PMS team in the form of questions and/or statements, which is described in more detail with reference to FIG. 18. Such technical limitations may be associated with a plurality of options for the user to select, e.g., yes/no if the limitation is in the form of a question. Further, however, some technical limitations may be in the form of a statement, and the facilitator 101, with input from the PMS team, enters data addressing such statement. For example, the One-Part Label Technical limitations 1188 may comprise data indicative of failure modes and effects analysis. Technical limitations are described further here.

Furthermore, in each algorithm 2801-2804 there may be general limitations related to DPM. For example, DPM may not be possible if the surface roughness is not between 8 and 250 micro-inches, which may be a general technical limitation to using DPM. Thus, if the marking area can not be prepared for DPM applications, then DPM may not be technically appropriate at all for the particular part and thus not available to the PMS team as a marking option.

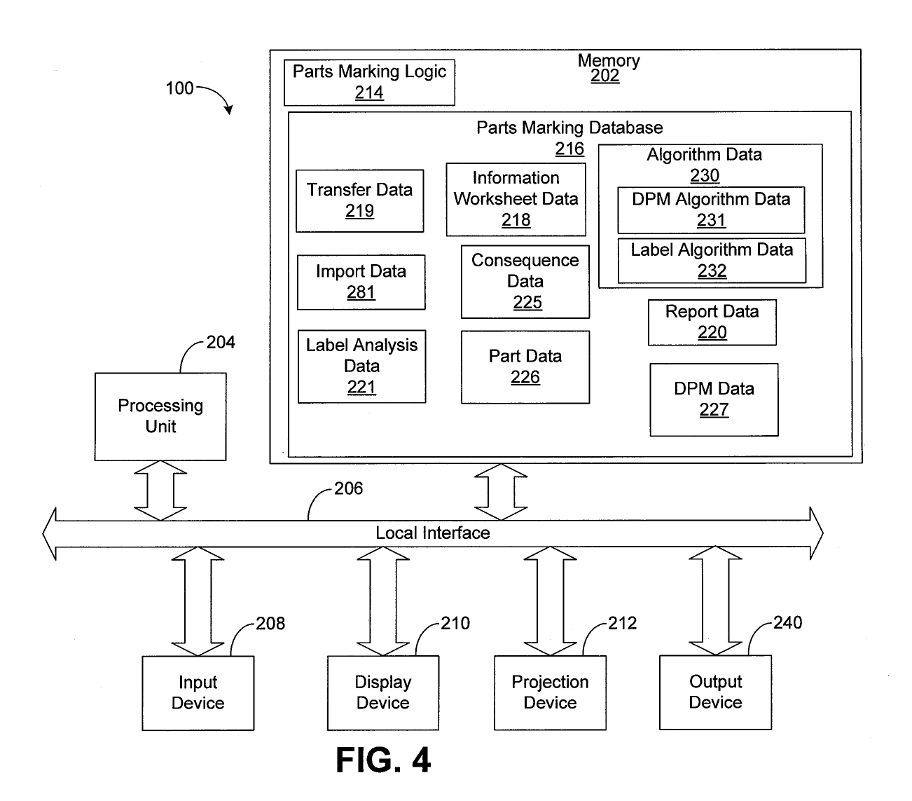

FIG. 4 depicts a PMS 100 in accordance with an exemplary embodiment of the present disclosure. The exemplary PMS 100 generally comprises a processing unit 204, an input device 208, a display device 210, a projection device 212, and an output device 240.

The PMS 100 further comprises parts marking logic (PML) 214 and a parts marking database (PMD) 216. The PMD 216 comprises part data 226, information worksheet data 218, consequence data 225, label analysis data 221, report data 220, transfer data 219, import data 281, DPM data 227, and algorithm data 230. The algorithm data 230 further comprises DPM algorithm data 231 and label algorithm data 232. Each is described further herein.

In the exemplary PMS 100 shown by FIG. 4, the PMD 216 and the PML 214 are implemented in software and stored in memory 202. In other embodiments, any of the foregoing components may be implemented in hardware and/or a combination of hardware and software.

The processing unit 204 may be a digital processor or other type of circuitry configured to run the PML 214 and/or other software components of the PMS 100 by processing and executing the instructions of such components. The processing unit 204 communicates to and drives the other elements within the PMS 100 via a local interface 206, which can include one or more buses. Furthermore, an input device 208, for example, a keyboard, a switch, a mouse, and/or other types of interfaces, can be used to input data from a facilitator 101 of the PMS 100, and display device 210 can be used to output data to the facilitator 101 (FIG. 1).

The PMS 100 may further comprise a projection device 212 that can be connected to the local interface 206. The projection device 212 may capture information that the facilitator 101 enters into the PMS 100 via the input device 208.

An exemplary input device 208 may include, but is not limited to, a keyboard device, serial port, scanner, camera, microphone, or local access network connection. An exemplary display device 210 may include, but is not limited to, a video display.

As noted herein, various components, such as the PML 214 and the PMD 216, are shown in FIG. 4 as software stored in memory 202. Such components can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

As described hereinabove, portions of the data, including the algorithm data 230 and a portion of the part data 226, may be pre-populated based upon the implementation information and strategies 2800 (FIG. 2). Thus, when a parts marking analysis begins, the facilitator 101 may request information identifying a part for analysis, and when the facilitator 101 enters such data, the PML 214 may retrieve data describing the part under analysis from the part data 226 and display the retrieved part data 226 to the display device 210 and the projection device 212. If the PML 214 does not locate data corresponding to the identified part in the part data 226, the facilitator 101 can add a new part to the part data 226 for analysis.

If the PMS team desires to perform a label analysis on the part, the facilitator 101 initiates a label analysis via the input device 208, which is described further herein, and the PML 214 displays label algorithm data 232 to the display device 210. As described hereinabove, the label algorithm data 232 may comprise a series of technical limitations in the form of questions. Further, the algorithm data 232 comprises selectable options corresponding to each of the technical limitations and may include a failure modes and effects analysis and a consequence evaluation, each of which is described further herein.

Thus, the facilitator 101 elicits selections corresponding to the label algorithm data 232 and the facilitator 101 enters such selections via the input device 208. The PML 214 stores such responses in label analysis data 221 for the identified part under analysis. In this regard, label analysis data 221 preferably comprises general data related to attaching a label or labels to the identified part. For example, the label analysis data 221 may comprise data indicative of whether the part is conducive to a two-part label or a one-part label described further herein. Such information is merely exemplary, and other label analysis data 221 is possible in other embodiments. The facilitator 101 enters label analysis data 221 via the input device 208, and the PML 214 stores such label analysis data 221 in memory 202.

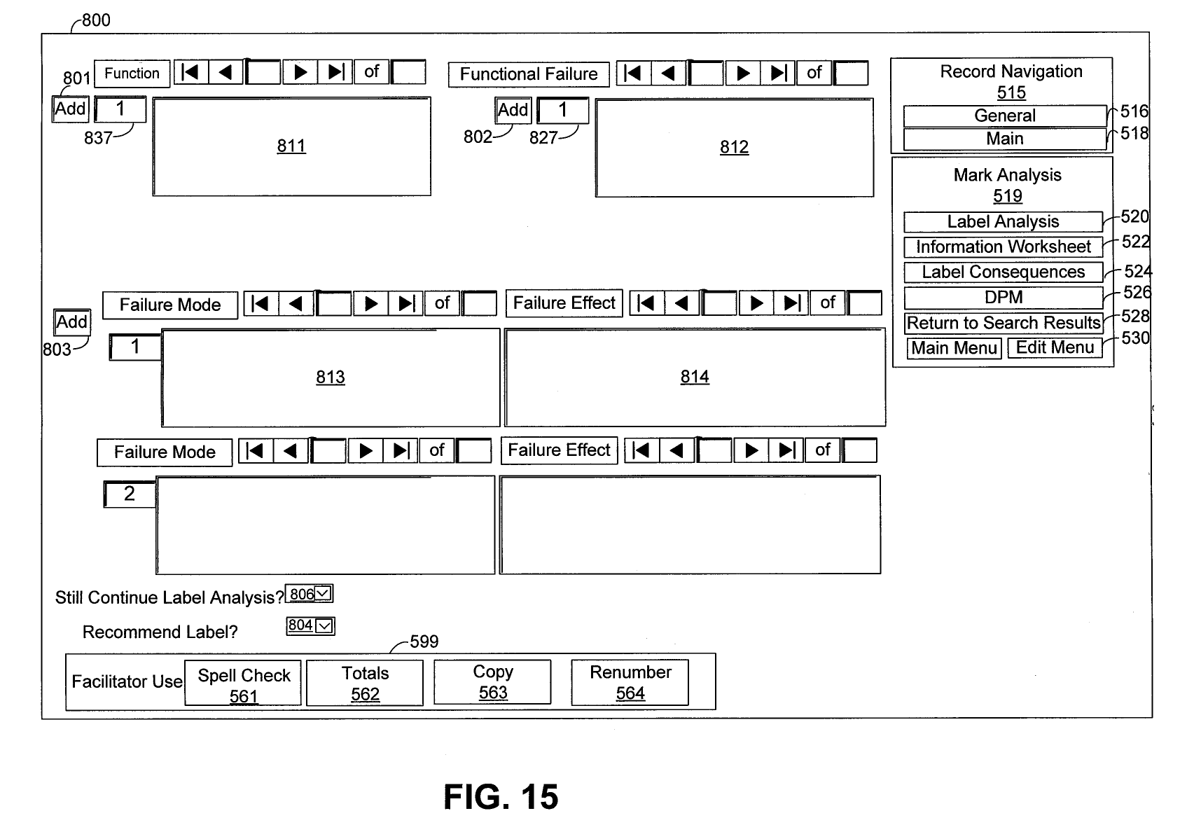

The facilitator 101 elicits information worksheet data 218 from the PMS team corresponding to the identified part. Information worksheet data 218 preferably comprises data identifying functions, functional failures, failure modes, and failure effects corresponding to attaching a label to the identified part. Information worksheet data 218 is described in more detail with reference to FIG. 15. The facilitator 101 enters Information worksheet data 218 via the input device 208, and the PML 214 stores such information worksheet data 218 in memory 202.

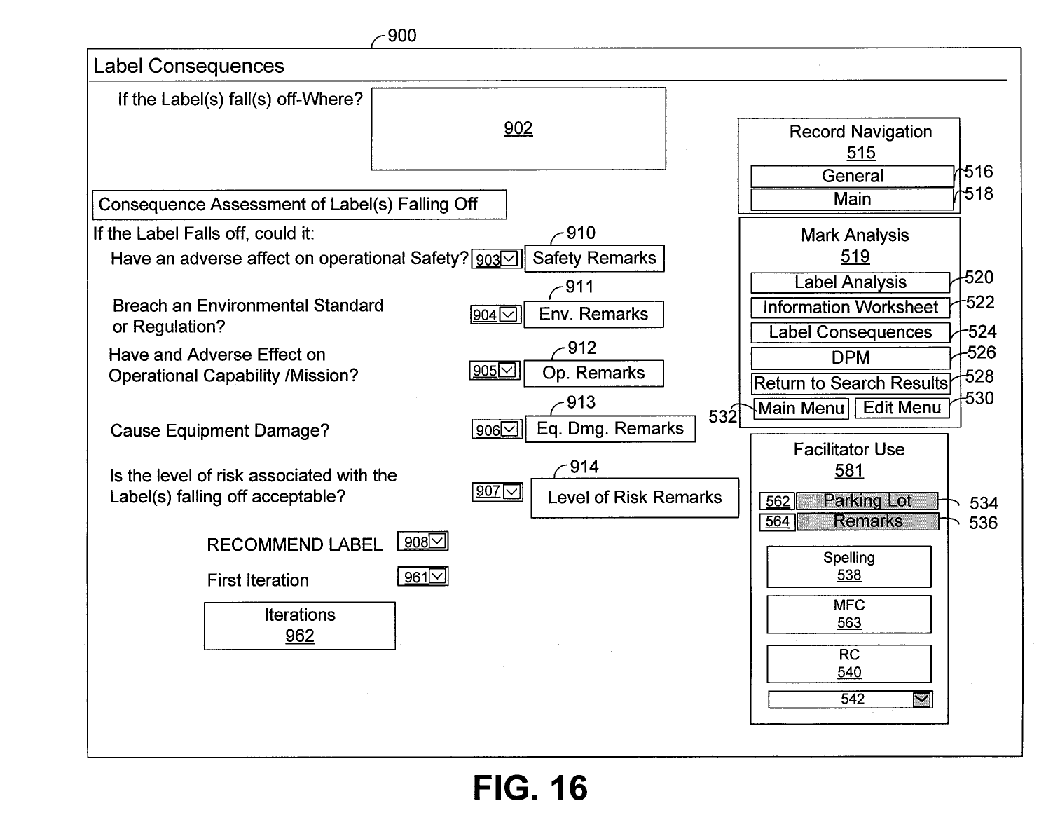

The facilitator 101 elicits consequence data 225 from the PMS team corresponding to the identified part. Consequence data 225 preferably comprises data detailing identified consequences of a label falling off of an identified part and any other applicable failure modes. Consequence data 225 is described in more detail with reference to FIG. 16. The facilitator 101 enters consequence data 225 via the input device 208, and the PML 214 stores such consequence data 225 in memory 202.

If the PMS team desires to perform a DPM analysis on the part, the facilitator 101 initiates DPM analysis via the input device 208, which is described further herein, and the PML 214 displays DPM algorithm data 231 to the display device 210. As described hereinabove, the DPM algorithm data 231 may comprise a series of technical limitations in the form of questions or statements. Further, the DPM algorithm data 231 comprises selectable options corresponding to each of the DPM technique technical limitations.

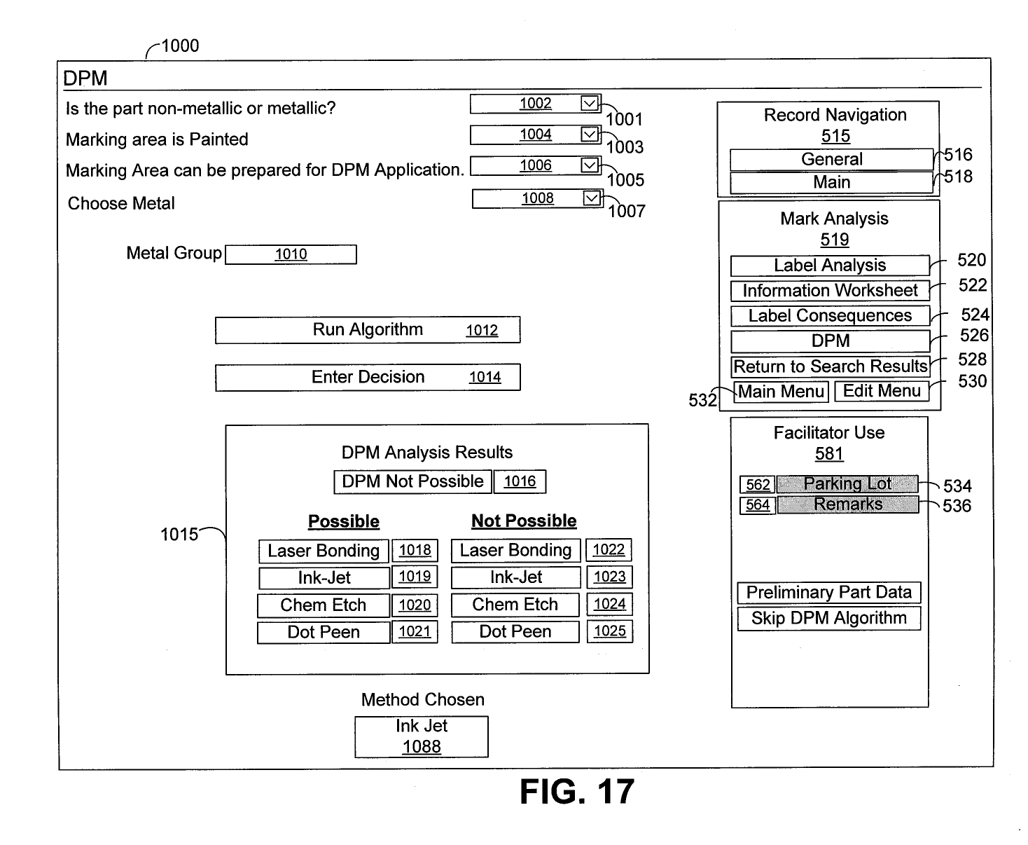

Thus, the facilitator 101 elicits selections corresponding to the DPM algorithm data 231 and the facilitator 101 enters such selections via the input device 208. As described hereinabove, the DPM algorithm data 231 comprises questions corresponding to the materials, environment, and DPM application limitations related to the part. The PML 214 stores such responses in DPM data 227 for the identified part under analysis. In this regard, DPM data 227 preferably comprises general data related to marking a part via one or more DPM techniques. For example, the DPM data 227 may comprise data indicative of whether the part is metallic or nonmetallic, whether the part is coated, and/or what type of metal makes up the identified part. DPM data 227 is described in more detail with reference to FIG. 17. The facilitator 101 enters DPM data 227 via the input device 208, and the PML 214 stores such DPM data 227 in the PMD 216 in memory 202.

As described hereinabove, the DPM algorithm data 231 preferably comprises specific inquiries for determining whether a part is conducive to a particular DPM application, i.e., chemical etching, laser bonding, ink jet marking, dot peen marking, etc. Further, the DPM algorithm data 231 comprises data indicative of which types of DPM techniques are identified for use in the implementation information and strategies for a particular implementing entity. Such data is used in order to configure the PMS 100 specific to each implementing entity, including options related to such inquiries as described hereinabove. DPM algorithm data 231 is described in more detail with reference to FIG. 18. The DPM algorithm data 231 is pre-populated in the PMS 100 prior to a parts marking analysis via the input device 208, and the PML 214 stores such DPM algorithm data 231 in memory 202.

Furthermore, data related to the parts marking analysis is stored in the PMD 216, and the PML 214 generates reports 220 corresponding to the data stored in PMD 216. For example, the PML 214 may generate a report detailing the status of a plurality of parts, e.g., whether the parts have been analyzed, whether an analysis of the parts has been sent to a validating authority, or whether the parts marking analysis and recommendations have been approved by an approval authority.

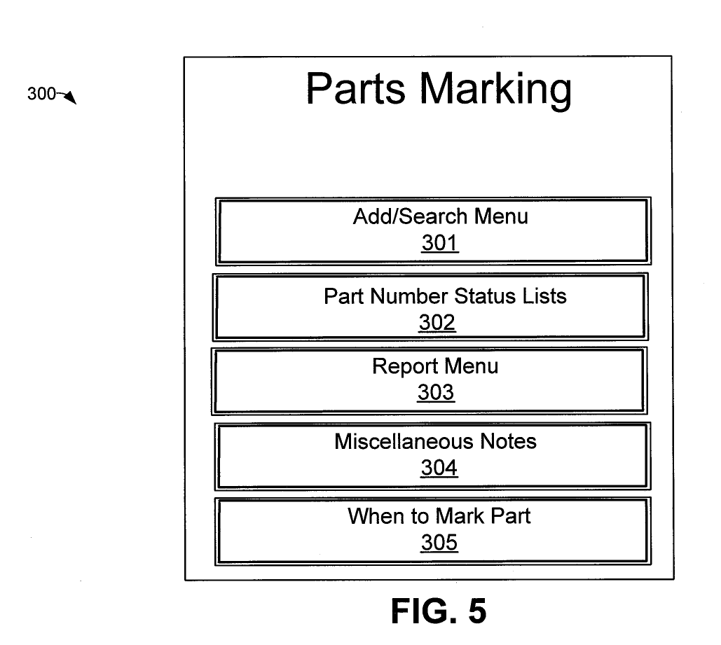

FIG. 5 depicts a graphical user interface (GUI) 300 in accordance with an exemplary embodiment of the present disclosure.

The “Parts Marking” GUI 300 preferably comprises pushbuttons 301-305, and each button 301-305 displays a window, each of which is described further herein, when selected by the facilitator 101 (FIG. 1).

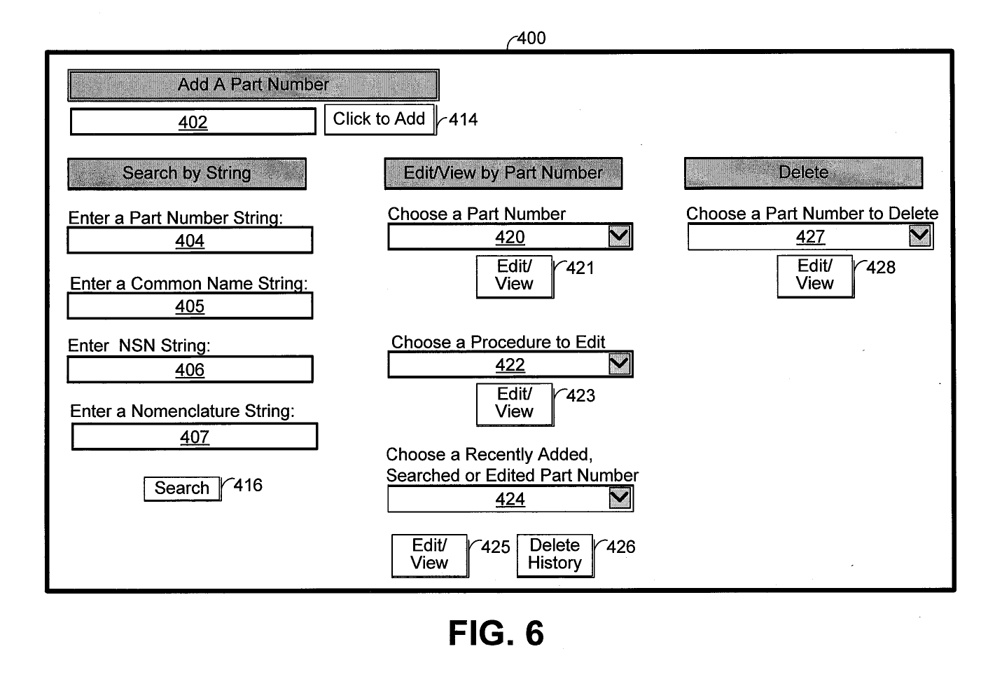

The “Add/Search Menu” pushbutton 301 enables the facilitator 101 to add a particular part and its associated data to the PMD 216 and navigate existing parts stored in the PMD 216. When the facilitator 101 selects the pushbutton 301, the PML 214 displays to the display device 210 an “Add/Search Menu” GUI 400, which is described in more detail with reference to FIG. 6.

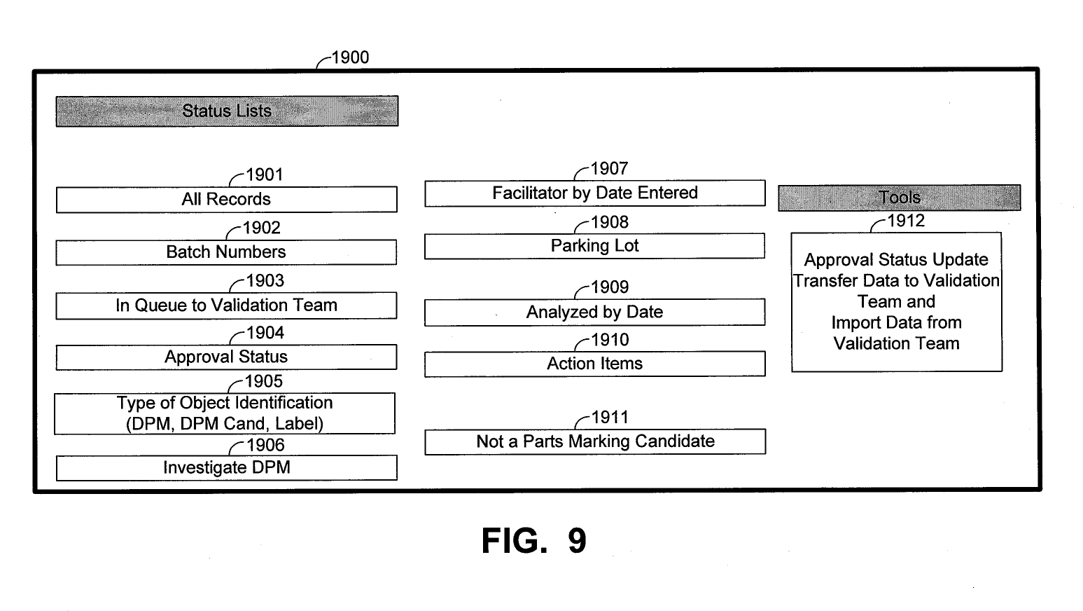

The “Part Number Status Lists” pushbutton 302, when selected, displays a plurality of pushbuttons that enable the facilitator 101 to retrieve lists of part numbers from the PMD 216 based on specific criteria. Thus, the pushbutton 302, when selected, displays a “Status Lists” GUI 1900, as depicted in FIG. 9.

With reference to FIG. 9, the GUI 1900 enables a facilitator 101 to view a plurality of status lists corresponding to a part or a plurality of parts.

The GUI 1900 comprises pushbuttons 1901-1912. The “All Records” pushbutton 1901, when selected, displays a list of parts and corresponding parts marking information and where such part is in an approval process. As described further herein, the PMS 100 is used in order to generate parts marking procedures for a plurality of parts. Such procedures for marking the parts may undergo an approval process, e.g., the team generates the information, a validation team reviews the information, and an approval authority approves the information. Thus, the “All Records” pushbutton 1901 may further display where each part is in the approval process.

The “Batch Numbers” pushbutton 1902 may display, when selected, a window that enables a facilitator 101 to display a plurality of parts associated with a batch number. In this regard, the facilitator 101 may enter the batch number and all the parts associated with that batch number are displayed, including the parts' common names and approval status.

The “In Queue to Validation Team” pushbutton 1903 may display, when selected, a window that exhibits a list of parts that are to be sent to an approval authority, e.g., a second or third tier. In this regard, an analysis has been performed on the parts, and the parts and associated information are to be provided to another tier for validation. For example, the list may indicate part numbers, common names and nomenclature for those parts in queue to the validation team.

The “Approval Status” pushbutton 1904 may display, when selected, a window that exhibits a list of part numbers and their associated approval status when that status is chosen.

The “Type of Object Identification” pushbutton 1905 may display, when selected, a window that exhibits a list of parts and status by their associated type of object identifier, when that object identification is chosen. In this regard, parts may be listed indicating DPM, DPM candidate, or Label. Note that a DPM candidate refers to a part that is waiting for a DPM analysis to be performed.

The “Investigate DPM” pushbutton 1906 may display, when selected, a window that exhibits a list of parts that are currently being marked with labels. However, a DPM mark may be more suitable, and thus analysis of the part may be suspended until a DPM analysis is performed. In this regard, such a list comprises part numbers associated with parts that the PMS team desires to analyze for a DPM method.

Further lists that may be generated include a list of parts by date entered by selecting the “Facilitator by Date Entered” pushbutton 1907, a list of parts having parking lot data by selecting the “Parking Lot” pushbutton 1908, or a list of by analysis date by selecting “Analyzed by Date” pushbutton 1909. Furthermore, a facilitator 101 may generate a status list showing a list of parts having action items by selecting the “Action Items” pushbutton 1910, or a list of parts that are not parts marking candidates by selecting the “Not a Parts Marking Candidate” pushbutton 1911.

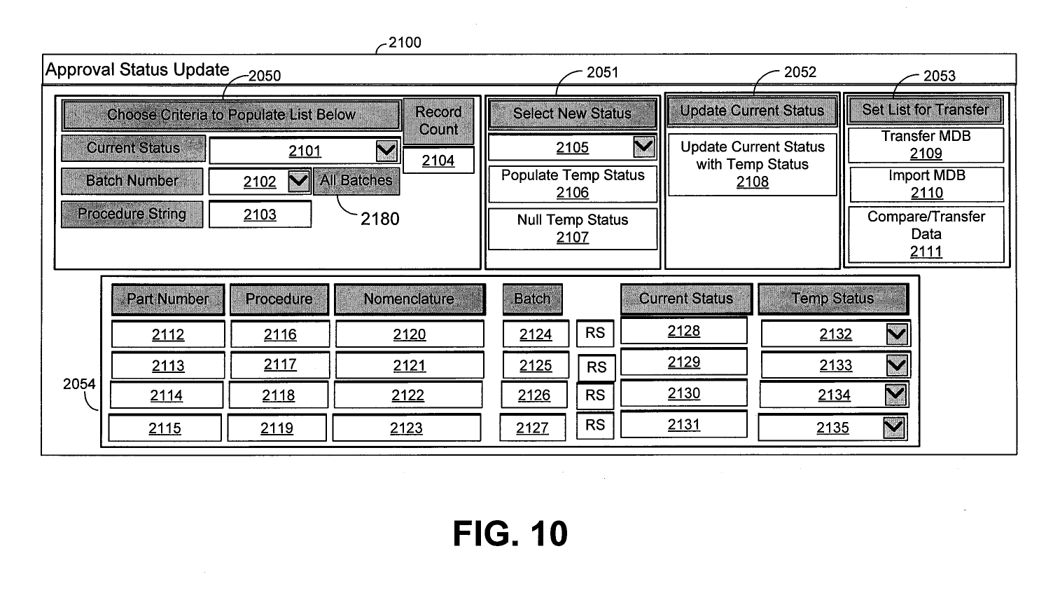

The GUI 1900 further comprises an “Approval Status Update; Transfer Data to Validation Team; Import Data from Validation Team” pushbutton 1912. When pushbutton 1912 is selected, a GUI 2100 is displayed as depicted in FIG. 10. The GUI 2100 enables a facilitator 101 to review data related to the status of a part or a batch of parts, change data related to the status of parts, import data related to a part or a batch, and/or transfer data related to a part or a batch to a validation team or an approval authority, e.g., manager or the like, so that they can add to or comment on the data.

GUI 2100 comprises a “Choose Criteria to Populate List Below” menu 2050, a “Select New Status” menu 2051, an “Update Current Status” menu 2052, and a “Set List for Transfer” menu 2053.

The menu 2050 enables a facilitator 101 to display a part or a list of parts in the listing window 2054. In this regard, the menu 2050 comprises a text field 2101 for selecting data indicative of the current status of a part or a batch of parts. Thus, for example, if the facilitator 101 selects data indicative of a status “In Queue for Validation Team,” as described hereinabove, then the PML 214 displays the parts in the window 2054 from the part data 226 associated with the status identifier entered by the facilitator 101. Note that the exemplary window 2054 lists the parts by part number and associated procedure number, nomenclature, batch number, and current status identifier. In addition, the facilitator 101 may retrieve parts for display in the window 2054 by selecting a batch number in text box 2102 or by entering a procedure string in text box 2103. The text box 2104 displays the total number of parts, i.e., records retrieved. Further pushbutton 2180, when selected, displays all part numbers associated with all batch numbers in the part data 226. For example, if text box 2101 indicated “In Queue to Validation Team” and the text field 2102 indicated batch number “3” for example, if the facilitator 101 selects “All Batches,” then the PML 214 removes the “3” limitation on the search and displays all records from all batches that have a status of in queue to validation team.

Note that the window 2054 comprises a plurality of text boxes 2112-2115 for displaying part numbers retrieved based upon criteria entered in menu 2050. Only four text boxes 2112-2115 are shown for exemplary purposes. However, the number of text boxes 2112-2115 displayed will directly reflect the number of parts retrieved based upon the criteria entered. Furthermore, text boxes 2116-2119 display alphanumeric codes identifying parts marking procedure, text boxes 2120-2123 display nomenclature, text boxes 2124-2127 display batch numbers, and text boxes 2128-2131 display current status identifiers corresponding to the part number text boxes 2112-2115, respectively.

After the facilitator 101 has selected one or more parts for display to the window 2054, the facilitator 101 may then change the status of the parts listed. In this regard, the text boxes 2128-2131 display the current status of each part listed. The facilitator 101 may select a new status identifier, e.g., awaiting approval, or approved, and enter the new status in a text box 2105. The “Populate Temp Status” pushbutton 2106, when selected, then populates “Temp Status” text boxes 2132-2135 with the new status selected in box 2105. Note that “Delete Temp Status” pushbutton 2107 may be selected in order to delete the new status identifiers populated in the “Temp Status” text boxes 2132-2135.

Once the facilitator 101 has selected a status identifier for the “Temp Status” text boxes associated with each part, the facilitator 101 may then update the “Current Status” text boxes 2128-2131 by selecting the “Update Current Status with Temp Status” pushbutton 2108. When the facilitator 101 selects the pushbutton 2108, the PML 214 changes the data stored in the PMD 216 associated with the corresponding parts to reflect the new status identifier. In addition, the PML 214 also displays the new status identifiers to the current status text boxes 2128-2131.

The “Set List for Transfer” menu 2053 comprises three pushbuttons 2109-2111. When the “Transfer Database” pushbutton 2109 is selected, the PML 214 generates a transfer data 219 that the PML 214 stores in memory 202, as described herein. In this regard, the PML 214 retrieves data describing the parts associated with the part numbers displayed in window 2054. The PML 214 then generates the PMD 219.

The GUI 2100 may further comprise a pushbutton (not shown) that, when selected, displays a window (not shown) for receiving recipient information, e.g., email address or web site address. Thus, the facilitator 101 may then select a transfer button (not shown) based upon the recipient information entered, and the PML 214 transmits the PMD 219 to the recipient. Thus, the listed parts and associated parts marking data making up a record in the PMD 216 may be transmitted to a validation team and/or an approving authority for review, as described herein.

In addition, the GUI 2100 comprises an “Import Database” pushbutton 2110. When the pushbutton 2110 is selected, the PML 214 may retrieve import data 281 and store the import data 281 in the PMD 216. The PMS 100 may receive import data 281 from a validation team and/or an approving authority, and the received import data 281 may comprise changes to a previous transfer data 219.

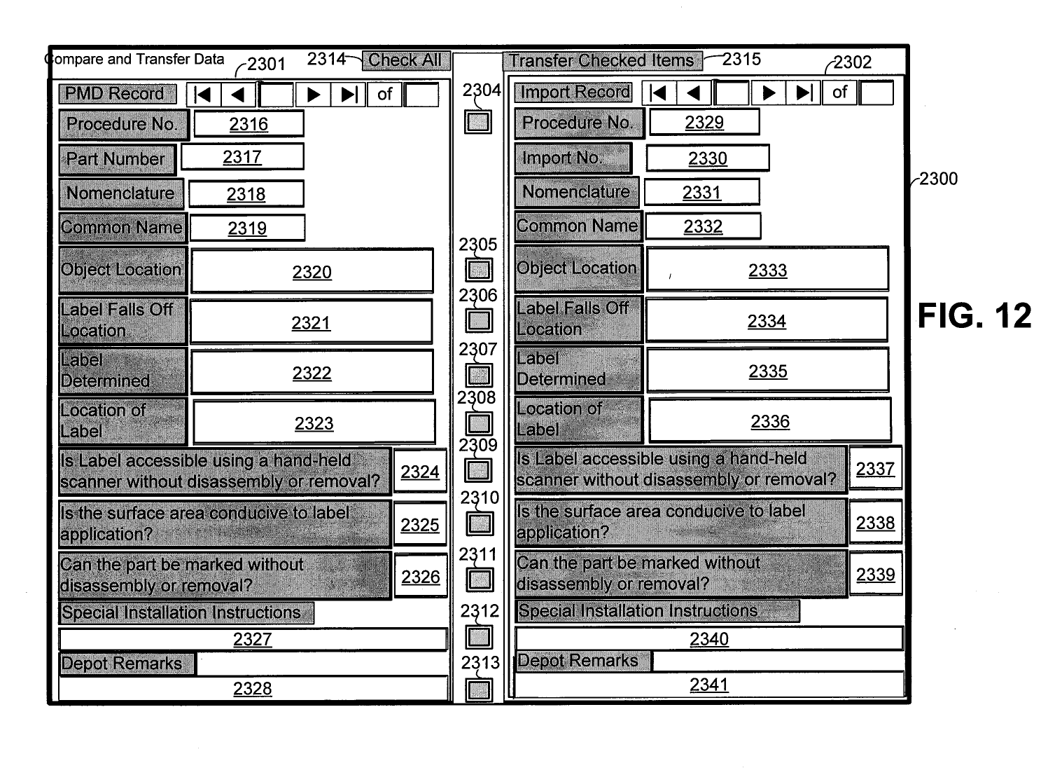

Thus, the GUI 2100 further comprises a “Compare/Transfer Data” pushbutton 2111. When the pushbutton 2111 is selected, the PML 214 displays a window 2300 as depicted in FIG. 12.

The GUI 2300 displays a window 2301 populated with data related to a part number currently stored in the PMD 216. Furthermore, the GUI 2300 displays a window 2302 populated with data related to the same part number, however, the data displayed is retrieved from the imported data 281 (FIG. 4). The GUI 2300 further comprises check boxes 2304-2313 corresponding at least a portion of the data contained in each of the “PMD Record” 2301 and the “Import Record 2302.” Note that the records 2301 and 2302 have a plurality of text fields 2316-2328 and 2329-2341, respectively.

When a facilitator 101 desires to transfer augmented data from the “Import Record” 2302 to the “PMD Record” 2301, facilitator 101 selects a check box 2304-2313 corresponding to that portion of the data 2316-2328 and 2329-2341 that the facilitator 101 desires to transfer and selects the “Transfer Checked Items” pushbutton 2315. The PML 214 then replaces the data related to the data checked in the PMD for the currently displayed part number data in the “Import Record” 2302. Additionally, the facilitator 101 may select the “Check All” pushbutton to move all the data in the “Import Record” 2302 to the “PMD Record” 2301.

With reference to FIG. 5, the “Report Menu” pushbutton 303 enables the facilitator 101 to request report data 220 from the PMD 216 corresponding to the PMD 216 and the algorithm data 230 described further herein. When the facilitator 101 selects the pushbutton 303 from the GUI 300, the PML 214 displays to the display device 210 a list of reports that the PML 214 can create or has already created. Thus, the facilitator 101 can retrieve a report and display it to display device 210 or print the report to an output device 240 or display such report to the display device 210 or visual device 110.

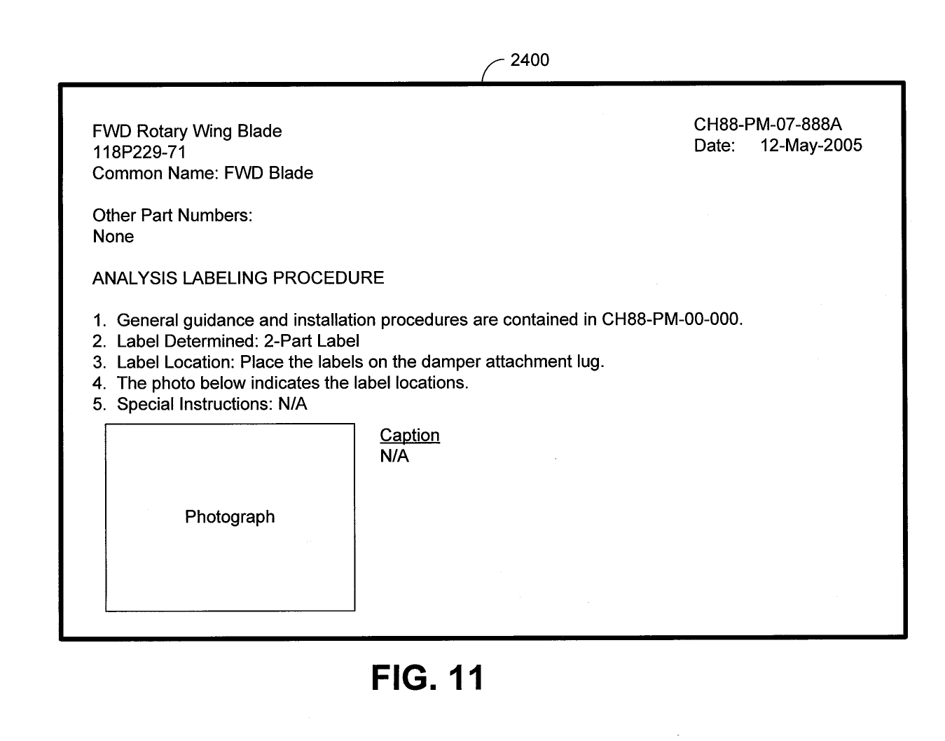

One report generated from “Report Menu” pushbutton 303 is an exemplary parts marking procedure 2400 as is illustrated in FIG. 11. The parts marking procedure 2400 depicts a parts marking procedure report for a part named “FWD Rotary Wing Blade.” The parts marking procedure report 2400 provides the part number “118P229-71,” a common name “FWD Blade,” a procedure number “CH88-PM-07-888A,” and a date “12-May-2005.”

Additionally, the parts marking procedure 2400 provides a labeling procedure including the type of label, “2-Part Label,” and a label location, “on the damper attachment lug.” The report further exhibits a photograph or drawing that may show the label location and the placement on the part and any special installation instructions.

With reference to FIG. 5, the “Miscellaneous Notes” pushbutton 304, when selected, displays a window (not shown) that enables the facilitator 101 to enter notes regarding a particular part of the analysis. A facilitator 101 may record common assumptions that are made during the analysis, and the assumptions create rules and standards for the parts marking implementation data 2800.

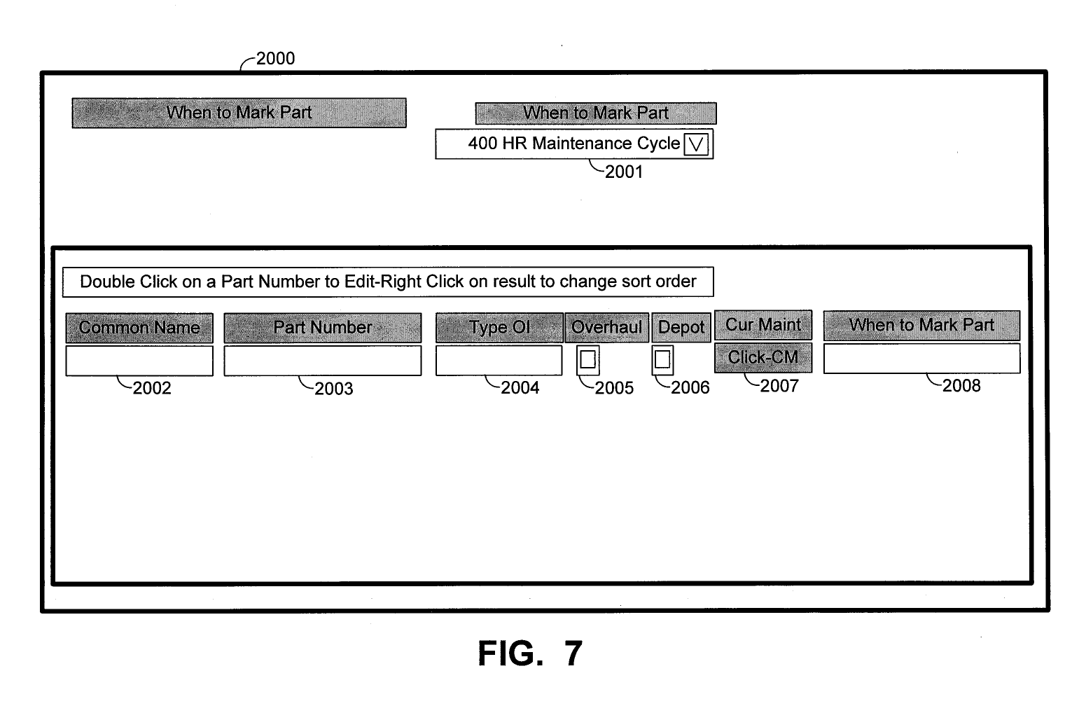

The “When to Mark Part” pushbutton 305 displays a GUI 2000 depicted in FIG. 7 when selected. The GUI 2000 enables a facilitator 101 and/or the PMS team to determine/view when a part is to be marked. In this regard, the GUI 2000 comprises a pull down menu 2001 that the facilitator 101 can use to select a particular “When to Mark Part” opportunity and thus the PML 214 displays the parts to be marked at that time. For example, the facilitator 101 may choose “400 HR Maintenance Cycle” and thus the PML 214 displays the parts that have been identified to be marked at the 400 HR Maintenance Cycle. GUI 2000 further comprises a “Common Name” text box 2002 that displays the common name of the part, a “Part Number” text box 2003 that displays the part number of the part, and a “Type OI” text box 2004 that displays the type of object identifier, e.g., a label or particular DPM technique, chosen by the PMS team to be used to mark the part. In addition, the GUI 2000 comprises check boxes 2005 and 2006 that indicate if the part is subject to overhaul or to be at the depot, respectively. Additionally, a “Click-CM” pushbutton, when selected, displays a current maintenance schedule for the part. The GUI 2000 also displays in text box 2008 that allows the facilitator 101 and the PMS team to choose or view when the part is to be marked based on the opportunities shown in 2005, 2006, and 2007.

As mentioned hereinabove, when the facilitator 101 selects the pushbutton 301 (FIG. 5), the PML 214 displays the GUI 400 (FIG. 6) to the display device 210. The GUI 400 comprises a text box 402 in which the facilitator 101 may enter data, via the input device 208, indicative of a part number. After the facilitator 101 has entered the text into the text box 402, the facilitator 101 selects a “Click to Add” pushbutton 414.

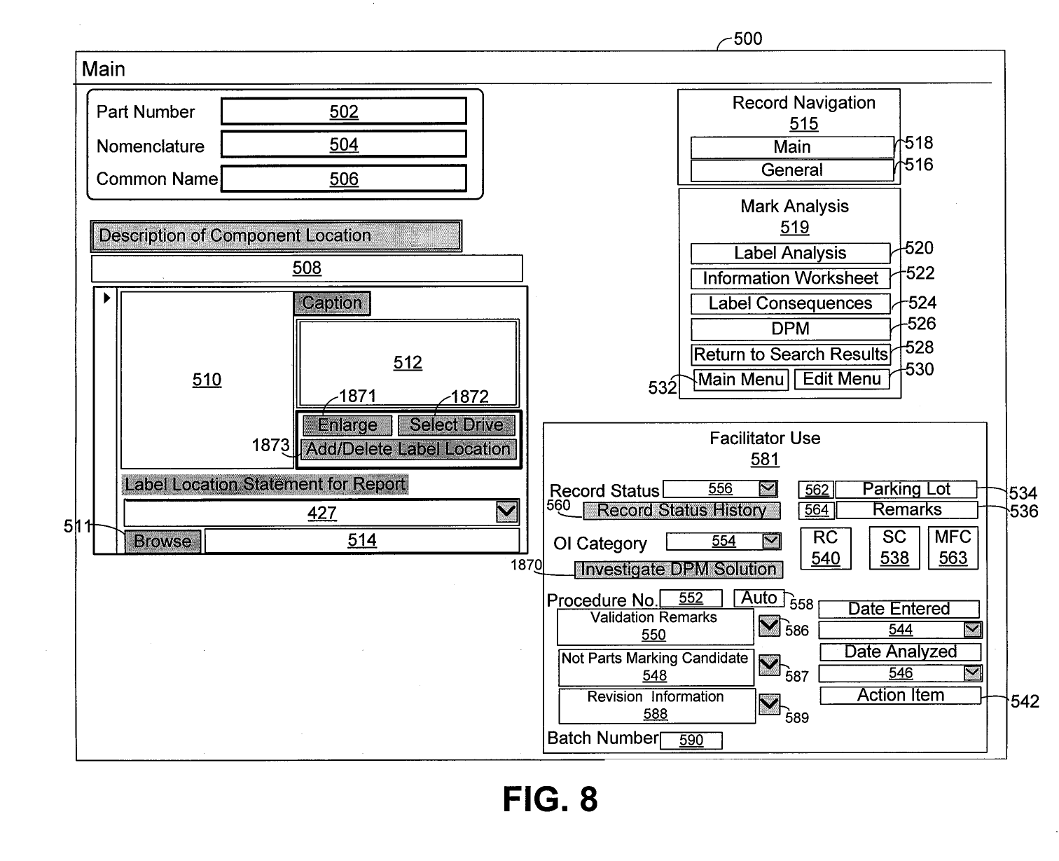

When the facilitator 101 selects the pushbutton 414, the PML 214 stores the part number in the part data 226 of the PMD 216 and displays to the display device 210 the “Main” GUI 500 of FIG. 8, which is described in more detail hereafter.

Furthermore, the GUI 400 enables a facilitator 101 to search the PMD 216 for existing part numbers. In this regard, the facilitator 101 may search existing part numbers by part number, common name, national stock number (NSN), or nomenclature. Thus, the GUI 400 comprises an “Enter a Part Number String” text box 404, an “Enter a Common Name String” text box 405, an “Enter an NSN String” text box 406, and an “Enter a Nomenclature String” text box 407.

When the facilitator 101 enters data into any one of the text boxes 404-407 and selects a “Search” pushbutton 416, the PML 214 displays a list of part numbers associated with the entered search string, i.e., part number, common name, NSN number, and/or nomenclature. The facilitator 101 can then select the part from the list of parts, and when the facilitator 101 selects the desired part, the PML 214 displays the “Main” GUI 500 (FIG. 8) exhibiting the selected part.

Additionally, the GUI 400 enables a facilitator 101 to edit and/or view a part number. Thus, the GUI 400 comprises a “Choose a Part Number” text box 420. When the facilitator 101 enters/chooses data into the text box 420 and selects an “Edit/View” pushbutton 421, the PML 214 retrieves information from the PMD 216 corresponding to a part that matches the data entered/chosen into the text box 420. The PML 214 displays the retrieved information in the “Main” GUI 500 described in more detail with reference to FIG. 8.

In addition, the GUI 400 comprises a “Choose a Procedure to Edit” text box 422 and corresponding “Edit/View” pushbutton 423 that, when selected, displays the GUI 500 of FIG. 8 exhibiting the part number associated with the procedure number entered/chosen into the text box 422 (FIG. 6). Therefore, if the facilitator 101 desires to edit a procedure, the facilitator 101 can enter/choose the procedure number into text box 422, select the pushbutton 423, and the PML 214 displays the GUI 500 corresponding to the particular part number.

In addition, the GUI 400 comprises a “Choose a Recently Added, Searched or Edited Part number” pull down menu 424. Therefore, the facilitator 101 may select a recently added, searched or edited part number and select the “Edit/View” pushbutton 425 to edit or view the part number or select the “Delete History” pushbutton 426 to delete the part numbers in the pull down menu 424 from history.

Further, the GUI 400 enables a facilitator 101 to delete a part number from the PMD 216. In this regard, the facilitator 101 can enter/choose a part number into text box 427 and select the “Delete” pushbutton 428. The PML 214 then deletes the part associated with the entered/chosen part number from the PMD 216.

FIG. 8 depicts the “Main” GUI 500. As described herein, the GUI 500 is generally displayed by the PML 214 when the facilitator 101 elects to retrieve information corresponding to a particular part or elects to edit an existing part stored in the PMD via the GUI 400 (FIG. 6). In this regard, the PML 214 retrieves desired information from the PMD 216 and populates the GUI 500 with the information retrieved.

Furthermore, the “Main” GUI 500 is displayed by the PML 214 when the facilitator 101 selects the “Click to Add” button 414 (FIG. 6). The GUI 500 displays the added part number and description information and the PML 214 stores data in PMD 216 corresponding to the new part number not already in the PMD 216. In this regard, the PML 214 displays the GUI 500 to the display device 210, and the facilitator enters data into the GUI 500 related to the part that the facilitator 101 desires to enter into the PMD 216.

The GUI 500 of FIG. 8 comprises a text box 502 that the PML 214 populates with a desired part number, which was entered from the GUI 400 as described herein. Note that the part number, common name, and/or nomenclature displayed in text boxes 502, 504, or 506, respectively, may already be stored and correlated in the PMD 216. However, as described hereinabove, the facilitator 101 may desire to enter a new part number in GUI 400 (FIG. 6) by selecting the “Click to Add” pushbutton 414 after entering a part number in text box 402 (FIG. 6). Furthermore, the GUI 500 comprises a text box 508 for displaying or entering data that describes the location of the part in the system in which the part operates identified in the “Part Number” text box 502.

In one embodiment, the GUI 500 comprises a window 510 for displaying several photographs and/or drawings indicative of the part identified in the text box 502. Note that the drawing may be in any format, e.g., portable document format (PDF), tagged image file format (TIFF), or a windows bitmap (BMP).

In this regard, the PML 214 may retrieve several photographs and/or drawings from the PMD 216 and display the photograph or drawing in the window 510 along with an associated caption describing the photograph or drawing in text box 512. Additionally, the GUI 500 comprises a “Browse” button 511. When the facilitator 101 selects the button 511, the PML 214 displays data indicative of the file system (not shown) of the PMS 100, and the facilitator can select from the file system a file name indicative of a file that contains data defining a photograph or drawing of a part, which the PML 214 can display in window 510.

Furthermore, the GUI 500 may comprise an “Enlarge” pushbutton 1871, a “Select Drive” pushbutton 1872, and an “Add/Delete Label Location” pushbutton 1873. The “Enlarge” pushbutton 1871, when selected, may display an enlarged version of the drawing and/or photograph in window 510. The facilitator 101 and the PMS team may then be able to view in better detail that which is displayed in window 510.

The GUI 500 comprises a “Record Navigation” menu 515 and a “Mark Analysis” menu 519. The “Record Navigation” menu 515 comprises a “General” pushbutton 516 and a “Main” pushbutton 518, which generally enable a facilitator 101 to access data currently being stored in the PMD 216 (FIG. 2).

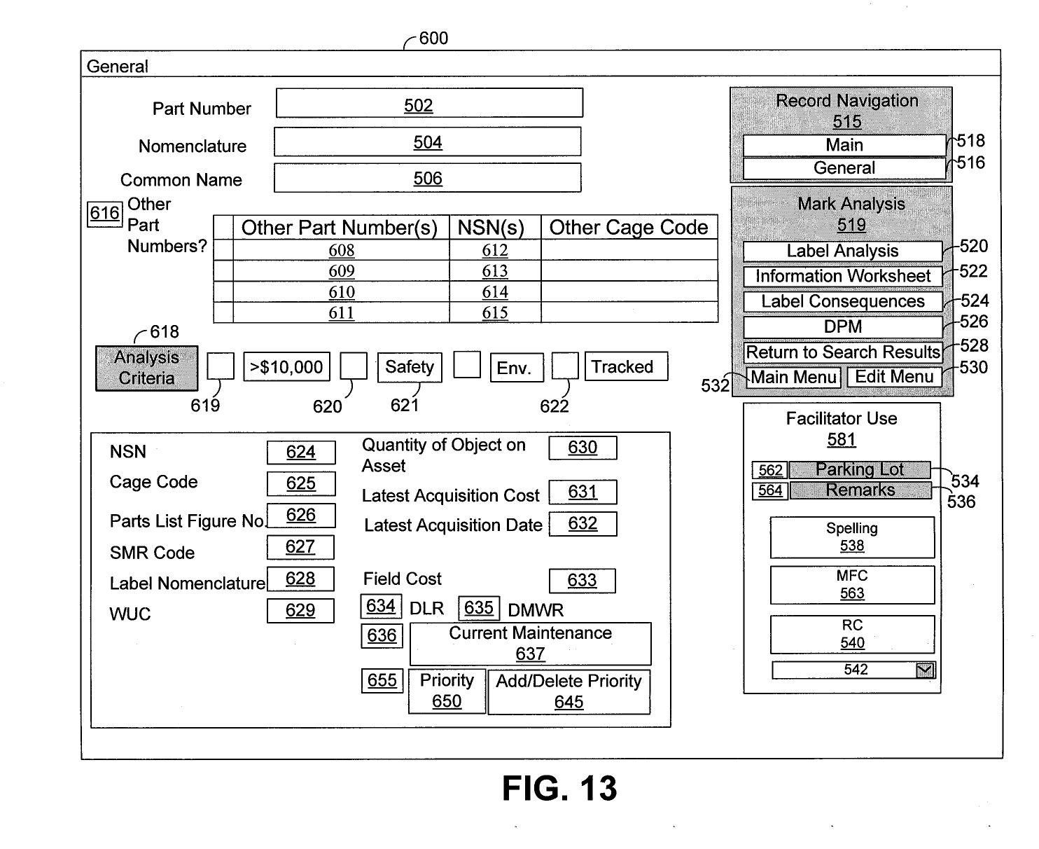

When the facilitator 101 selects the “General” pushbutton 516, the PML 214 (FIG. 4) displays to the display device 210 a “General” GUI 600, which is described in more detail with reference to FIG. 13. The GUI 600 (FIG. 13) provides general information about the part currently selected in the “Part Number” text box 502 of FIG. 8.

When the facilitator 101 selects the “Main” pushbutton 518, the PML 214 (FIG. 4) displays to the display device 210 the “Main” GUI 500, which is described hereinabove with reference to FIG. 8.

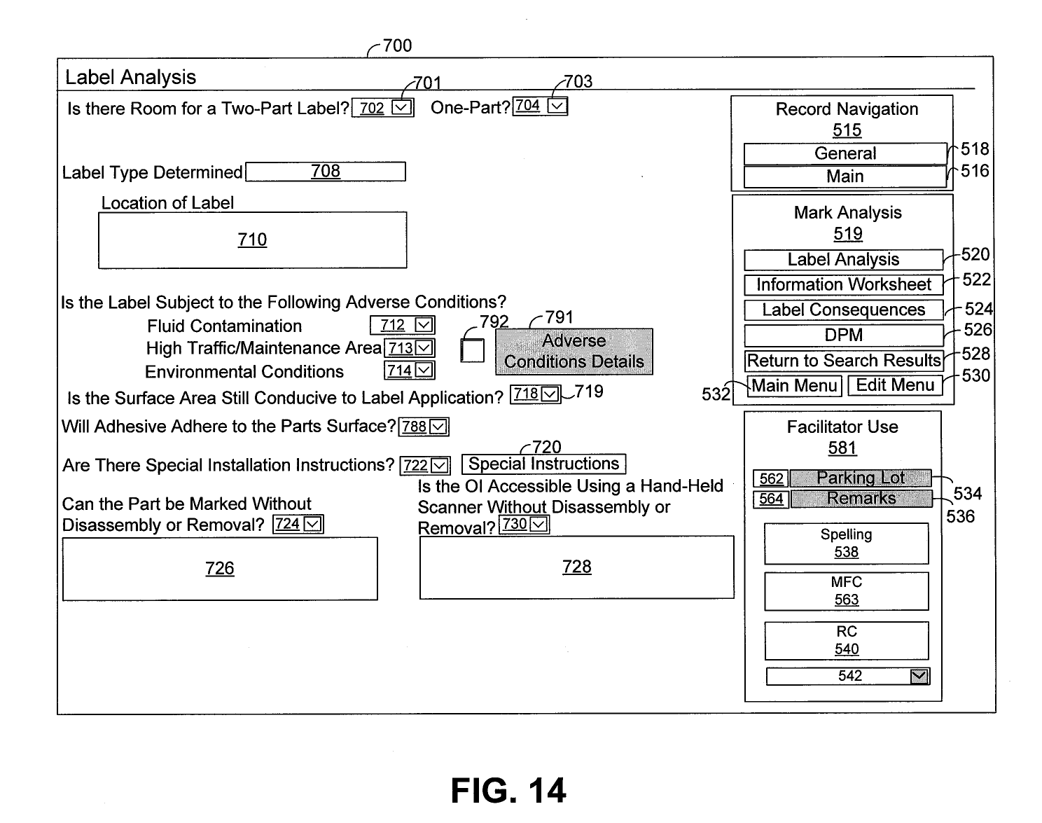

The “Mark Analysis” menu 519 comprises a “Label Analysis” pushbutton 520, an “Information Worksheet” pushbutton 522, and a “Label Consequences” pushbutton 524. Each button 520, 522, and 524 provides a specific analysis functionality with respect to an object identifier that is to be used on the part identified in the text box 502, and each is described in more detail with reference to FIGS. 14-16.

Additionally, the GUI 500 comprises a “Direct Parts Marking” (DPM) pushbutton 526, a “Return to Search Results” pushbutton 528, a “Main Menu” pushbutton 532, and an “Edit Menu” pushbutton 530.

When the facilitator 101 selects the DPM button 526, the PML 214 displays to the display device 210 the GUI 1000, which is described in more detail with reference to FIG. 17. When the pushbutton 528 is selected, the PML 214 displays a listing of parts that may have resulted in an earlier search as described with reference to FIG. 6. The button 532 displays the “Parts Marking” GUI 300 of FIG. 5, and the button 530 displays GUI 400 of FIG. 6.

With reference to FIG. 5, the GUI 500 further comprises a text box 556 for providing the status of a record, and a button 560 that, when selected, displays the status history of a record. Further, the GUI 500 comprises a text box 554 for displaying the object identifier category of the currently displayed part, a text box 552 for displaying a procedure number associated with the part, and an automation button 558 for automatically formulating a procedure number. As an example, text box 554 may display “Label,” “DPM Candidate,” or “Not a Parts Marking Candidate.”

When the part that is currently being displayed has associated validation remarks, such remarks are indicated in check box 586. In this regard, a facilitator 101 can select “Validation Remarks” pushbutton 550 to open a window comprising an editable text box (not shown). The facilitator 101 can enter data indicative of validation remarks in the text box, and when the facilitator 101 returns back to the “Main” GUI 500, the check box 586 exhibits a check indicating that there are validation remarks.

In addition, if the PMS team determines that the part currently displayed is not a parts marking candidate, then the facilitator 101 can select the push button 548, and the PML 214 displays an editable text box (not shown) in which the facilitator 101 can enter data indicative of reason why the part is not a parts marking candidate even though the part meets other parts marking criteria laid out in the implementation information and strategies. When the facilitator 101 returns back to the “Main” GUI 500, a check box 587 exhibits a check indicating that there are reasons indicated for why the part is not a parts marking candidate.

Furthermore, the “Facilitator Use” menu 581 comprises a “Revision Information” check box 589 to indicate that revisions of the information related to the part exist. In this regard, the “Revision Information” pushbutton 588, when selected, displays an editable text box for entering revision information. When the facilitator 101 returns back to the “Main” GUI 500, the check box 589 exhibits a check indicating that there is revision information.

As described herein, a part may be a member of a plurality of parts, wherein a batch number identifies the plurality. Data indicative of the batch in which the part number belongs is exhibited in text box 590. As the approval process for parts marking descriptions for the plurality associated with the batch number is analyzed and reviewed, the parts can be retrieved by searching the PMD 216 via the batch number.

The GUI 500 further comprises a check box 562 that indicates that a part is currently listed in the “Parking Lot.” Note that when a part is listed in the “Parking Lot,” such indication means that prior to making a decision on the part's marking analysis, additional information may be needed. Thus, the facilitator 101 can enter data describing the reasons for the part being in the parking lot into editable text box 534. Thus, when the facilitator 101 returns back to the “Main” GUI 500, the check box 562 exhibits a check indicating that there is parking lot information.

Further, there may be additional remarks related to the part. If so, then the GUI 500 further comprises a “Remarks” pushbutton 536 and a corresponding check box 564, which behave substantially similar to the “Parking Lot” pushbutton 534 and corresponding check box 562.

The GUI 500 may further comprise a “Record Copy” pushbutton 540, a “Spelling” pushbutton 538, and a “Master Facilitator Copy” pushbutton 563. The “Spelling” pushbutton 538, when selected, checks the spelling in the displayed descriptions and other displayed text. The facilitator may select the pushbutton 538 in order to run a spell check on the information provided in the GUI 500.

Further, the “Record Copy” pushbutton 540 is for providing a record copy of another part number to transport into the current working record. In one embodiment, the pushbutton 540 displays a window from which data can be cut and pasted into the GUI 500. In another embodiment, the pushbutton 540 automatically transports selected data into the GUI 500 without the facilitator having to cut and paste the data.

“Master Facilitator Copy” pushbutton 563 is for displaying a master record copy (not shown) for use by the facilitator 101. The master record copy preferably is a window that shows all the information related to the part including its marking information.

In addition, the “Facilitator Use” menu 581 comprises a “Date Entered” text box 544 for entering the origination date of the information relating to the part currently displayed in the text box 502. Further the menu 581 comprises a “Date Analyzed” text box 546 for entering data indicative of the date on which a parts marking analysis was performed for the part number displayed in text box 502. The “Facilitator Use” menu 581 further comprises an “Action Item” pushbutton 542. The pushbutton 542, when selected, displays a window (not shown) that enumerates at least one action item associated with the identified part. In this regard, the action item window may exhibit data indicative of the part number, common name, actionee (the individual or group that is to take the action), the action to be taken, the due date, and corresponding remarks.

Note that the data described hereinabove that is entered via the GUI 500 is preferably stored in the PMD 216 as part data 226.

As described hereinabove, if the facilitator 101 selects the “General” pushbutton 516, then the PML 214 displays to the display device 210 the GUI 600 described now with reference to FIG. 13. The GUI 600, like the GUI 500, displays or receives text via text boxes, pull down menus, and/or check boxes corresponding to the “Part Number” 502, the part “Nomenclature” 504, and/or the part “Common Name” 506.

Additionally, the GUI 600 comprises a table that includes other part numbers 608-611 that are affiliated with the part currently displayed in text box 502 and each other part number's corresponding NSNs 612-615 including other cage codes. If other part numbers exist in the table, then the text box 616 provides an indication of additional part numbers, e.g., a check mark.

Additionally, the GUI 600 comprises an “Analysis Criteria” box 618. As described herein, the type of criteria that is to be considered when analyzing a part is dependent upon several factors, including the desires of the implementing entity for which the part is being analyzed. In this regard, the “Analysis Criteria” box 618 can comprise a plurality of configurable check boxes to indicate if one or more of the listed criteria pertains to the displayed part number. For example, the box 618 comprises selection boxes 619, 620, 621, and 622 and exhibit specific analysis criteria. When box 619 is selected, this indicates that the part costs more than $10,000, if the “safety” box 620 is checked this indicates that the part has safety consequences, if the “environmental” box 621 is selected, this indicates that failure of the part has environmental consequences, and the “tracked” box 622, if checked, indicates that the implementing entity desires to track the part number for a particular reason. Thus, if one or more of these boxes is checked, then there exists a reason(s) for marking the part with an object identifier. As described hereinabove, other analysis criteria in other embodiments are possible depending upon the type of parts that are indicated in the implementation information and strategies for marking and any requirements that may be placed upon an implementing entity. Thus, the boxes 619-622 are configurable based upon such analysis criteria identified.

The GUI 600 comprises an “NSN” text box 624 for displaying the NSN information related to the part, a “Cage Code” text box 625 for displaying the cage code associated with the part number, an “Parts List Figure No.” text box 626 for displaying a figure number corresponding to a drawing associated with the part number, a source maintenance recoverability (“SMR) Code” text box 627 for entering and/or displaying the SMR code associated with the part number, a “Label Nomenclature” text box 628 for displaying the label nomenclature associated with the part number, and a work unit code (“WUC”) text box 629 for entering and/or displaying the WUC code associated with the part number. Further, the GUI 600 comprises a “Quantity of Object on Asset” text box 630 for entering and/or displaying the quantity or number of a particular part contained on a particular asset, e.g., two rotary blades on a helicopter. The “Latest Acquisition Cost” text box 631 may be provided for entering and/or displaying the latest acquisition cost associated with the part number, and the “Latest Acquisition Date” text box 632 may be provided for entering and/or displaying the latest acquisition date associated with the part number. Other information that may be provided including a “Field Cost” text box 633 for entering and/or displaying the field cost for which the displayed part is bought by the end user.

The GUI 600 further provides boxes 624-633, check box 634, and text boxes 635 and 636 for entering and/or displaying information provided by the facilitator 101 relating to the part number indicated in text box 502. Such information is configurable based upon the application in which the PMS 100 is used. For example, the check boxes 624-634 may be used to provide additional tracking information or maintenance characteristics or additional maintenance and/or part management data.

Additionally, the GUI 600 comprises a “Priority” pushbutton 650, a check box 655, and “Add/Delete Priority” pushbutton 645. When the pushbutton 650 is selected, the PML 214 displays a window comprising a list of priority indicators for marking of the part. Such data may include, for example, “funding availability” priority indicator or “immediate” indicator. The facilitator 101 can add priority indicators by selecting a pushbutton (not shown). If priority data is provided for the displayed part, the PML 214 displays an indicator in check box 655. The GUI 600 further comprises a “Current Maintenance” push button 637 that, when depressed, displays an editable text box for entered current maintenance package information associated with the part being analyzed. When information is entered in the editable check box, the PML 214 displays an indicator in check box 636.

Note that each of the informational text boxes 624-633 and 635-636 are populated with data that is provided prior to analysis. However, some of the data, for example the current maintenance data in the aforedescribed editable text box, may be retrieved from the team during analysis. Further note that the analysis criteria in box 618 and the additional information in text boxes 624-635 are exemplary criteria only, and other criteria can be used in other embodiments depending upon an implementing entity's requirements.

Once the facilitator 101 has entered information corresponding to the part number displayed in the text box 502, the PMS team performs an analysis to determine if a label or labels are technically appropriate. In this regard, the facilitator 101 selects the “Label Analysis” pushbutton 520, and the PML 214 displays to the display device 210 a GUI 700 illustrated in FIG. 14.

As described hereinabove, the “Label Analysis” screen is preferably generated based upon label algorithm data 232, which is obtained from implementation information and strategies for a particular implementing entity. For example, if it is determine that there are two types of labels available, a one-part and a two-part, then the first question in the “Label Analysis” GUI 700 is “Is there room for a two-part label?”

The GUI 700 comprises a selection box 702 for selecting an option that is also provided by the label algorithm data 232. For example, the selectable option data may be an affirmative or a negative response to whether there is room on the part being analyzed for placing a two-part label. Thus, the PMS team answers the question of whether there is room on the part for a two-part label, and if the PMS team determines that there is room for a two-part label, then the facilitator selects an affirmative indication for the box 702. For example, the box 702 may provide a pull down menu when the down arrow 701 is selected. Thus, the facilitator 101 may select a “Yes” or a “Y” from the pull down menu to indicate an affirmative response. To the contrary, the part may not be suitable for a two-part label, thus the facilitator 101 would select a negative indication, for example a “No” or an “N,” for the text box 702.

The GUI 700 further comprises a selection box 704 for selecting an affirmative or a negative response to the question of whether there is room on the part being analyzed for placing a one-part label. Thus, the PMS team answers the question of whether there is room on the part for a one-part label, and if the PMS team determines that there is room for a one-part label, then the facilitator selects an affirmative indication in the box 704. For example, the box 704 may provide a pull down menu when the down arrow 703 is selected. Thus, the facilitator 101 may select a “Yes” or a “Y” from the pull down menu to indicate an affirmative response. To the contrary, the part may not be suitable for a one-part label, in which case the facilitator 101 would enter a negative indication, for example a “No” or a “N” in the text box 704.

Notably, the queries made on the “Label Analysis” GUI 700 are configurable, as described hereinabove. For example, if an implementing entity that is to use the PMS 100 to perform a label analysis desires not to have any two-part labels, then the question corresponding to the box 702 would not be available. Likewise, if the entity desired to use other types of labels, e.g., tape, then such a selection would be available. Note that the questions that are asked in the label analysis are technical limitations with respect to the use of labels in their operating environment. In this regard, if the part is not big enough for a two-part label, then such a question describes a technical limitation to the use of the two-part label on the part being analyzed.

Once the PMS team determines whether a two-part label, a one-part label, and/or another type of label known in the art can be used on the part, the PML 214 automatically populates box 708 from question/answers from boxes 702, and 704.

Further, the PMS team describes the optimal location of the label determined. In this regard, the facilitator 101 enters information describing the location on the part for the label type indicated in the text box 708. Notably, the PMS team may navigate to the GUI 500 described with reference to FIG. 8, by selecting the pushbutton 518, and view the photograph or drawing of the part in making the location determination.

With reference to FIG. 14, the PMS team then provides information describing adverse conditions that the part may be subjected to during operation that may affect whether or not a label is technically appropriate. In this regard, the GUI 700 comprises boxes 712-714 including box 712 for indicating whether the label might be subject to fluid contamination, box 713 for indicating whether the label is subject to high traffic and/or maintenance traffic, and box 714 for indicating whether the label is subject to adverse environmental conditions. In addition, the GUI 700 comprises a check box 792 for indicating whether adverse conditions are described in more detail. In this regard, the facilitator 101 may select the “Adverse Conditions Details” pushbutton 791. If selected, the PML 214 may display a window (not shown) for entering data further describing the details, and the PML 214 may store such data in the PMD 216 associated with the part.

These adverse conditions questions are technical limitations to the label analysis. The facilitator selects options from the pull down boxes 712, 713, and 714. These options and technical limitations are common conditions that may cause the label to fail. In this regard, the adverse condition questions are also configurable depending upon the type of environment or external exposures that a part may endure during operation.

Further, the GUI 700 provides a box 718 for indicating whether the surface area is still conducive to label application in light of the previous analysis and exists to allow the PMS team to decide if label analysis should be continued. As described hereinabove, the GUI may provide a pull down functionality via the arrow 719. Whether the surface area is still conducive to label application may depend upon a number of factors that the PMS team considers in making such a determination.

Additionally, the GUI 700 comprises a technical limitation described by the query of “Will adhesive adhere to the parts surface” and provides options in a pull down menu 788 for answering such a query.

Further, the GUI 700 provides a box 722 for providing an affirmative or negative option to indicate whether there are special installation instructions for applying the suggested label in box 708 to the part being analyzed. Additionally, the GUI 700 comprises a button 720, and, when selected, the PML 214 displays to display device 210 an editable text box (not shown) in which the facilitator can enter information describing the special instructions determined by the PMS team.

Further, the GUI 700 comprises a box 724 for providing an affirmative or negative option to indicate whether the part can be marked without disassembly or removal. Thus, the facilitator 101 enters an affirmative or negative response determined by the PMS team in the box 724. Corresponding text box 726 receives data indicating the removal or disassembly procedure/details.

The GUI 700 also comprises a box 730 for indicating affirmatively or negatively whether the OI is accessible using a hand-held scanner without disassembly or removal. Thus, the facilitator 101 enters an affirmative or negative response determined by the PMS team in the box 730. Corresponding text box 728 receives data indicating the removal or disassembly procedure/details.

The “Label Analysis” GUI 700 embodies exemplary label algorithm data 232. In this regard, the questions/statements and options provided to respond to the exemplary questions/statements make up an exemplary label algorithm. Other questions/statements in other embodiments of a “Label Analysis” GUI 700 can be used with other options, and such algorithms can be configured based upon the implementation information and strategies as described herein.

The PMS 100 stores data indicative of the selected options and other data entered in the “Label Analysis” GUI 700 in the label analysis data 221 of the PMD 216.

Once the PMS team performs the basic label analysis using GUI 700, the facilitator continues the analysis by selecting the “Information Worksheet”pushbutton 522. When the pushbutton 522 is selected, the PML 214 displays the GUI 800 depicted in FIG. 15 to the display device 210.

The GUI 800 enables the PMS team to perform an information worksheet analysis via the display device 210 and the visual device 110. In this regard, the PMS team begins by identifying a variety of functions, functional failures, failure modes, and failure effects related to the placing of a label on a part or such functions, functional failures, failure modes, and failure effects may be identified prior to the PMS team gathering, and the PMD 216 may be populated with function, functional failure, failure mode, and failure effect data. In this regard, the pre-populated identified functions, functional failures, failure modes, and failure effects may be technical limitations associated with an algorithm, and such functions and functional failures may be stored in the information worksheet data 218 (FIG. 4).

Such function data is entered or displayed into text box 811. When adding a function, the facilitator 101 selects the “Add” pushbutton 801. As the facilitator 101 enters additional functions or scrolls through pre-populated functions, the PML 214 increments a counter in text box 837. Note that the text box 811, and any other text box in the PMS 100, when selected may magnify on the display such that the size of the box increases and the font of the text in the box increases.

Exemplary functions that may be identified by the PMS team include, for example, to safely and permanently display human and machine-readable part information so that it can be identified and traced, to avoid damage to the part and/or the vehicle in which the part is installed, and to avoid introducing any additional failure modes to the system in which the part is installed. Note that such functions may vary for different applications of the PMS 100.

Once the PMS team has reviewed pre-populated functions and/or added new functions associated with the label under analysis, the PMS team identifies “Functional Failures” associated with each pre-populated function and/or added function. As functional failures are identified, the facilitator 101 enters such functional failure data by selecting an “Add” pushbutton 802 and entering data into the text box 812 describing the functional failure. A counter in text box 827 indicates the number associated with the displayed functional failure in text box 812.

Exemplary functional failures associated with an identified function may include the label falls off, the label is humanly illegible, or the label is not machine-readable. Note that such functional failures may vary for different implementing entities of the PMS 100.

Once the PMS team has identified functional failures associated with the label under analysis, the PMS team identifies “Failure Modes” associated with the identified functional failures. The facilitator 101 enters such failure mode data by selecting an “Add” pushbutton 803 and entering data describing the failure mode in text box 813.

Once the PMS team has identified failure modes, the PMS team identifies “Failure Effects” associated with each failure mode identified. The facilitator 101 enters such failure effects into the text box 814 associated with each failure mode. The described compilation of failure modes and failure effects is hereinafter referred to as a “FMEA.”

Based on the FMEA, if the PMS team desires to continue the label analysis, the GUI 800 comprises a box 806 for indicating an affirmative or negative response as to whether to still continue the analysis. Further, the GUI 800 comprises a box 804 for indicating an affirmative or negative response as to whether the label determined in text box 708 (FIG. 14) is recommended in light of the information provided in the FMEA.

Note that the “Record Navigation” menu 515 and the “Mark Analysis” menu 519 behave in substantially the same manner as described hereinabove.

Furthermore, the GUI 800 comprises a “Facilitator Use” box 599. The box 599 comprises a “Spell Check” pushbutton 561 that, when selected, checks the spelling in the text boxes in the GUI 800. The box 599 further comprises a “Totals” pushbutton 562 that when depressed displays a text box (not shown) that details the total number of functions, functional failures, failure modes, and failure effects contained in the information worksheet performed in the GUI 800, when selected. The “Copy” pushbutton 563 displays a copy of the current window so that the facilitator 101 can copy data from one window to the working GUI 800. Further, the “Copy” pushbutton 563 is for providing a record copy of another part number to transport into the current working record. In one embodiment, the pushbutton 563 displays a window from which data can be cut and pasted into the GUI 800. In another embodiment, the pushbutton 563 automatically transports selected data into the GUI 800 without the facilitator having to cut and paste the data.

Finally, the box 599 comprises a “Renumber” pushbutton 564 that renumbers functions, functional failure, failure modes, and failure effects when selected.

The PML 214 stores the FMEA data and any other data entered in the “Information Worksheet” GUI 800 in the information worksheet data 218 (FIG. 4).

Once the Information Worksheet GUI 800 is completed by the PMS team, the facilitator 101 may select the “Label Consequences” button 524, and the PML 214 displays the GUI 900 described in more detail hereafter with reference to FIG. 16.

The GUI 900 further exhibits a plurality of questions indicative of technical limitations associated with the consequences of a particular label falling off of its location identified in text box 710 (FIG. 14), as described hereinabove. In this regard, the GUI 900 comprises text boxes for entering data and selection boxes for selecting options corresponding to a plurality of queries aimed at gathering information corresponding to the consequences of a label falling off which allows the PMS team to select a label as a marking option.

The GUI 900 comprises a text box 902 for entering data describing where a label conducive to detachment might fall off. Thus, the facilitator 101 requests information from the PMS team corresponding to where a label(s) would fall off, and the facilitator 101 enters such information in text box 902.

The PMS team further analyzes the consequences if the label falls off via the GUI 900 by entering data in boxes 903-907. Furthermore, pushbuttons 910-914 may be selected so that the facilitator 101 can enter additional data regarding each box 903-907.

In this regard, the GUI 900 comprises text box 903 for providing an affirmative or negative response as to whether, if the label being analyzed falls off, if such falling off might have adverse effects on operational safety. If the PMS team determines that there are or are not safety consequences, the GUI 900 further provides a pushbutton 910, and when the button 910 is selected, the PML 214 displays an editable text box (not shown) for entering detailed information corresponding to safety consequences information identified by the PMS team.

The GUI 900 comprises text box 904 for providing an affirmative or negative response as to whether, if the label being analyzed falls off, such falling off might cause a breach of an environmental standard or regulation. If the PMS team determines affirmatively/negatively that there are environmental consequences, the GUI 900 further provides a pushbutton 911, and when the button 911 is selected, the PML 214 displays an editable text box (not shown) for entering detailed information corresponding to the environmental consequences information identified by the PMS team.

The GUI 900 comprises text box 905 for providing an affirmative or negative response as to whether, if the label being analyzed falls off, such falling off might cause an adverse effect on operational capability. If the PMS team determines affirmatively/negatively that there are operational consequences, the GUI 900 further provides a pushbutton 912, and when the button 912 is selected, the PML 214 displays an editable text box (not shown) for entering detailed information corresponding to the operational consequences information identified by the PMS team.

The GUI 900 comprises text box 906 for providing an affirmative or negative response as to whether, if the label being analyzed falls off, such falling off might cause equipment damage. If the PMS team determines affirmatively/negatively that there may be equipment damage consequences, the GUI 900 further provides a pushbutton 913, and when the button 913 is selected, the PML 214 displays an editable text box (not shown) for entering detailed information corresponding to the equipment damage information identified by the PMS team.

The GUI 900 comprises text box 907 for providing an affirmative or negative response as to whether, if the label being analyzed falls off, is the level of risk associated with such falling acceptable. If the PMS team determines affirmatively/negatively that the level risk associated with the label falling off is acceptable, the GUI 900 further provides a pushbutton 914, and when the button 914 is selected, the PML 214 displays an editable text box (not shown) for entering detailed information corresponding to details regarding the level of risk associated with the label(s) falling off identified by the PMS team.

In light of the information provided regarding the consequences of the label falling off, the PMS team then determines whether the label being analyzed is recommended. If the team determines that the label is recommended, the GUI 900 comprises a box 908 for entering an affirmative indication, i.e., a “Yes” or a “Y,” that indicates that the label is recommended. Otherwise, the facilitator 101 can enter data indicating that the team does not recommend the analyzed label, i.e., a “No” or a “N.” If a negative entry is made in text box 908, the PML 214 displays a dialog box (not shown) that asks whether to continue to the DPM analysis, as described with respect to FIG. 17.

The GUI 900 further comprises a “First Iteration” selection box 961 for selecting whether the recommendation made in box 908 is a result of a first iteration of the algorithm exhibited by GUI 700 (FIG. 14), GUI 800 (FIG. 15), and GUI 900 (FIG. 16). If it is not the first iteration, then the facilitator 101 selects a negative indication form the pull down box 961. In one embodiment, the facilitator 101 selects the pushbutton 962, and the PML 214 displays an editable text (not shown) for entering data describing the first iteration so that an audit trail of decisions can be maintained.

As described herein, DPM is distinguishable from marking via a label. In this regard, DPM refers to placing part information directly on the part. Thus, the PMS team determines whether the part is conducive to DPM by using the GUI 1000 depicted in FIG. 17 and the GUI 1100 depicted in FIG. 18.

Furthermore, GUI 1000 and GUI 1100 embody an exemplary algorithm, e.g., algorithms 2801-2803 (FIG. 2), which will be indicated further herein.

The exemplary GUI 1000 comprises a plurality of questions corresponding to an algorithm for deciding upon a DPM technique. In this regard, the GUI 1000 comprises a text box 1002 for indicating whether the part composition is a metal or a nonmetal. Exemplary metals include, for example, titanium or aluminum. Exemplary nonmetals include, for example, rubber, plastic, or composite materials. As described hereinabove, different materials will have different algorithms associated with them. Thus, the GUI 1000 will change depending upon the type of part that is being analyzed.

In this regard, the text box 1002 may comprise a pull down menu 1001 that lists a plurality of options for the facilitator 101 and the PMS team when selecting data in response to this question. The menu may comprise the different available selections, e.g., metal or nonmetal. Note that the questions related to DPM may vary depending upon the particular application of the GUI 1000. Furthermore, the PML 214 determines the algorithm that is employed in GUI 1100 based upon the selections made on GUI 1000 (FIG. 17). In this regard, if it is a metal and that metal is further identified as “aluminum”, then an algorithm comprising marking options corresponding to techniques that are to be used for marking aluminum is displayed when the algorithm is run by selecting a “Run Algorithm” pushbutton 1012, described further herein.

The GUI 1000 further comprises a text box 1004 for indicating whether the surface of the part is painted. In this regard, the text box 1004 may comprise a pull down menu (not shown) actuated by selecting the arrow 1003. The menu may comprise the different available selections, e.g., painted/not painted or true/false. Further, the facilitator may enter an affirmative or negative response, for example, if the surface is painted, the facilitator 101 enters a “Yes” or a “Y” in the text box 1004 by entering text into the box 1004 or selecting an affirmative indication from a pull down menu displayed by selecting the arrow 1003. Again, the algorithm employed to determine whether the part can be marked using DPM and the marking options available for marking the part may aid in defining the algorithm that is employed in GUI 1100, described further herein.

The GUI 1000 further comprises a text box 1006 for indicating whether the surface can be prepared for DPM application. In this regard, the text box 1006 may comprise a pull down menu (not shown) actuated by selecting the arrow 1005. The menu may comprise the different available selections, e.g., “yes” or “no.” Note that if the surface cannot be prepared for DPM, and the facilitator 101 answers “no” in box 1006 via the pull down menu 1005, then the PML 214 runs an algorithm that is unique to the negative response provided in pull-down menu 1005.

The GUI 1000 further comprises a text box 1008 for indicating the type of metal that the part is made of. In this regard, the text box 1008 may comprise a pull down menu (not shown) actuated by selecting the arrow 1007. The menu may comprise the different available selections, e.g., aluminum, steel, bronze, and/or brass. Note that the pull down selections, e.g., aluminum, steel, bronze, etc., can be populated depending upon the type of application for which the PMS 100 is being used for a specific implementing entity. Furthermore, the PML 214 determines the algorithm that is employed in GUI 1100 based upon the selection made in text box 1008. In this regard, if the part is aluminum, then an algorithm comprises DPM marking options corresponding to techniques that are technically possible for marking aluminum and is displayed when the algorithm is run by selecting a “Run Algorithm” pushbutton 1012, described further herein. Furthermore, the answers in text boxes 1002 and 1008 determine the “Metal Group” 1010 in which the part is a member. In this regard, there may be several metals, e.g., aluminum and steel, which belong to the same metal group in that the same algorithm can be used to determine the type of DPM that can be employed to mark the part.

When the facilitator 101 selects the button 1012, the PML 214 displays a GUI 1100 described in more detail with reference to FIG. 18. The GUI 1100 aids the PMS team in deciding which type of DPM is recommended in regard to the part being analyzed.

Once the algorithm is run, the GUI 1000 comprises a “DPM Analysis Results” box 1015 that indicates whether DPM is possible and what types of DPM are possible and not possible for the part being analyzed.

In this regard, the box 1015 indicates in a text box 1016 an affirmative or a negative indication of whether it is possible to use DPM. If DPM is possible at all, the box 1015 further comprises boxes 1018-1021 that indicate which types of DPM are possible, and boxes 1022-1025 that indicate which types of DPM are not possible.

Further, the GUI 1000 comprises a text box 1088 or a pull down menu (not shown) that allows the facilitator 101 to choose which DPM technique is recommended by the PMS team.

As indicated hereinabove, when the facilitator 101 selects the button 1012, the PML 214 displays GUI 1100 of FIG. 18. The PML 214 selects one of a plurality of algorithms that are coded into PML 214 prior to analysis and are based on the specific implementation strategies for a particular implementing entity for display in GUI 1100 based upon the answers to the queries in GUI 1000 (FIG. 17).

The GUI 1100 enables the PMS team to determine which types of DPM are technically appropriate, if any. In this regard, the GUI 1100 comprises a text box 1102 for displaying the metal identified in box 1010 (FIG. 17) and a text box 1104 for displaying the part number associated with the part currently being analyzed. Furthermore, the GUI 1100 provides a box 1106 for indicating which step the PMS team is currently on as it goes through each step in the algorithm depicted in GUI 1100.

As noted herein, the algorithm displayed in GUI 1100 depends upon answers to questions in GUI 1000. In this regard, the algorithm in GUI 1100 comprises four decision areas 1196-1200. As the facilitator 101 enters data indicative to options related to each of the part marking techniques, the PML 214 determines, based upon the data entered, whether the marking technique related to the data being entered is possible or not possible. The PML 214 then automatically moves the facilitator 101 on the GUI from one marking technique area 1196-1200 to another.

In decision area 1200, the PMS team analyzes whether the part generally can be marked using a DPM method by displaying questions (not shown) related to general technical DPM limitations. For example, if the part has a surface on which a DPM can be placed or if the surface thickness is adequate for placing a DPM. Note that these questions are configurable based upon the implementing entity for which the particular PMS 100 is designed. For example, aerospace research may disallow DPM for surfaces of a particular thickness or made of a particular type of metal. If the facilitator 101 enters data, based upon input from the PMS team, that indicates that DPM is possible, then the PML 214 automatically controls the analysis flow by highlighting and/or disabling selected decision areas based upon the options selected by the facilitator 101 corresponding to the technical limitations of each DPM technique as described further herein. In this regard, as described herein, the algorithm displayed comprises the decision areas 1196-1199 corresponding to DPM techniques determined to be technically appropriate for the material displayed in text box 1102.

Note that, based upon the answers to the questions in decision area 1200, none or all of the decision areas 1196-1199 may be made editable by the PML 214. Likewise, based upon the answers to the questions in decision areas 1196-1199, one or more of the decision areas 1196-1199 may be made editable by the PML 214.

In one embodiment, if each general technical DPM limitation in decision area 1200 is answered affirmatively, then the PML 214 enables each of the decision areas 1196-1199. However, in other embodiments of the algorithm, other combinations of enabled/disabled decision areas 1196-1199 are possible and are dependent upon the affirmative/negative selected options in decision areas 1196-1199.

If each decision area 1196-1199 is technically appropriate, the PML 214 enables all decision areas 1196-1199 and automatically moves an indicator (not shown) to the dot peen technical limitations 1161. Thus, the facilitator 101 and the PMS team may then provide affirmative/negative responses corresponding to the dot peen technical limitations 1161 of the decision area 1196. If during analysis of the dot peen technical limitations 1161 the facilitator 101 enters a negative response, then the PML 214 automatically moves the indicator to the ink jet technical limitations 1162 of the decision area 1197, and if the answers to such technical limitations indicate that dot peen can not be performed, then the PML 214 (FIG. 4) places a “No” in text box 1144. If the answers to such technical limitations indicate that dot peen can be performed, then the PML 214 (FIG. 4) places a “Yes” in text box 1130.

Thus, as indicated herein above, after it is determined whether or not dot peen is possible, the PML 214 automatically moves the indicator to the ink jet technical limitations 1162 of the decision area 1197. If during analysis of the ink jet technical limitations 1162 the facilitator 101 enters a negative response, then the PML 214 automatically moves the indicator to the laser bond technical limitations 1163 of the decision area 1198, and if the answers to such technical limitations indicate that ink jet can not be performed, then the PML 214 (FIG. 4) places a “No” in text box 1145. If the answers to such technical limitations indicate that ink jet can be performed, then the PML 214 (FIG. 4) places a “Yes” in text box 1140.

Thus, as indicated herein above, after it is determined whether or not ink jet is possible, the PML 214 automatically moves the indicator to the laser bond technical limitations 1163 of the decision area 1198. If during analysis of the laser bond technical limitations 1163 the facilitator 101 enters a negative response, then the PML 214 automatically moves the indicator to the chemical etching limitations 1164 of the decision area 1199, and if the answers to such technical limitations indicate that laser bond can not be performed, then the PML 214 (FIG. 4) places a “No” in text box 1160. If the answers to such technical limitations indicate that laser bond can be performed, then the PML 214 (FIG. 4) places a “Yes” in text box 1162.

Thus, as indicated herein above, after it is determined whether or not laser bond is possible, the PML 214 automatically moves the indicator to the chemical etch technical limitations 1164 of the decision area 1199. If during analysis of the chemical etch technical limitations 1164 the facilitator 101 enters a negative response, then the PML 214 places a “No” in the text box 1146 and the algorithm terminates. If the answers to such technical limitations indicate that chemical etching can be performed, then the PML 214 (FIG. 4) places a “Yes” in text box 1148 and the algorithm terminates

Note that, the decision areas 1196-1199 are arranged in succession within the algorithm so that each decision area 1196-1199 is enabled/disabled as a result of the affirmative/negative answers to the general technical limitations or preceding technical limitations 1161-1163. In this regard, the PML 214 automatically moves the indicator from the preceding decision area 1200 or 1196-1198 to the next decision area 1196-1199. However, in other embodiments, the decision areas may be enabled/disabled and the indicator may be automatically moved independent of the affirmative/negative answers to the preceding technical limitations 1161-1163.

In yet another embodiment, if in decision area 1200, based upon options selected in the general technical DPM limitations 1200, the PML 214 determines that chemical etching, for example, is the only technically appropriate DPM technique, the PML 214 may only enable chemical etching decision area 1199. Thereafter, chemical etch decision area 1199 behaves as described herein above.

As noted herein above, if the questions answered in the general technical DPM limitations in decision area 1200 indicate that more than just chemical etching decision area 1198 is technically appropriate, those applicable decision areas 1196, 1197, and 1199 are enabled by the PML 214.

Note that, the DPM techniques illustrated in GUI 1100 are for exemplary purposes and varying combinations of those identified DPM techniques or different DPM techniques may be used in other embodiments. Further note that, four DPM techniques are shown in the algorithm in GUI 1100 for exemplary purposes. However, other quantities of DPM techniques in other embodiments are possible.

GUI 1100 further comprises a “Facilitator Use” menu 1121. The menu 1121 provides text boxes 1167 and 1169 for entering additional information related to the part being analyzed. In this regard, if there is additional information needed in order to make a determination as to the label algorithm, the facilitator 101 selects the “Parking Lot” pushbutton 1167, and the PML 214 displays an editable text box (not shown) for entering information corresponding to the additional information needed for the analysis. The PML 214 then enters an indication in the “Parking Lot” box 1166, e.g. a check mark, indicating that additional information is needed. Further, the GUI 1100 provides the “DPM Remarks” check boxes 1168, and the PML 214 enters an indication in the check box 1168 that there are DPM remarks associated with the part being analyzed if the facilitator 101 enters data by selecting the “DPM Remarks” pushbutton 1169. Thus, when the facilitator 101 selects the “DPM Remarks” pushbutton 1169, the PML 214 displays an editable text box (not shown) for entering information corresponding to the remarks related to the analysis.

Further, the “Facilitator Use” menu 1121 comprises a “Start Over” button 1170. Thus, if the facilitator 101 and/or the PMS team determine that the algorithm being performed needs to be started over, the PML 214 resets the GUI 1100 when the facilitator selects button 1170. The menu 1121 also comprises a “Return to DPM” button 1172, and if the facilitator 101 determines that the GUI 1000 (FIG. 17) is needed during the analysis, the PML 214 displays the GUI 1000 when the facilitator 101 selects the button 1172.

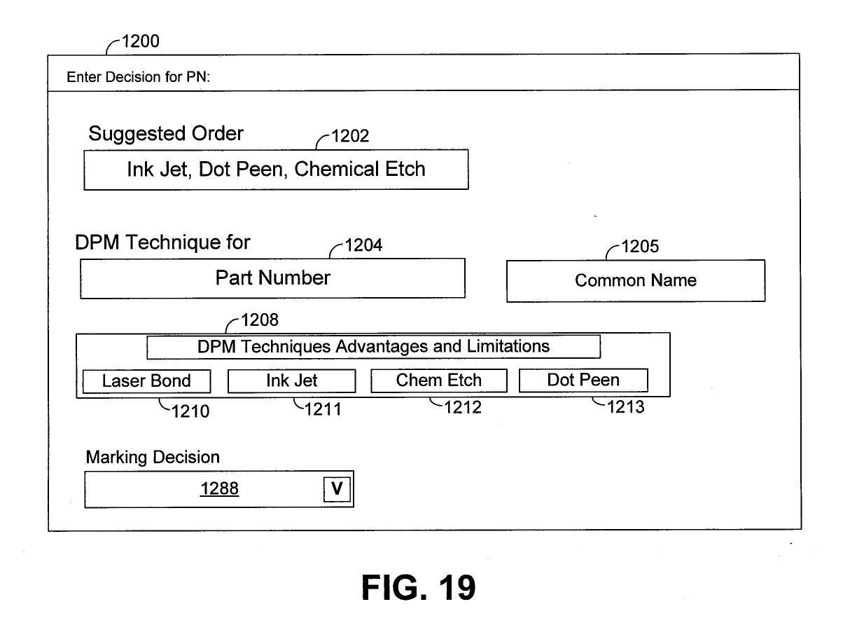

With respect to FIG. 17, once the PMS team has completed running the algorithm in FIG. 18, the facilitator 101 may select the “Enter Decision” button 1014. When button 1014 is selected, the PML 214 displays the “Enter Decision for PN” GUI 1200 depicted in FIG. 19.

GUI 1200 illustrated in FIG. 19 comprises a text box 1202 for displaying the suggested order of the parts marking as a result of the DPM algorithm. Such suggested order is predetermined during the implementation information and strategies development, therefore, the text field 1202 is pre-populated. As an example, text field 1202 might exhibit “ink jet, dot peen, chemical etch,” and this order may have been determined based upon cost or other factors.

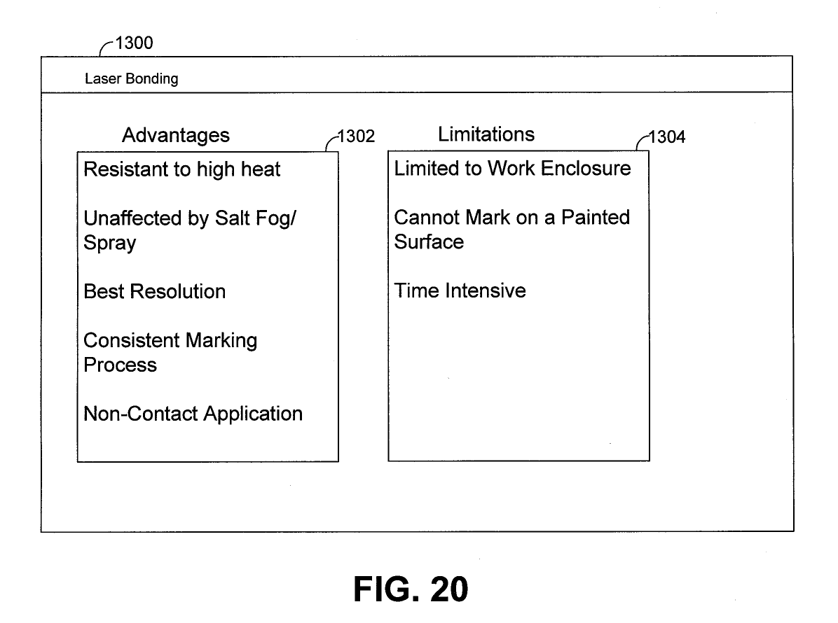

Further, the GUI 1200 comprises text box 1204 for displaying the current part number and a text box 1205 for displaying the current part common name. Further, the GUI 1200 comprises a “DPM Techniques Advantages and Limitations” menu 1208 that shows each of the DPM techniques included in PML 214. The menu comprises pushbuttons 1210-1213 that, when selected, displays the advantages and limitations associated with each DPM technique. Menu 1208 provides a laser bonding button 1210, ink jet button 1211, chemical etching button 1212, and dot peen button 1213, and if the facilitator 101 selects, for example, the laser bond button 1210, the PML 214 displays GUI 1300 of FIG. 20 for PMS team reference purposes. The GUI 1200 further comprises a text box 1288 for entering data indicative of a technically appropriate DPM method chosen by the PMS team for marking the part as a result of the algorithm.

GUI 1300 provides a summary of the advantages and limitations corresponding to laser bond DPM. In this regard, the GUI 1300 may comprise a box 1302 enumerating the advantages of laser bond DPM, which may include that laser bond parts marking is resistant to high heat, is unaffected by salt, fog, and/or spray, exhibits the best resolution, is consistent, and is a non-contact application. On the other hand, the GUI 1300 may comprise a box 1304 enumerating the limitations of laser bond parts marking, which may include that the laser bond parts marking is limited to the work enclosure, it cannot be used to mark on a painted surface, and it is time intensive. GUI 1300 in FIG. 20 displays advantages and limitations specific to laser bonding, however, other techniques will be correlated with other Advantages/Limitations for display in GUI 1300 in other embodiments.

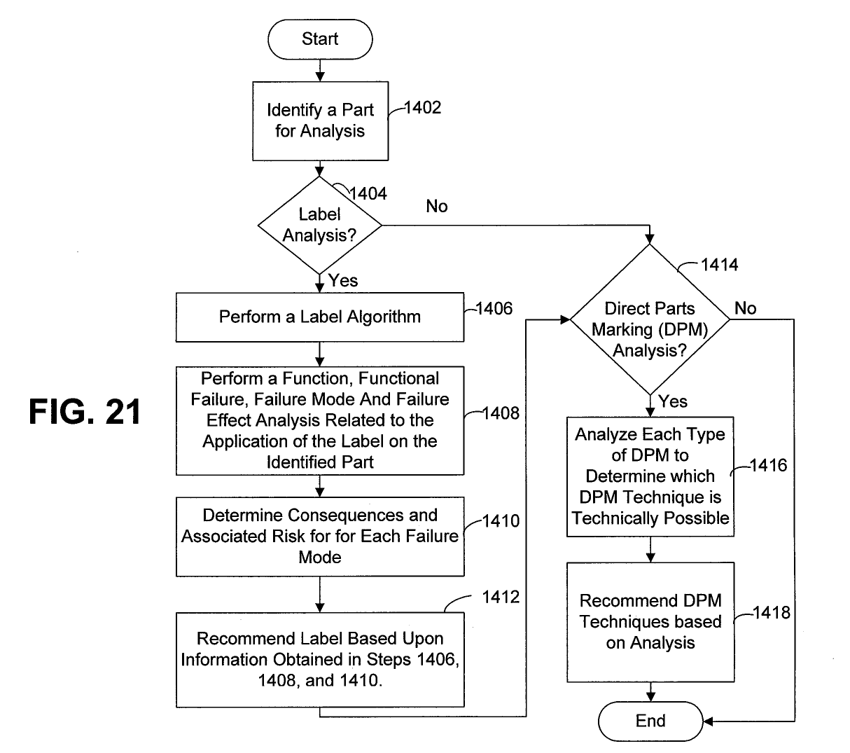

FIG. 21 is a flowchart illustrating an exemplary parts marking process of the present disclosure.

The facilitator 101 and/or the PMS team identify a part for analysis in step 1402. Preferably, information relating to the part identified is gathered prior to any parts marking analysis. For example, the facilitator 101 may collect information including a drawing and/or a photograph or a specification sheet corresponding to the part. Furthermore, as described herein, data relating to a part may be pre-populated prior to the analysis in but not limited to the “General” GUI 600 depicted in FIG. 13.

The PMS team then determines whether a label analysis is desired in step 1404. If a label analysis is not desired in step 1404, then the PMS team determines in step 1414 whether a DPM analysis is desired.

If a label analysis is desired, then the PMS team performs a label algorithm in step 1406. In this regard, the PMS team determines whether a one-part or two-part label, for example, can be used on the part. Further, the PMS team determines a location for the label, adverse conditions that may affect the label, and other installation instructions. Note that such technical limitations corresponding to a label algorithm are configurable and may change depending upon the implementation strategy and the implementing entity.

The PMS team then performs a function, functional failure, failure mode and failure effect analysis related to the application of the label on the identified part in step 1408. The PMS team then determines consequences and associated risk of each failure mode in step 1410.

Based upon the information obtained in steps 1406, 1408, and 1410, the PMS team provides a recommendation on the type of label to use in step 1412.

If a label is not desired in step 1404 or in addition to recommending a label in step 1412, the PMS team may perform a direct parts marking (DPM) analysis to determine if DPM is desirable for the part under analysis in step 1414. If the team does not perform a DPM after it has been determined that a label is applicable for the part, the label is recommended for the part as indicated in step 1412. If DPM is not desirable, then the analysis ends. However, if DPM is desired, the PMS team analyzes each DPM technique that is pre-populated in the PMS 100 and determines which DPM technique is technically possible in step 1416.

After the PMS team determines the types of DPM that are technically appropriate for use on the part, the PMS team then determines a recommendation of a DPM technique based upon the PMS team analysis and a prioritized list pre-populated of DPM techniques that may be used to mark the part in step 1418.

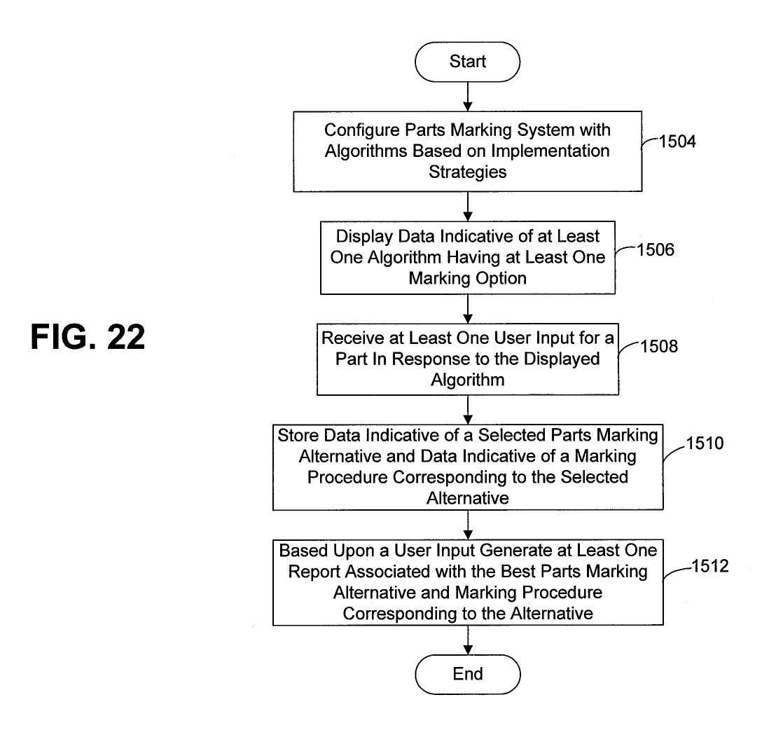

FIG. 22 is a flowchart depicting architecture and functionality of exemplary PML 214 (FIG. 2) of the present disclosure.

The PML 214 configures parts marking options based upon implementation strategies in step 1504. For example, an implementing entity may identify that it is technically appropriate to use labels and specific DPM techniques to mark parts. Such information is used to configure the PMS 100 such that options are made available to the PMS team during analysis to reflect the implementation strategies.

The PML 214 then stores data indicative of a plurality of parts for marking in step 1506. The PML 214 then receives data indicative of parts marking options corresponding to at least one of the parts in step 1508.

The PML 214 then stores data indicative of the determined best parts marking alternative and receives data indicative of a marking procedure corresponding to the selected alternative in step 1510. The PML 214 generates at least one report associated with the best parts marking alternative and marking procedure corresponding to the alternative in step 1512.

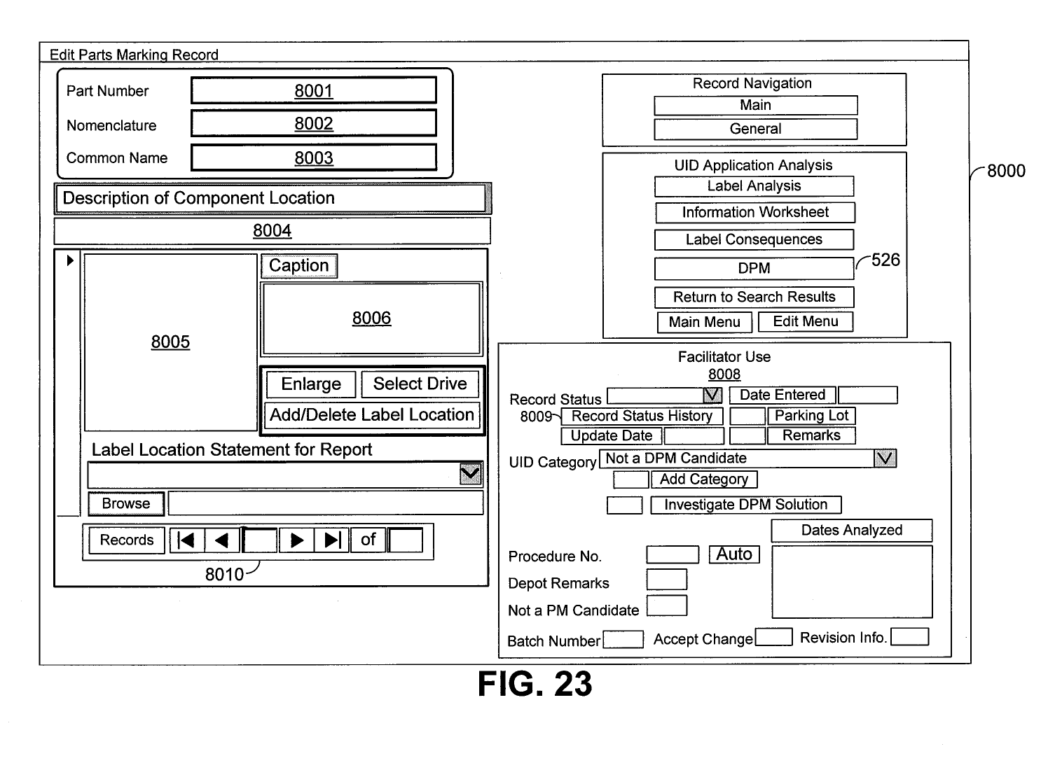

Another exemplary embodiment of the PMS 100 of FIG. 1 is now described with reference to FIGS. 23-42. In this regard, a user may double click on a string indicative of a part number that the PML 214 exhibits in a list (not shown) of part numbers resulting from a status query initiated by selecting pushbutton 1901 (FIG. 9), as an example. In addition, the user may be able to display the GUI 8000 of FIG. 23 from other GUIs in the PMS 100. In response to the double click, the PML 214 displays the “Edit Parts Marking Record Page” GUI 8000 depicted in FIG. 23.

The GUI 8000 displays information in text fields 8001-8004 and 8006 that describe the part number selected by the user. In this regard, text field 8001 displays the part number of the selected part, text field 8002 displays the nomenclature of the selected part, and text field 8003 displays the common name of the selected part. Furthermore, text field 8004 displays text describing the location of the part in the system in which it operates identified in text field 8001, image field 8005 displays a photograph of the selected part, if available, and text field 8006 displays a caption describing the photograph in image field 8005.

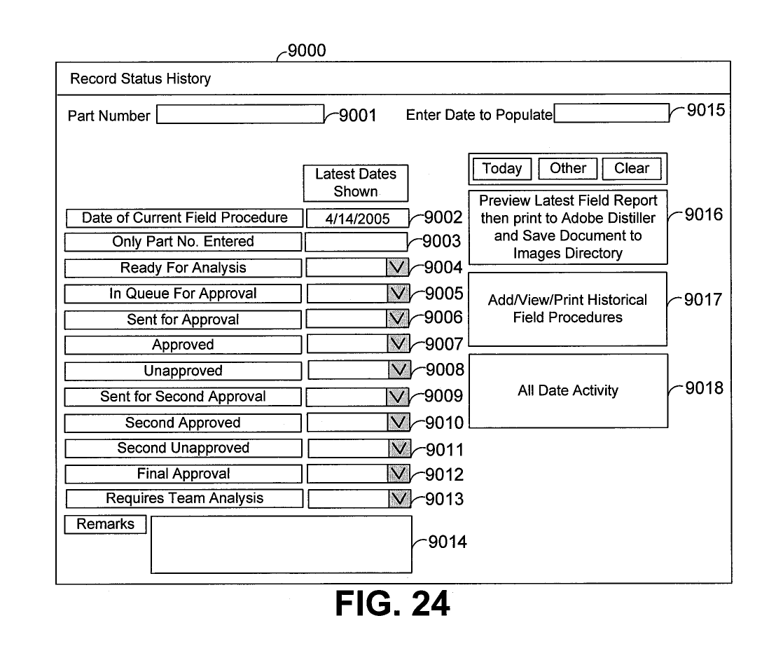

However, in addition to displaying that information related to the part number selected by the user in fields 8001-8006, the PML 214 further displays a scroll box 8010 that allows a user to scroll through a plurality of photographs displayed in image field 8005 related to the selected part. Further, the PML 214 displays a “Record Status History” pushbutton 8009 that behaves similar to the “Record Status History” pushbutton 560. However, when the pushbutton 8009 is selected, the PML 214 displays the “Record Status” GUI 9000 depicted in FIG. 24.

The GUI 9000 exhibits a plurality of text fields 9001-9015 for displaying information related to part marking procedure, as described hereinabove with reference to FIG. 11. The information displayed corresponds to the part number selected by the user, which is displayed in the “Part Number” text field 9001.

Notably, text fields 9002-9013 and 9015 display dates that indicate dates on which particular changes take place related to the status of the parts marking procedure corresponding to the selected part number identified in text field 9001. In this regard, text field 9002 displays the date that will be printed on the current parts marking procedure, e.g., 4/14/2005 as shown in FIG. 24. If the part number has been entered into the PMS 100, the text field 9003 displays the date on which the parts marking procedure data corresponding to the selected part number was entered into the PMS 100.

If the parts marking procedure is ready for analysis, text field 9004 displays the date that the parts marking procedure is ready for analysis. If the parts marking procedure corresponding to the selected part number is in queue for approval, for example for approval by the Research, Development, and Engineering Center in Corpus Christi, (“RDEC CORPUS”), the date that the parts marking procedure is entered in queue for that location is displayed in text field 9005. If the parts marking procedure corresponding to the part number has been sent for approval, the date sent is displayed in text field 9006, and if the parts marking procedure has been approved or disapproved, the dates of approval or disapproval are displayed in text fields 9007 and 9008, respectively.

Further, if the parts marking procedure has been sent to a second approval authority, for example AMCOM (“Aviation and Missile Command”) Engineering Directive (“AED”), the date that the parts marking procedure was sent is displayed in text field 9009. If the parts marking procedure is approved disapproved, or finally approved by the second approval authority, the date of approval, disapproval, or final approval is displayed in text fields 9010, 9011, and 9012, respectively. If the parts marking procedure needs further analysis, the date for the analysis is displayed in text field 9013, and any remarks corresponding to the parts marking procedure are displayed in text field 9014. If a user desires to select a date for population of the parts marking procedure, the user may enter a date into the text field 9015.

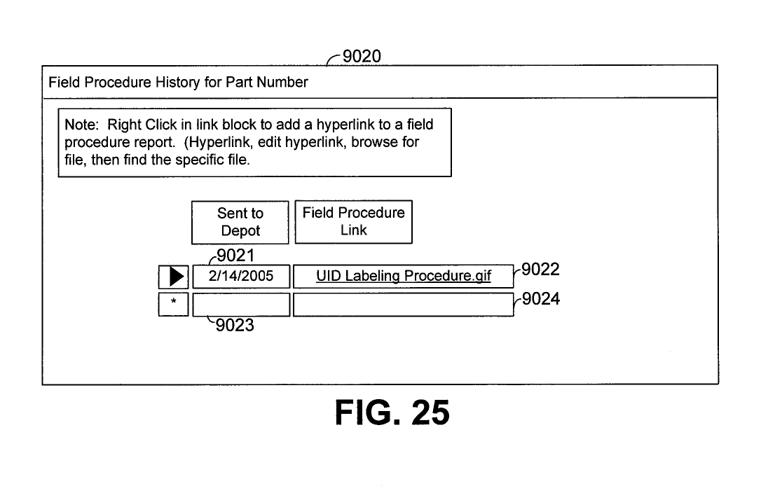

The GUI 9000 further comprises buttons 9016, 9017, and 9018. When the button 9016 is selected, the PML 214 displays the current parts marking procedure for the part identified in text field 9001. When the button 9017 is selected, the PML 214 displays the “Parts Marking Procedure History” GUI 9020 as depicted in FIG. 25. The GUI 9020 comprises text fields 9021 and 9023 for displaying dates associated with historical parts marking procedures corresponding to the selected part number. In addition, the GUI 9020 comprises text fields 9022 and 9024 for displaying hyperlinks, e.g., “UID Labeling Procedure.pdf,” that when selected displays the corresponding parts marking procedure to the display device 210.

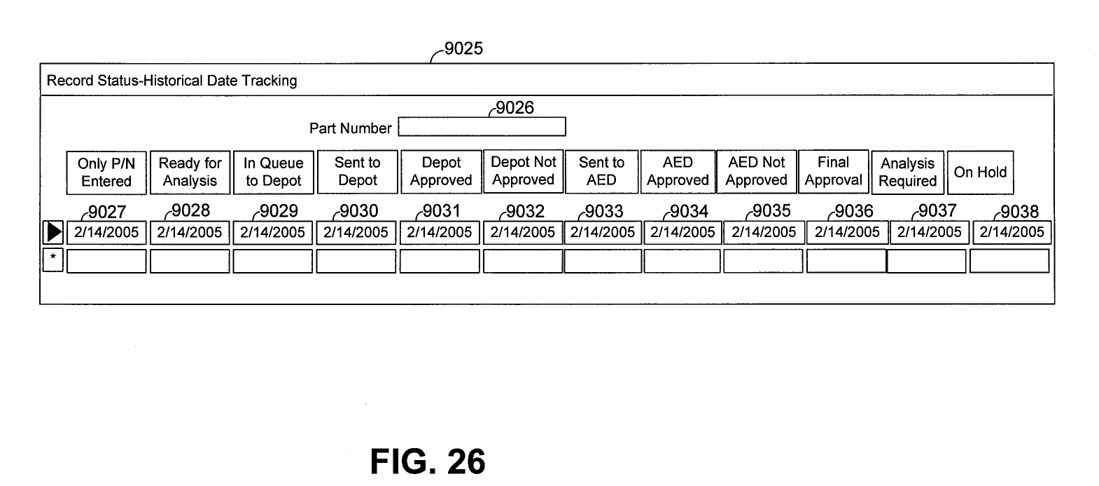

When the button 9018 is selected, the PML 214 displays the “Historical Date Tracking” GUI 9025 as depicted in FIG. 26. The GUI 9025 comprises text fields 9026 through 9038. Text field 9026 displays the selected part number, as described hereinabove. Further, text fields 9027-9038 display one or more dates associated with actions taken historically with respect to the parts marking procedure corresponding to the part number displayed in text field 9026.

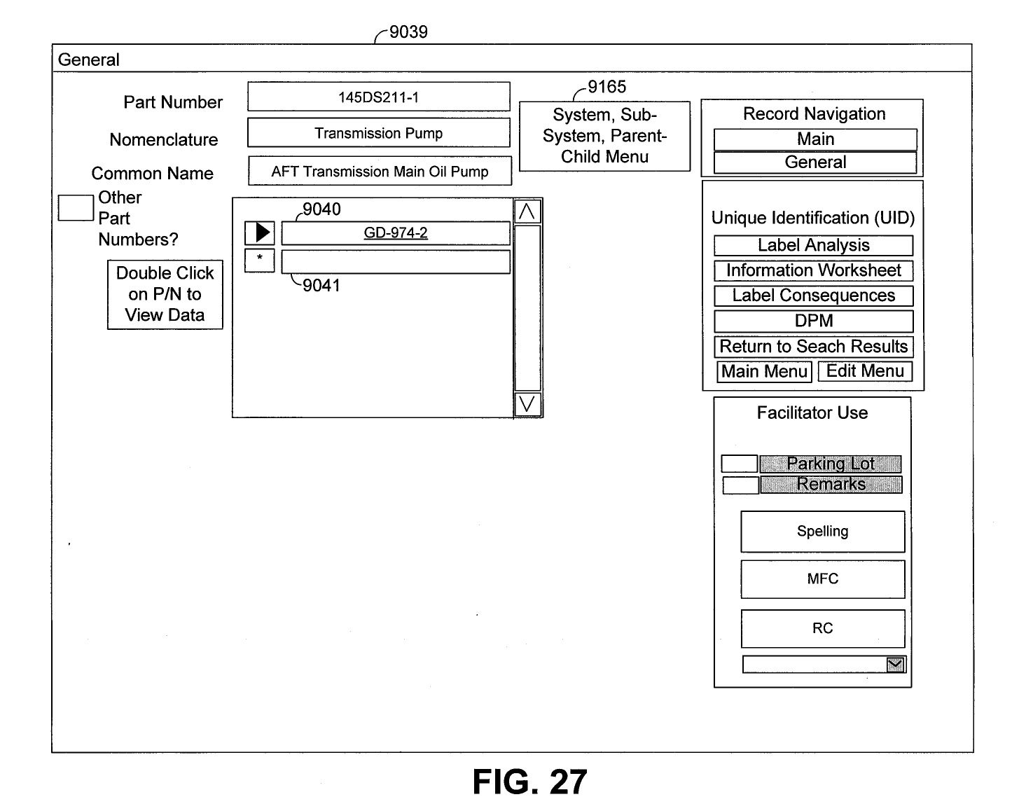

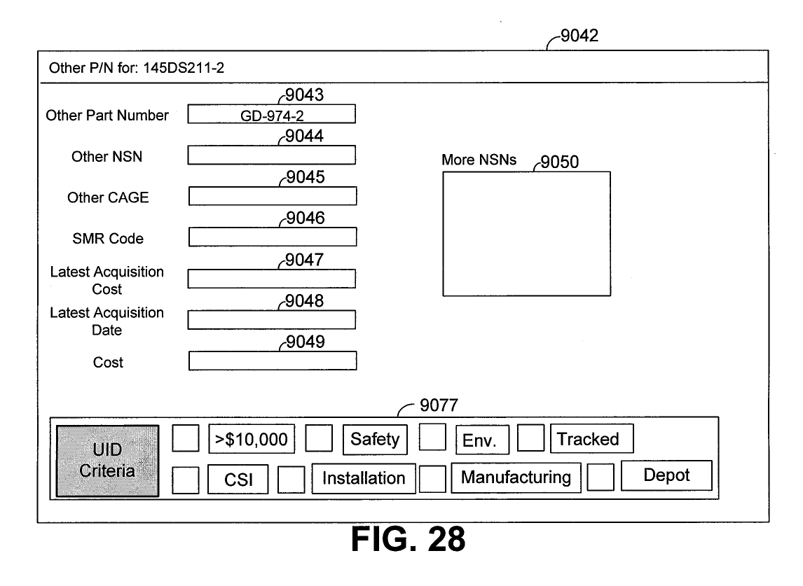

FIG. 27 depicts a “General” GUI 9039 for another embodiment of the PMS 100 of FIG. 1. The GUI 9039 is substantially similar to the GUI 600 depicted in FIG. 13. However, the GUI 9039 further comprises selectable part number text fields 9040 and 9041. When a link, e.g., GD-974-2, in text field 9040 or 9041 is selected, the PML 214 displays the “Other PN” GUI 9042 depicted in FIG. 28.

The GUI 9042 depicted in FIG. 28 comprises a plurality of text fields 9043-9050. Text field 9043 displays the other part number the user selected via a link in GUI 9039. In this regard, text fields 9044-9050 display and/or receive data via the input device 208 (FIG. 4) as additional data for describing the other part number. Thus, text fields 9044-9050 may receive data indicative of the other part number's NSN, a CAGE number, a SMR code, a latest acquisition cost, a latest acquisition date, a cost, and more associated NSNs in text fields 9044-9050, respectively. In addition, the UID Criteria for each part displayed in the GUI 9042 can be indicated in a menu box 9077.

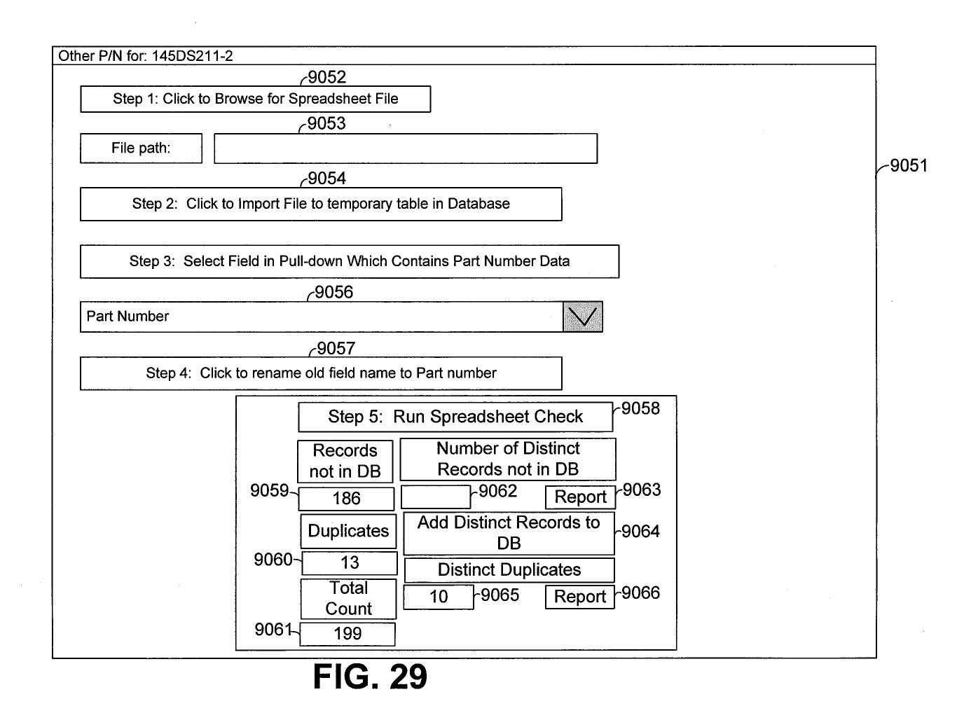

FIG. 29 depicts an “Spreadsheet Check” GUI 9051. The GUI 9051 comprises a button 9052 that, when selected, enables a user to search for a file located on the PMS 100 that comprises an excel spreadsheet. The spreadsheet preferably comprises a plurality of part numbers listed in a particular column of the spreadsheet. The user selects the spreadsheet that the user desires the PML 214 to search the database to determine whether each listed part number is present in the part data 226.

Once selected, the user may then select button 9054 to import the excel file into a database table. In addition, the user enters a field name in the pull-down selector 9056 that identifies the column name associated with the listed part numbers in the excel spreadsheet that has been imported. Once the column name is identified, the user selects the pushbutton 9057 to rename the field to the name selected, e.g., “Part Number.”

The user selects the pushbutton 9058, and the PML 214 determines the number of records associated with a part number listed in the imported table that are not currently in the part data 226 (FIG. 4) and displays this number in a “Records not in DB” text field 9059. The PML 214 further displays the number of part numbers found in the part data 226 that are in the imported table and displays such number in a “Duplicates” text field 9060, e.g., 13 records, and the PML 214 displays the total number of records compared in a “Total Count” text field 9061, e.g., 199 records. The PML 214 also displays the number of distinct records not found in the parts data 226 in the “Number of Distinct Recs not in DB” text field 9062 and the number of distinct duplicates in the “Distinct Duplicates” text field 9065. Further, the user may select the “Report” buttons 9063 and 9066 in order to obtain a printed or displayed report listing of the records not found in the part data 226 and the distinct duplicates, respectively. The user may select the “Add distinct Records to DB” button 9064 in order to add those distinct records that are not currently in the parts data 226 yet in the imported table to the parts data 226.

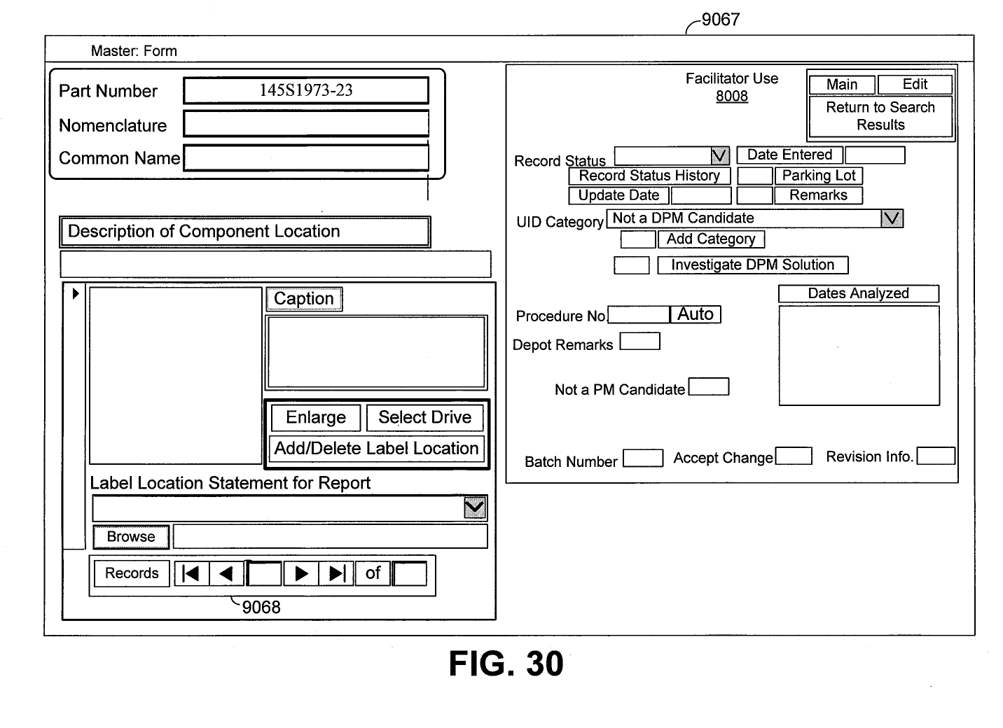

FIG. 30 depicts a “Master: Form” GUI 9067. The master form GUI 9067 may be used by the user to scrollably view a plurality of records associated with a plurality of respective part numbers. In this regard, the user may select a plurality of records, via a GUI that displays a listing of search results from GUI 400 depicted in FIG. 6, which the user desires to review. Once a plurality is selected, the PML 214 displays the first record of the plurality in GUI 9067.

As an example, the first record may correspond to part number “145S1973-23,” as shown in the “Part Number” text field in FIG. 30. The user may then use the buttons in box 9068 to traverse the records associated with the plurality of part numbers listed. In this regard, the user may select one of the buttons in box 9068 that displays the first or last record associated with the plurality of part numbers selected, as an example.

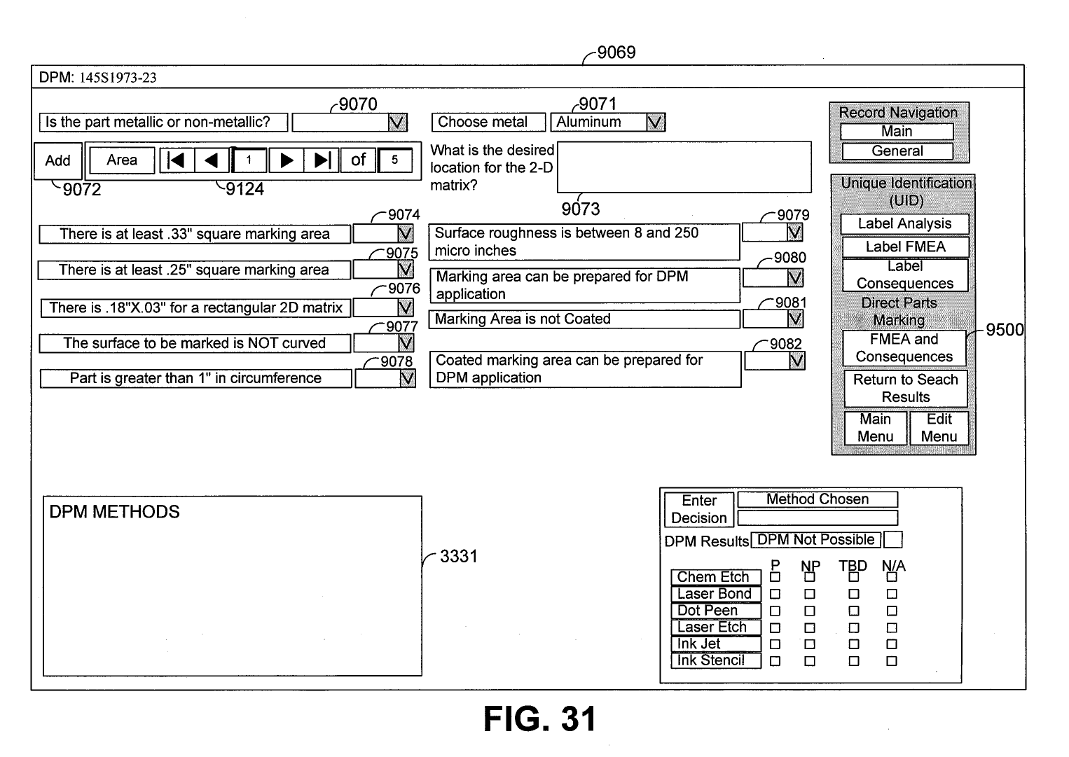

With reference to FIG. 23, in order to perform a DPM analysis, the user may select the DPM pushbutton 526 (FIG. 23). Once selected, the PML 214 displays the DPG GUI 9069 as depicted in FIG. 31. GUI 9069 receives data indicative of the type of DPM that may be applicable to the part associated with the part number displayed in the text box 8001 (FIG. 23). As an example, the DPM analysis described further herein will be described with reference to part number “145S1973-23.”

The user selects whether the part is metallic via a pull down menu 9070 and the type of metal of which the part consists in pull down menu 9071. Further, the DPM GUI 9069 comprises an “Add” button 9072. When selected, the PML 214 enables a user to add a desired marking location area on the selected part corresponding to the selected part number on which a 2-D matrix may be applied. For example, the part associated with the part number displayed, e.g., “145S1973-23,” may comprise a plurality of surfaces that may be analyzed for marking, each marking location hereinafter is referred to as a distinct “area.” Thus, the GUI 9069 enables a user to analyze different areas on the part to determine which area is a more effective marking area. In this regard, there may be an area capable of accepting a 2-D matrix, whereas there may be another area on the part that is incapable.

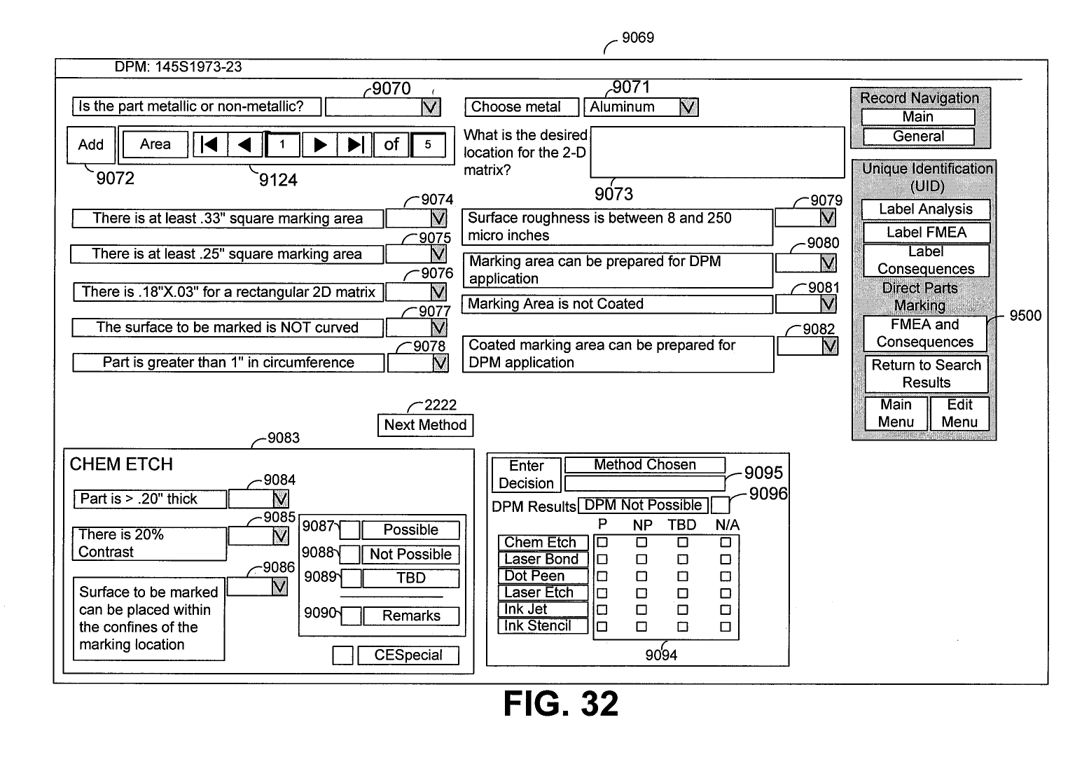

Depending upon the answers indicated by the user in a plurality of pull-down selection boxes 9074-9082, a plurality of DPM methods may be available for the area described for the part selected. For example, FIGS. 32-37 describe GUIs for DPM methods including chemical etching, dot peen, laser etching, ink jet, ink stencil, and laser bond. Note that each of these methods has different requirements if the particular method is to be used on the area described for the part selected.

In this regard, if the user indicates, via the box 9074 that “There is at least 0.33″ square marking area,” the PML 214 deactivates boxes 9075 and 9076. The user may only then enter whether the area to be marked is curved in box 9077. Notably, if the area is curved, DPM is not possible, therefore, the analysis is parked and the solution is investigated and recorded in the database.

However, if the area is not curved, the user indicates in box 9078 whether the circumference is greater than one inch and in box 9079 whether the surface roughness/finish is between 8 and 250 micro-inches. If it is not, the user indicates in box 9080 whether the marking area can be prepared for DPM application. If it cannot, then DPM is not possible, and the analysis of the area is parked and the solution is investigated and recorded in the database.

If it can, however, then the analysis can continue at box 9081. If the surface roughness/finish is between 8 and 250 micro-inches, in box 9079, the user indicates true, the PML 214 deactivates box 9080, and the user indicates whether the marking area is not coated in box 9081. If the marking area is not coated, then the part area can be marked using DPM techniques, and the PML 214 deactivates out the box 9082. However, if it is coated, the user indicates in box 9082 whether the marking area can be prepared for DPM application, e.g., the coating removed or neutralized.

Once the user answers the aforedescribed questions, the PML 214 scrollably displays available marking techniques as described further with reference to FIG. 32-37. In this regard, if chemical etching is available based upon the user's responses in pull-down boxes 9074-9082, the PML 214 determines whether chemical etching is available for analysis. If it is available, the PML 214 displays a “CHEM ETCH” analysis box 9083 for the area described for the part number selected in FIG. 32.

With reference to FIG. 32, box 9083 comprises questions and corresponding selection pull-down boxes 9084-9086 that, when answered and selected, respectively, determine whether the area described may be marked using a chemical etching method as described hereinabove.

If the part is greater than 0.20 inches thick, then the user selects an indicator in box 9084. If there is a 20% contrast difference then the user selects an indicator in the box 9085, and if the surface to be marked can be placed within the confines of the marking location, then the user selects an indicator in the box 9086. If the questions are answered negatively, then the area cannot be marked using chemical etching, and the PML 214 displays an indicator in an indicator box 9088 that indicates that chemical etching is not possible. If all the queries are affirmative, then the PML 214 indicates in an indicator box 9087 that chemical etching is possible. If there is not enough information, then an indicator is placed in box 9089 indicating that chemical etching is to be determined.

Note that the GUI 9069 comprises a box 9094 having a plurality of indicator boxes associated with each DPM method. In this regard, each DPM method is associated with four selection boxes, including a “P” box for indicating that the associated method is possible, an “NP” box for indicating that the associated method is not possible, a “TBD” box for indicating that the associated method is to be determined, an “N/A” box for indicating that the method is not applicable. Thus, if it is determined that a particular method is possible, not possible, to be determined, or not applicable, then the PML 214 places an indicator in the respective box corresponding to the particular method. Further, if DPM is not possible, as described hereinabove, then an indicator is displayed in box 9096. During DPM analysis, the user may enter a “Method Chosen” in the text box 9095.

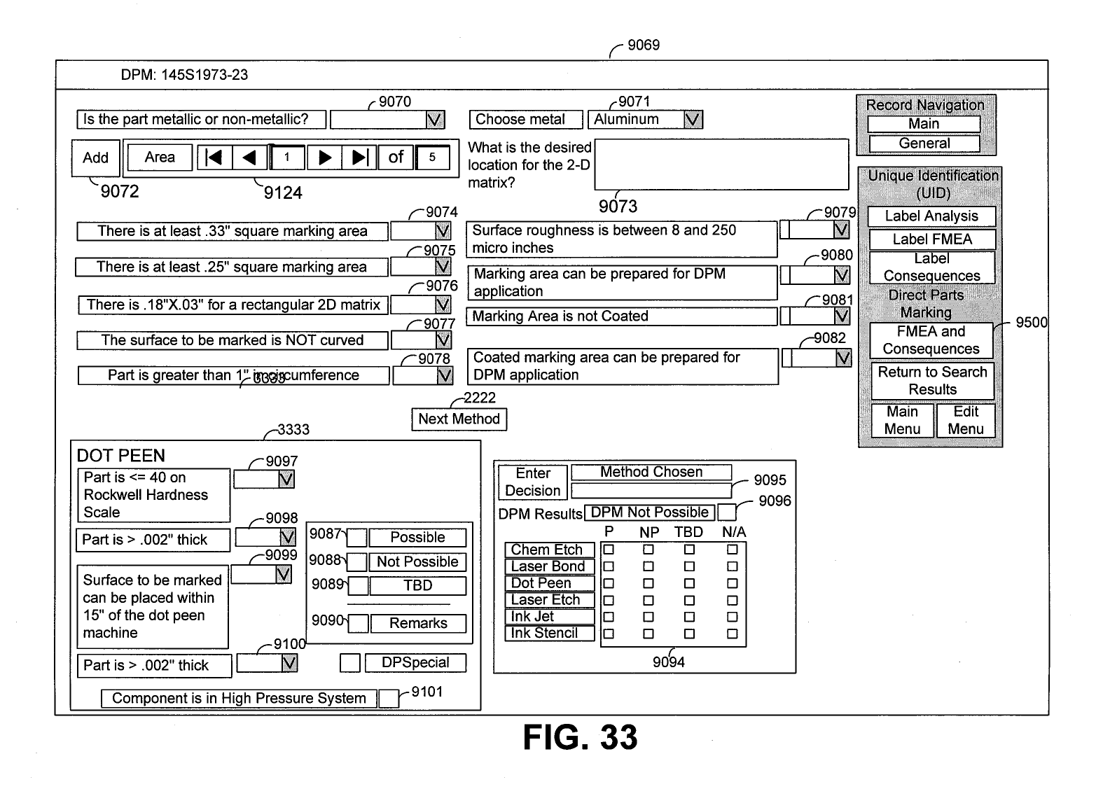

Once the aforedescribed chemical etching analysis is complete, the user may select the “Next Method” button 2222, and the next method available is displayed as shown in FIG. 33. For example, the PML 214 displays a “DOT PEEN” analysis box 3333, which behaves substantially similar to the CHEM ETCH analysis box 9083 except that because the criteria are different for DOT PEEN, the questions are different.

The PML 214 displays questions and corresponding selection pull-down boxes 9097-9100 that, when answered and selected, respectively, determine whether the Area described may be marked using a dot peen method as described hereinabove.

If the part is less than or equal to 40 on Rockwell Hardness C-Scale, then the user selects an affirmative indicator in box 9097. If the part is greater than 0.002 inches thick, the user selects an affirmative indicator in the box 9098, and if the surface to be marked can be placed within fifteen inches of a dot peen machine, then the user selects an affirmative indicator in the box 9099. Finally, if there is a 20% contrast different the user enters an affirmative indicator in box 9100. As described with reference to the CHEM ETCH analysis box 9083, if the questions are answered negatively, then the area cannot be marked using dot peen, and the PML 214 displays an indicator in an indicator box 9088 that indicates that dot peen is not possible. If all the queries are affirmative, then the PML 214 indicates in an indicator box 9087 that dot peen is possible. If there is not enough information, then an indicator is placed in box 9089 indicating that dot peen is to be determined. Further, if the component is a high-pressure system, then the user selects the selection box 9101.

Furthermore, as described with reference to FIG. 32, if dot peen is possible, not possible, to be determined, or not applicable, then the PML 214 displays an indicator in one of the boxes in box 9094 associated with the dot peen method based upon the indicators provided in boxes 9097-9100.

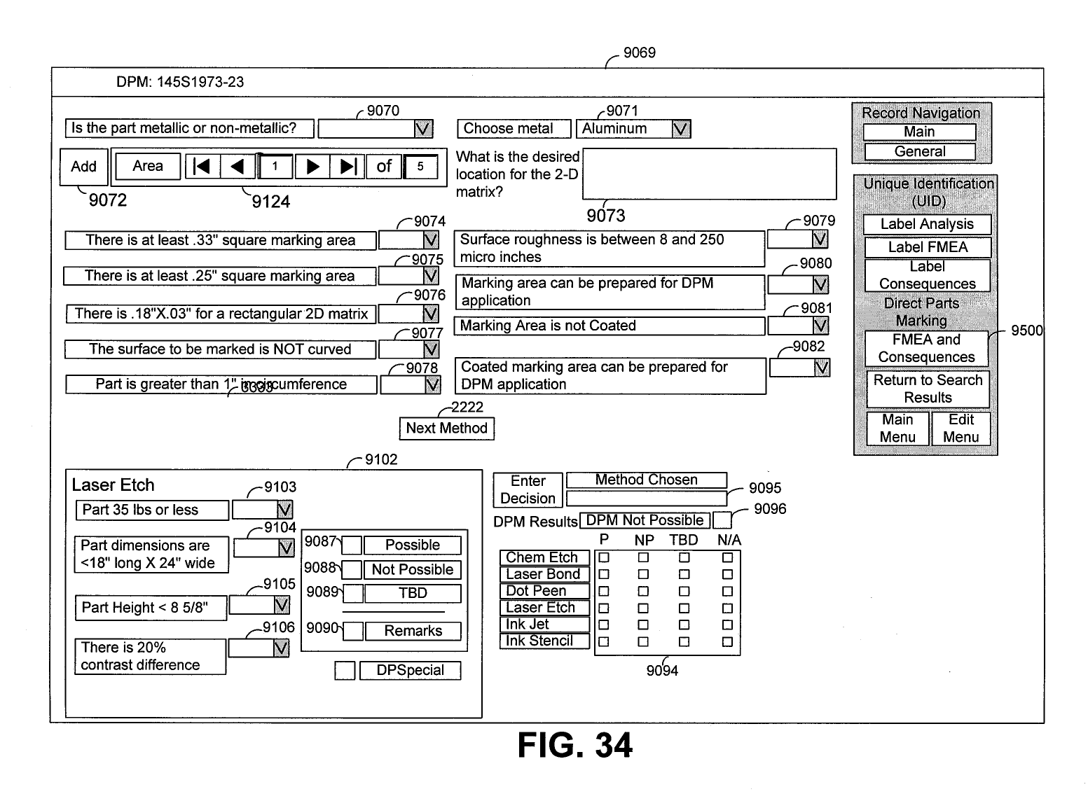

Once the aforedescribed dot peen analysis is complete, the user may select the “Next Method” pushbutton 2222, and the next method available is displayed as shown in FIG. 34. For example, the PML 214 displays a “LASER ETCH” analysis box 9102, which behaves substantially similar to the CHEM ETCH analysis box 9083 except that because the criteria are different for LASER ETCH, the questions are different.

The PML 214 displays questions and corresponding selection pull-down boxes 9103-9106 that, when answered and selected, enables the PML 214 to determine whether the Area described may be marked using a laser etching method as described hereinabove.

If the part is 35 pounds or less, then the user selects an affirmative indicator in box 9103. Note that if the part is not 35 pounds or less, the user selects a negative indicator, and the PML 214 deactivates the remainder of the laser etching queries associated with boxes 9104-9106. Furthermore, if the part dimensions are less than 16″ long by 24″ wide, the user selects an affirmative indicator in the box 9104. If the part height is less than 8 5/8″, then the user selects an affirmative indicator in the box 9105. Finally, if there is a 20% contrast difference, the user selects an affirmative indicator in box 9106.

If the questions are answered negatively, the area cannot be marked using laser etching method, and the PML 214 displays an indicator in an indicator box 9088 that indicates that laser etching is not possible. If all the queries are affirmative, then the PML 214 indicates in an indicator box 9087 that laser etching is possible. If there is not enough information, then the PML 214 places an indicator in box 9089 indicating that laser etching is to be determined.

Furthermore, as described with reference to FIG. 32, if laser etching is possible, not possible, to be determined, or not applicable, the PML 214 displays an indicator in one of the boxes in box 9094 associated with the laser etching method based upon the indicators provided in boxes 9103-9106.

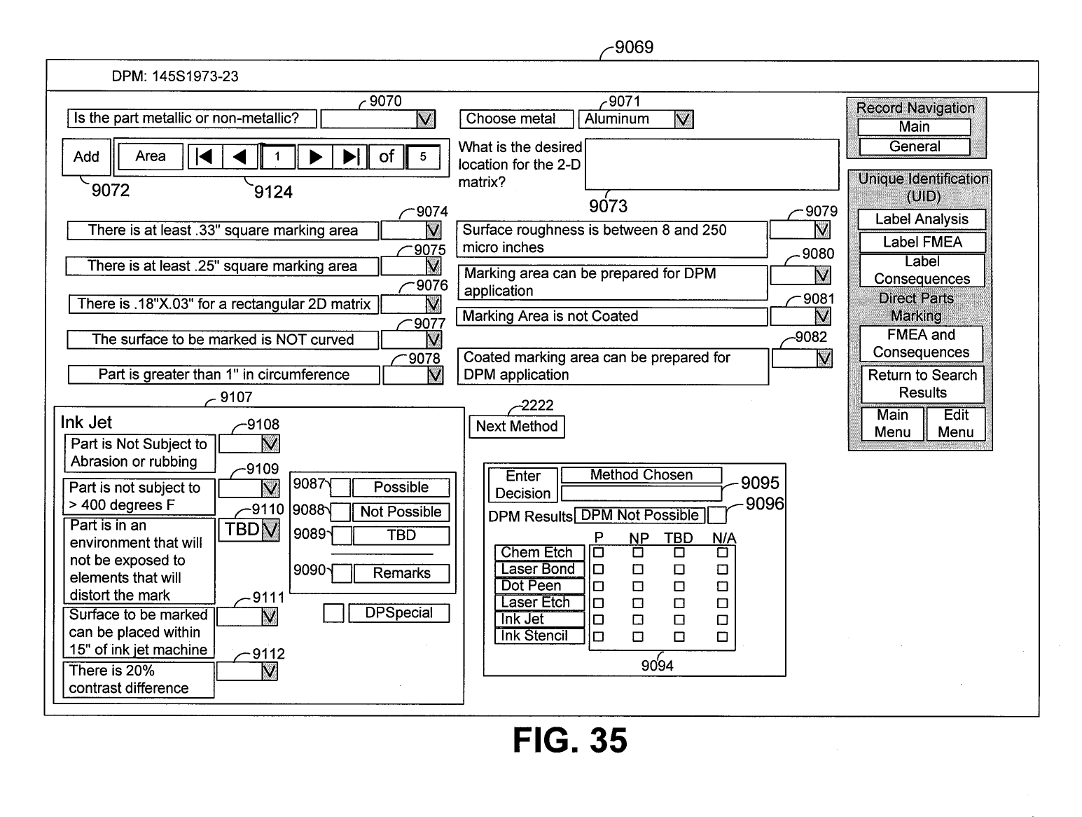

Once the aforedescribed laser etching analysis is complete, the user may select the “Next Method” button 2222, and the next method available is displayed as shown in FIG. 35. For example, the PML 214 displays an “INK JET” analysis box 9107, which behaves substantially similar to the CHEM ETCH analysis box 9083 except that because the criteria are different for ink jet technique, the questions are different.

The PML 214 displays questions and corresponding selection pull-down boxes 9108-9112 that, when answered and selected, enables the PML 214 to determine whether the area described may be marked using an ink jet method as described hereinabove.

If the part is not subject to abrasion, rubbing, or sliding, then the user selects an affirmative indicator in box 9108. Note that if the part is subject to abrasion, rubbing, or sliding, then the user selects a negative indicator, and the PML 214 deactivates the remainder of the ink jet queries associated with boxes 9109-9112. Furthermore, if the part is not subject to temperatures of greater than 400° Fahrenheit, the user selects an affirmative indicator in the box 9109. If the part is in an environment that will not be exposed to elements that will distort the mark, the user selects an affirmative indicator in the box 9110.

Note that box 9110 indicates a to be determined (TBD) indicator that may be selected with respect to a particular query. As described hereinabove, if one of the queries is to be determined and thus each of the queries are not affirmatively answered, then the possibility of using the technique, e.g., ink jet, may not yet be determinable. Thus, the PML 214 may indicate a TBD status in selection box 9089, as described hereinabove. If the surface to be marked can be placed within 15″ of the ink jet machine, the user selects an affirmative indicator in box 9111, and if there is 20% contrast, the user selects an affirmative indicator in box 9112.

The ink jet analysis box 9107 works similarly to the CHEM ETCH analysis box 9083. In this regard, if the questions are answered negatively, then the area cannot be marked using ink jet method, and the PML 214 displays an indicator in an indicator box 9088 that indicates that ink jet is not possible. If all the queries are affirmative, then the PML 214 indicates in an indicator box 9087 that ink jet is possible. If there is not enough information, then the PML 214 places an indicator in box 9089 indicating that ink jet technique usage is to be determined.

Furthermore, as described with reference to FIG. 32, if ink jet is possible, not possible, to be determined, or not applicable, the PML 214 displays an indicator in one of the boxes in box 9094 associated with the ink jet method based upon the indicators provided in boxes 9108-9112.

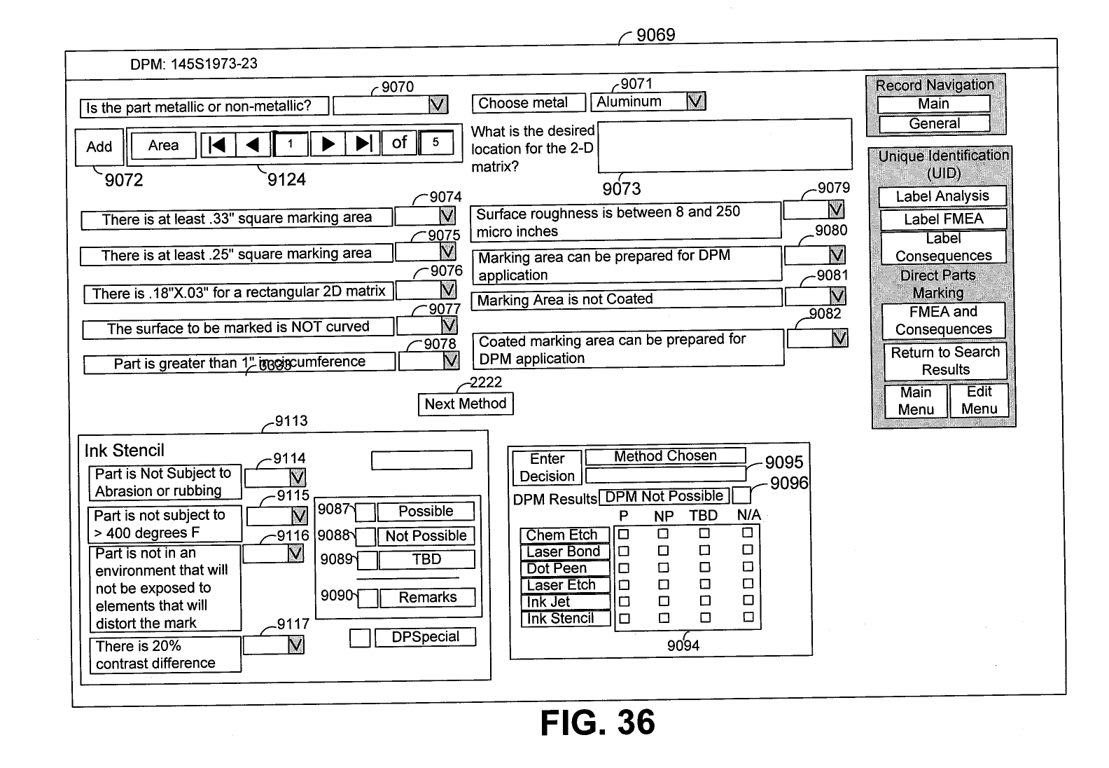

Once the aforedescribed ink jet analysis is complete, the user may then select the “Next Method” button 2222, and the next method available is displayed as shown in FIG. 36. For example, the PML 214 displays an “INK STENCIL” analysis box 9113, which behaves substantially similar to the CHEM ETCH analysis box 9083 except that because the criteria are different for ink stencil technique, the questions are different.

The PML 214 displays questions and corresponding selection pull-down boxes 9114-9117 that, when answered and selected, enables the PML 214 to determine whether the Area described may be marked using an ink stencil method as described hereinabove.

If the part is not subject to abrasion, rubbing, or sliding, then the user selects an affirmative indicator in box 9114. Note that if the part is subject to abrasion, rubbing, or sliding, then the user selects a negative indicator, and the PML 214 deactivates the remainder of the ink stencil queries associated with boxes 9115-9117. Furthermore, if the part is not subject to temperatures of greater than 400° Fahrenheit, the user selects an affirmative indicator in the box 9115. If the part is in an environment that will not be exposed to elements that will distort the mark, the user selects an affirmative indicator in the box 9116.

As described hereinabove, if one of the queries is to be determined and thus each of the queries are not affirmatively answered, then the possibility of using the technique, e.g., ink stencil, may not yet be determinable. Furthermore, if any one of the boxes 9114-9116 is answered negatively, then the PML 214 deactivates the remainder of the boxes 9115-9117. For example, if part is subject to greater than 400 degrees Fahrenheit, the user selects an affirmative indicator in box 9915. Therefore, the PML 214 deactivates boxes 9116 and 9117, and places and indication in the “Not Possible” indicator box 9088.

The ink stencil analysis box 9113 works similarly to the CHEM ETCH analysis box 9083. In this regard, if the questions are answered negatively, the area cannot be marked using an ink stencil method, and the PML 214 displays an indicator in an indicator box 9088 that indicates that ink stencil is not possible. If all the queries are affirmative, then the PML 214 indicates in an indicator box 9087 that ink stencil is possible. If there is not enough information, then the PML 214 places an indicator in box 9089 indicating that an ink stencil technique usage is to be determined.

Furthermore, as described with reference to FIG. 32, if ink stencil is possible, not possible, to be determined, or not applicable, the PML 214 displays an indicator in one of the boxes in box 9094 associated with the ink stencil method based upon the indicators provided in boxes 9114-9117.

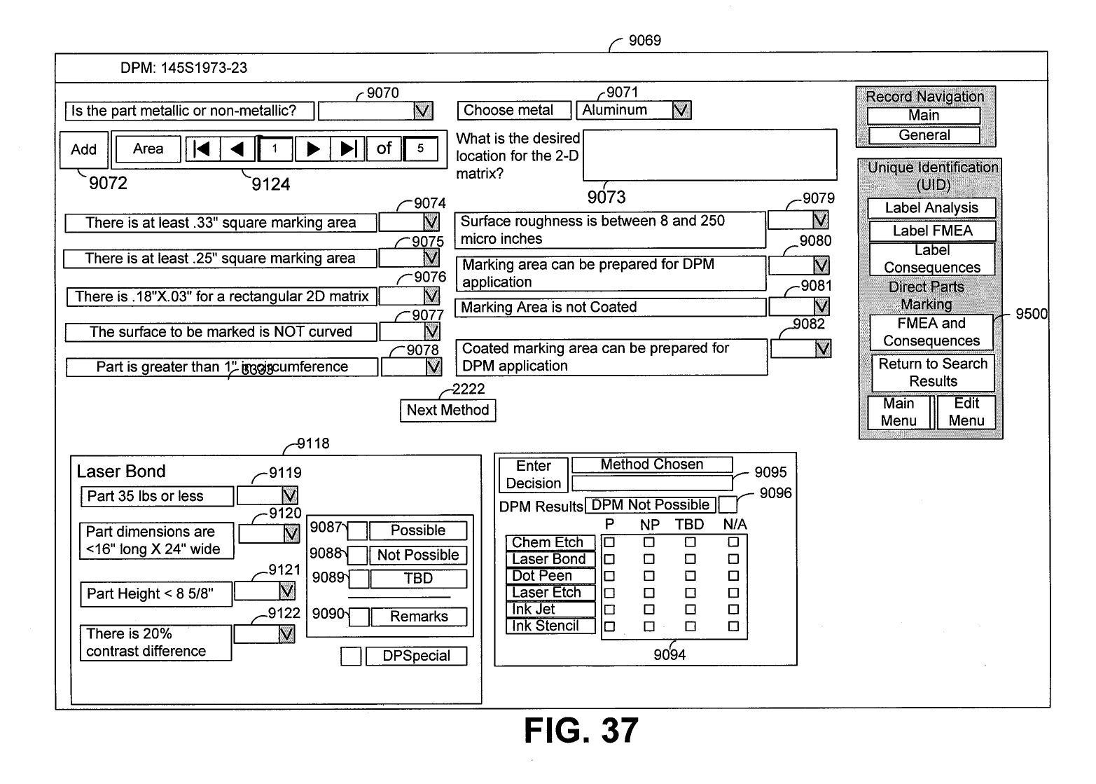

Once the aforedescribed ink stencil analysis is complete, the user may then select the “Next Method” button 2222, and the next method available is displayed as shown in FIG. 37. For example, the PML 214 displays a “LASER BOND” analysis box 9118, which behaves substantially similar to the CHEM ETCH analysis box 9083 except that because the criteria are different for applying the laser bond technique, the questions are different.

The PML 214 displays questions and corresponding selection pull-down boxes 9119-9122 that, when answered and selected, enables the PML 214 to determine whether the area described may be marked using a laser bond method as described hereinabove.

If the part is less than 35 pounds, then the user selects an affirmative indicator in box 9119. Furthermore, if the part dimensions are less than 16″ long by 24″ wide, the user selects an affirmative indicator in the box 9119. Note that throughout the analysis, if one of the indicators is negatively answered, then the PML 214 deactivates the remainder of the boxes 9120-9122, because one negative answer indicates that the technique being analyzed is not possible. Thus, in the instant example, even though the initial question, e.g., part is 35 pounds or less, was answered affirmatively, the second question, e.g., part dimensions were not less than 16″ long and 24″wide, the technique is still not available. Therefore, the PML 214 deactivates box 9119, even though it was answered affirmatively, and the remainder of the boxes 9121 and 9122. Further, if the part height is less than 8⅝″, the user selects an affirmative indicator in box 9121, and if there is 20% contrast, the user selects an affirmative indicator in box 9122. The ink laser bond analysis box 9118 works similarly to the CHEM ETCH analysis box 9083. In this regard, if the questions are answered negatively, the area cannot be marked using laser bond method, and the PML 214 displays an indicator in an indicator box 9088 that indicates that laser bond is not possible. If all the queries are affirmative, then the PML 214 select the indicator box 9087 indicating that laser bond is possible. If there is not enough information, the PML 214 places an indicator in box 9089 indicating that laser bond technique usage is to be determined.

Furthermore, as described with reference to FIG. 32, if laser bond is possible, not possible, to be determined, or not applicable, the PML 214 displays an indicator in one of the boxes in box 9094 associated with the laser bond method based upon the indicators provided in boxes 9119-9122.

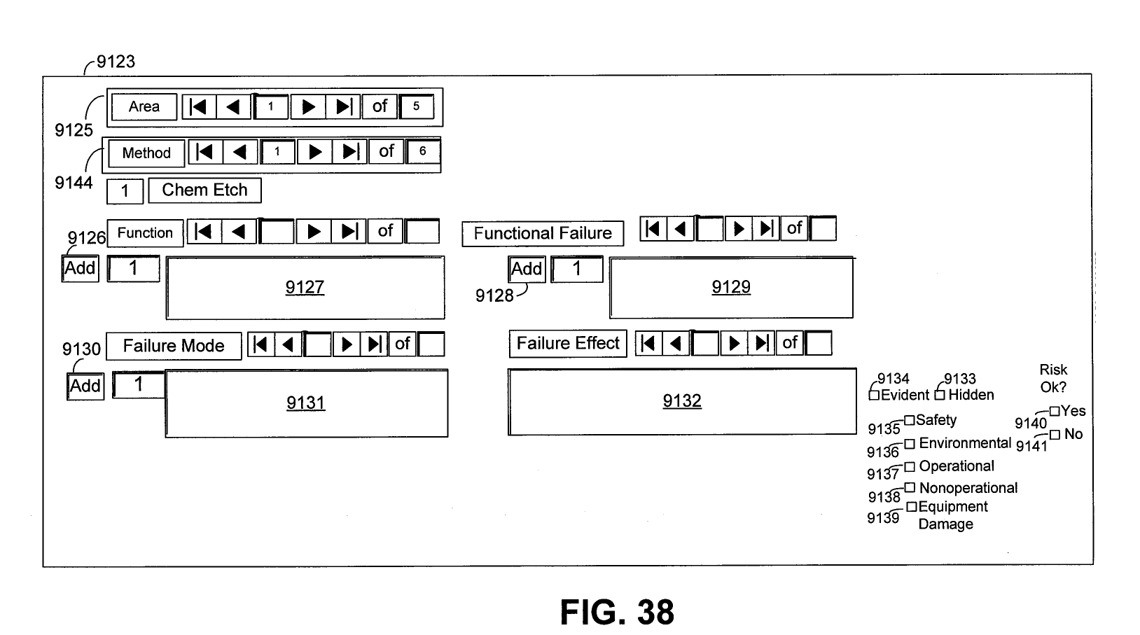

FIG. 38 depicts a DPM FMEA analysis. Each of the DPM methods described with reference to FIGS. 32-37 may be subjected to a DPM FMEA analysis, as described with reference to GUI 9123 in FIG. 38. Accordingly, if during the analysis described with reference to FIGS. 32-37 one or more of the methods is found to be possible and so indicated for the method in box 9087, then the user may perform a DPM FMEA for the method in GUI 9123.

As described hereinabove, a FMEA analysis includes identifying functions, functional failures, failure modes, failure effects, and consequences. Notably, however, a DPM FMEA includes identifying such functions, failures, modes, effects, and consequences associated with particular DPM techniques. Thus, from each of the GUIs described in FIGS. 32-37, respectively, a user may select a FMEA and Consequences pushbutton 9500 (FIG. 37), and the PML 214 displays the GUI 9123.

The PML 214 displays GUI 9123, which enables a user to perform a DPM FMEA for each area and its associated possible methods, as indicated for each method in “Possible” box 9087. In this regard, an “Area” scroll box 9125 enables a user to traverse the plurality of areas identified in the marking analysis. Further, the “Method” scroll box 9144 may be used to traverse each possible method identified in the marking analysis.

The user enters functions by selecting the “Add” button 9126 and entering data in text box 9127 describing the function. For example, the function may be to safely and permanently display human and machine-readable part information so that it can be identified and traced.

The user may then add a functional failure by selecting the “Add” button 9128 and entering data describing the failure in text box 9129. For example, if the function is indicated as described in the instant example, the failure may be that the chemical etching may introduce damage into the system causing the part to fail.

The user may then add an associated failure mode by selecting the “Add” button 9130 and entering data describing the failure mode in text box 9131. For example, the one who is marking the part in the field may forget to apply a neutralizing solution after the part is chemically etched and the chemicals continue to eat away at the part material.

The user may then enter data describing a failure effect associated with such failure mode by entering text in text box 9132. In the instant example, the loss of material weakens the part and allows the part to break in flight causing loss of aircraft and crew.

The GUI 9123 further comprises selection boxes for identifying the type of consequences that may result from a particular failure mode. For example, selection boxes 9133-9138 may be selected to identify evident failures 9134, hidden failures 9133, safety consequences 9135, environmental consequences 9136, operational consequences 9137, non-operational consequences 9138, and/or equipment damage 9139.

In addition, the GUI 9123 comprises selection boxes 9140 and 9141 associated with whether the risk assessed with relation to each failure mode displayed in text box 9131 is acceptable to the user. With respect to the consequences identified in boxes 9134-9139, the user decides whether or not the level of risk associated with the identified consequences is acceptable by indicating in boxes 9140 and 9141. Thus, during analysis of all failure modes associated with the object identifier, if the risk associated with the consequences of any failure mode is not acceptable, the object identifier is not technically appropriate and an alternate object identifier is sought.

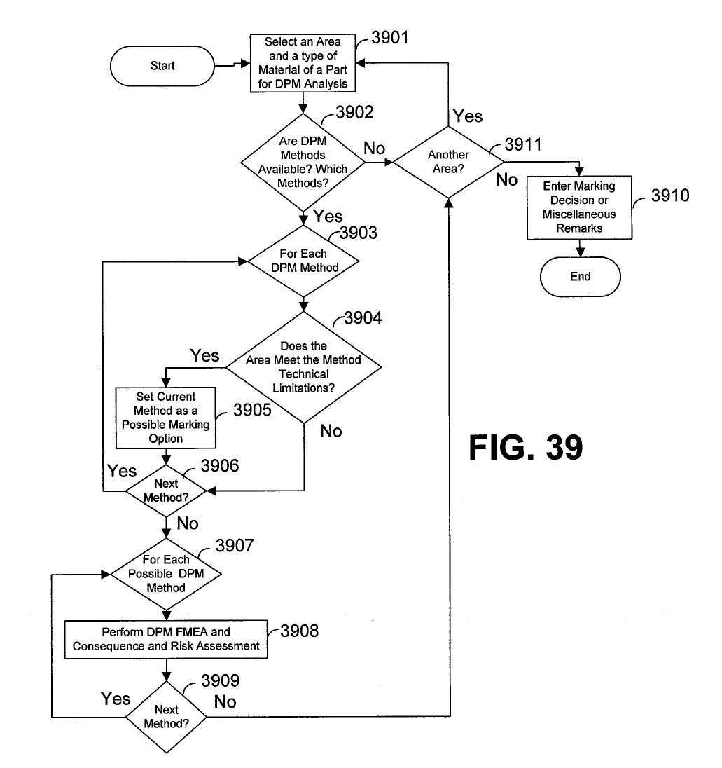

FIG. 39 is a flowchart depicting architecture and functionality of the DPM analysis and FMEA functionality of the PML 214 of the present disclosure. The user selects the type of material and enters an area for DPM analysis in step 3901. As described hereinabove with reference to FIG. 31, the user may add an area for analysis by selecting the “Add” pushbutton 9072 (FIG. 31) for the part identified, e.g., 145S1973-23.

The next step is determining if DPM is possible and what DPM marking options are available, in step 3902. In this regard, based upon the user's responses to the queries listed via the pull-down boxes 9074-9082 in FIG. 31, e.g., is the area at least 0.33″, is the area at least 0.25″, whether the surface is curved, etc., DPM techniques may not be possible. For example, if the surface of the area to be marked is too rough and the area can not be prepared for marking, then it is technically impossible to apply a DPM solution for marking that area. Thus, no DPM method will be available for analysis. In addition, based upon the user's responses to the queries listed via the pull-down boxes 9074-9082 one or more of the DPM techniques may be available for the area, i.e., chemical etching, etc.

If DPM is not possible based upon step 3902, the user may select another area on the part for analysis, as indicated in step 3911. If the user selects another area for analysis, the process begins again in step 3901. If no other area is available for analysis, a decision is entered or remarks are entered in step 3910. Thereafter, the process ends.

For each DPM marking method available, as indicated in step 3903, the PML 214 receives data on whether the area under analysis for the part meets the technical limitations 1161-1164 (FIG. 3) for each DPM marking method available, as indicated in step 3904. In this regard, the PML 214 displays the first available marking option, and when the user selects the “Next Method” pushbutton 2222, the PML 214 displays the next available marking option. In this regard, the PML 214 receives data, for example, in the CHEM ETCH analysis box 9083, the DOT PEEN analysis box 3333, the LASER ETCH analysis box 9102, the ink jet box 9107, the INK STENCIL analysis box 9113, and the LASER BOND analysis box 9118, in response to specific queries related to the displayed marking method.

If the marking method is available in step 3904, the PML 214 sets the marking method under analysis as an possible marking option, as indicated in step 3905. In this regard, if the marking method under analysis for the area is possible, not possible, to be determined, or not applicable, e.g., DPM is not available for the marking method, the PML 214 places an indicator in the appropriate boxes in box 9094 (FIG. 32).

If the user selects the “Next Method” pushbutton 2222 and there is another marking method available for the area under analysis in step 3906, the PML 214 displays the next analysis box 9083, 3333, 9102, 9107, 9113, or 9118 in step 3903, and the process begins again in step 3904. As indicated, the marking method analysis is performed for each available marking method as determined in step 3903.

Furthermore, for each possible DPM method, as indicated in step 3907, a DPM FMEA is performed, as indicated in step 3908. In this regard, in step 3909, the PML 214 scrollably displays to the user for analysis a FMEA GUI 9123 (FIG. 38), as indicated in step 3909.

Once each possible DPM method is analyzed, the user may select another area on the part to analyze in step 3911. If there is no additional area for analysis, the user enters a marking decision or enters miscellaneous remarks in step 3910, and the process ends. An example of miscellaneous remarks is that the component cannot be marked with a DPM technique because the material is too hard.

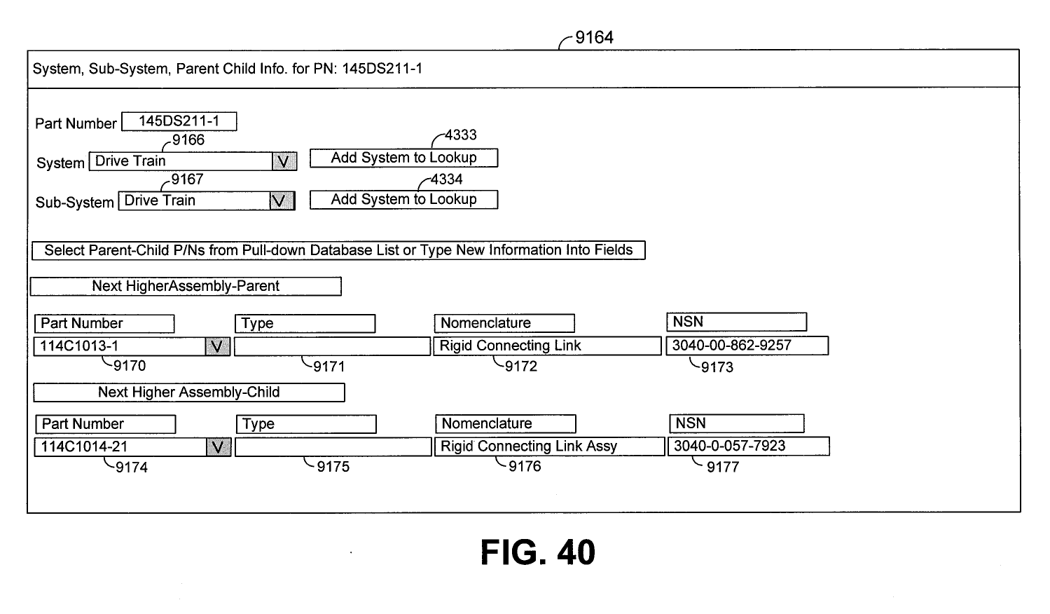

FIG. 40 depicts an exemplary “System, Sub-system, Parent-child info” GUI 9164. With reference to FIG. 27, the GUI 9039 comprises a button 9165 that when selected displays GUI 9164. Generally, the GUI 9164 displays information for the part number currently displayed in FIG. 27. In this regard, for example, part number 145DS211-1 is displayed.

GUI 9164 provides information related to the various systems to which the part belongs and any other parts associated with the part number displayed in the system in which the part is used. Thus, a pull-down box 9166 enables a user to select a system of which the displayed part number is a part. Furthermore, a pull-down 9167 enables a user to select from a list of subsystems related to the part number displayed. Further, the “Add Systems to Lookup” button 4333 enables a user to associate the displayed part with another system. Additionally, the “Add subsystems to Lookup” button 4334 enables a user to associate the displayed part number with another subsystem.

Additionally, GUI 9164 comprises pull-down 9170 for associating the part number with a parent assembly, i.e., the part associated with the displayed part number can be found in the parent assembly. In the example, the assembly having the part number 114C1013-1 includes a part number 145DS211-2. The GUI 9164 further comprises a text field 9171 for displaying the type of the Parent part, a text field 9172 for displaying the nomenclature of the parent, and a text field 9173 for displaying the NSN of the parent.

The GUI 9164 further comprises a child description for the part number that is displayed, i.e., the part number displayed is made up of at least the one child part number displayed in a text field 9174. In the example, the part number 145DS211-2 is made up of at least a part having the number 114C1014-21. The GUI 9164 further comprises a text field 9175 for displaying the type of the child part, a text field 9176 for displaying the nomenclature of the child, and a text field 9177 for displaying the NSN of the parent.

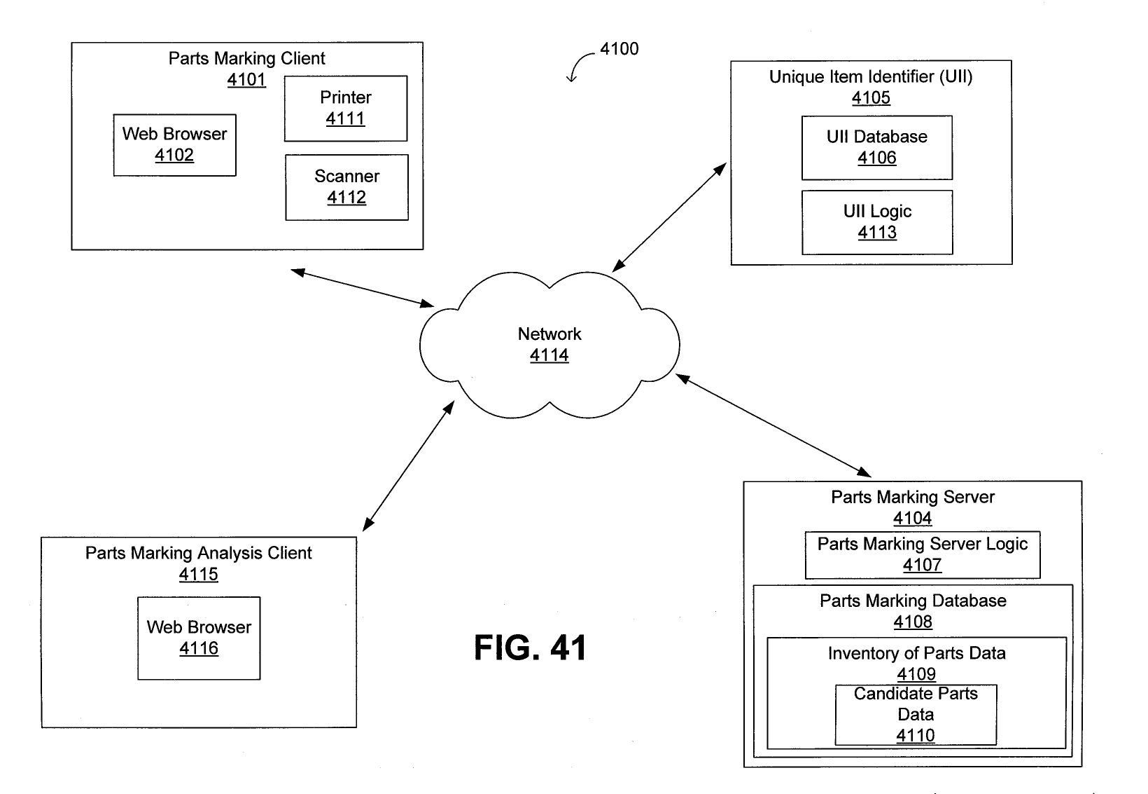

FIG. 41 depicts a parts marking server system 4100 in accordance with another embodiment of the present disclosure.

The parts marking server system 4100 comprises one or more parts marking clients 4101 connected via a web browser 4102 to a network 4114. In addition, the parts marking server system 4100 comprises one or more parts marking analysis clients 4115 connected via a web browser 4116 to a network 4114. Each parts marking client 4101 further comprises a printer 4111, e.g., a label printer, and a scanner 4112, e.g., a unique identifier scanner. Note that the printer 4111 and the scanner 4112 comprise hardware and any applicable software drivers for performing their respective function, e.g., printing labels and/or field procedures from printer hardware or scanning 2-D matrices via the scanner hardware.

Note that the present disclosure describes, with reference to FIGS. 4-40, a PMS 100 (FIG. 1) that employs a local graphical user interface software, e.g., Visual Basic™, that may be configured, for example, to run locally on a personal computer (not shown) using a local database, e.g., Microsoft Access™. In addition, however, the present disclosure further describes hereinafter, in FIGS. 41-55, the parts marking server system 4100 (FIG. 41) that employs HTML pages and that may be configured, for example, as a web-based server application that communicates with the parts marking client 4101 and the parts marking analysis client 4115 via the network 4114 (FIG. 41).

In addition, the system 4100 comprises a part marking server 4104 and a unique identifier registry server 4105. The server 4104 and the registry server 4105 are preferably computing devices, e.g., personal computers.

The part marking server 4101 comprises a parts marking database 4108 that includes an inventory of parts 4109 and candidate parts 4110, which are described further herein. In this regard, the inventory of parts 4109 comprises a complete set of parts that may be in the inventory of an entity's, e.g., the Navy. Of those inventory of parts 4109, the entity may have regulations that govern which parts of the inventory of parts 4109 are to be marked either via a label or direct parts marking, for example. In accordance with those regulations, the subset of the inventory of parts 4109 that the entity prescribes to be marked is the candidate parts 4110, which are described further herein. The parts marking server 4104 further comprises parts marking server logic (“PMSL”) 4107.

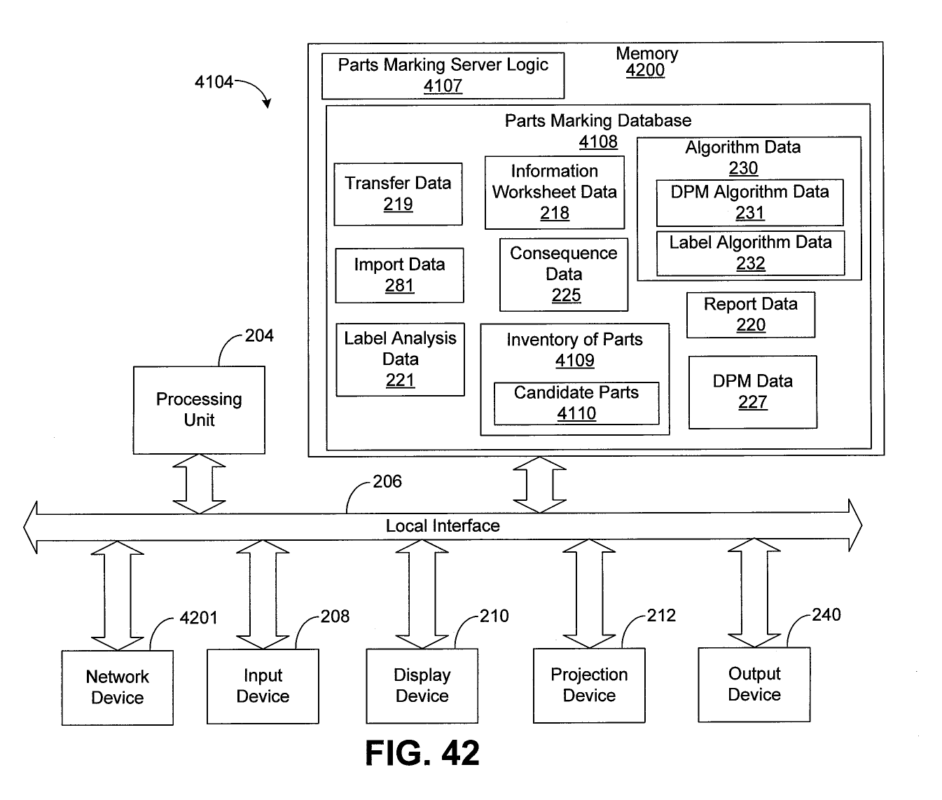

The PMSL 4107 may receive data from a via a plurality of graphical user interfaces (GUIs), described further herein, for determining the candidate parts 4110 within the inventory of parts 4109. Notably, the parts marking server 4104 is described further with reference to FIG. 42.

During operation, a user may employ the parts marking analysis client 4115 to perform part marking analysis tasks, e.g., perform a label analysis and FMEA, perform a DPM analysis and FMEA, and/or determine the candidate parts 4110 on which to perform a marking analysis.

Furthermore, a user may use the parts marking client 4101 to obtain and generate labels for parts in the field and/or otherwise mark parts. For example, a user may employ the parts marking client 4101 to receive a field procedure via the web browser 4102 from the PMSL 4107. As described hereinabove, the field procedure is preferably a document, e.g., a hyper-text markup language (“HTML”) document that describes how to mark a particular part (not shown). The PMSL 4107 may deliver the HTML field procedure to the user. In another embodiment, which will be described further herein, the HTML document may be stored locally on the parts marking client 4101. Additionally, as described herein with reference to the PMS 100 (FIG. 1), the field procedure may be stored locally as a text file (“TXT”) or a portable document format (“PDF”) file.

When the user is ready to print a label in accordance with the HTML field procedures, the user enters or selects a serial number of the part for which the user is printing the label. The web browser 4102 receives an input from the user indicating that he is ready to print the label, e.g., the user selects a button, described further herein, and the web browser 4102 transmits the serial number to the PMSL 4107.

The PMSL 4107 uses the serial number and other information identifying the part for which the label is being made to generate a unique item identifier (“UII”) associated with the part. The PMSL 4107 transmits the UII, via the Network 4114, to the unique identifier registry server 4105. Upon receipt, the UII logic 4113 determines whether the UII received is in the unique identifier database 4106. If it is not in the unique identifier database 4106, the UII logic 4113 may store the UII received in the database 4106 and transmit a message to the PMSL 4107 that the UII received can be used by the parts marking client 4101. If it is already in the database 4106, then the UII logic 4113 transmits a message to the PMSL 4107 that the UII cannot be used.

If the UII logic 4113 determines that the UII can be used, the PMSL 4107 transmits a message to the web browser 4102 indicating that the UII is available and ready to be printed by the printer 4111. The user may then print a label exhibiting the UII described hereinabove from the parts marking client 4101 via the printer 4111. Note that the UII may be encoded in a marking referred to as a 2-D matrix, as described hereinabove.

If the UII cannot be used, the PMSL 4107 transmits a message to the web browser 4102 that the label cannot be printed with the generated UII using the serial number provided by the user.

Once the label is printed, the user may scan the marking, e.g., a 2-D matrix, via the scanner 4112. The scanner 4112 determines whether the marking on the label accurately reflects the UII generated by the PMSL 4107. As an example, the scanner 4112 may be manufactured by Microscan™, Symbol™, and/or Siemens™.

The scanner 4112 stores verification data (not shown) on the client 4101. The user may view the verification data to determine if the marking passes a quality standard, i.e., whether the marking is sufficient that when scanned will identify the part.

FIG. 42 depicts an exemplary embodiment of the parts marking server 4104. The server 4104 as depicted in FIG. 42 is similar to the PMS 100 depicted in FIG. 4. However, the server 4104 comprises memory 4200 that stores the PMSL 4107 and the parts marking database 4108. In addition to storing the inventory of parts data 4109 and the candidate parts data 4110, the parts marking database 4108 stores the additional data described with reference to FIG. 4, including the transfer data 219, the import data 281, the label analysis data 221, the information worksheet data 218, the consequence data 225, the algorithm data 230, the report data 220 and the DPM data 227.

In addition, the parts marking server 4104 comprises a network device 4201. The network device 4201 is preferably a component for connecting the parts marking server 4104 to the network 4114 and transmitting data through the Network 4114 to the parts marking client 4101 and the parts marking analysis client 4115.

Furthermore, the PMSL 4107 operates similar to the PML 214 (FIG. 4). However, the GUIs generated and provided to the users of the parts marking client 4101 (FIG. 41) and/or the parts marking analysis client 4115 (FIG. 41) are in the form of web pages that are displayed to the user via the web browser 4102 (FIG. 41) and/or 4116 (FIG. 41), respectively. Whereas, the GUIs provided by the PML 214 are window-based forms.

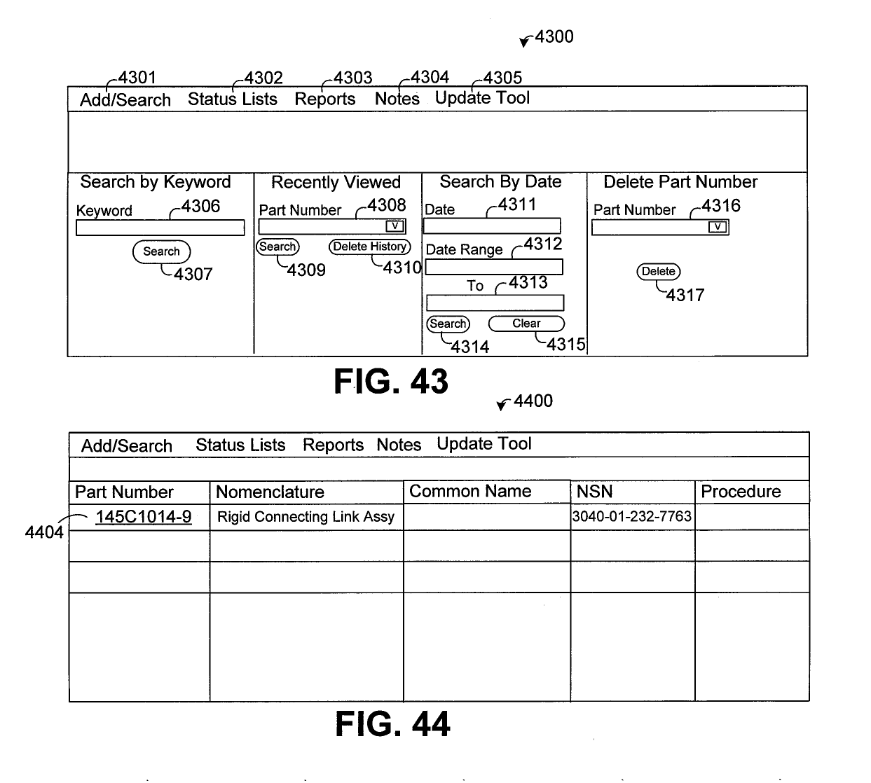

During operation, a user (not shown) of the parts marking client 4101 or the parts marking analysis client 4115 may desire to obtain part information for the purpose of marking a part or performing an analysis. Via the web browser 4102 or 4116, respectively, the user may enter data into an exemplary search GUI 4300 as shown in FIG. 43.

The GUI 4300 comprises a plurality of navigation links, including “Add/Search” 4301, “Status Lists” 4302, “Reports” 4303, “Notes” 4304, and “Update Tool” 4305. These navigation links 4301-4305 provide the user the ability to navigate the plurality of HTML pages making up the PMSL 4107.

In addition, the GUI 4300 comprises a “Keyword” search field 4306, a “Part Number” search field 4308, “Date” search fields 4311-4313, and various activation buttons including “Search” buttons 4307, 4309, and 4314. A user can enter data related to a part, for example a portion of the part number, in field 4306 and select a corresponding search button 4307. The PMSL 4107, in response, will retrieve from the parts marking database 4108 data indicative of the part number searched and display the data in GUI 4400 depicted in FIG. 44, which will be described further herein.

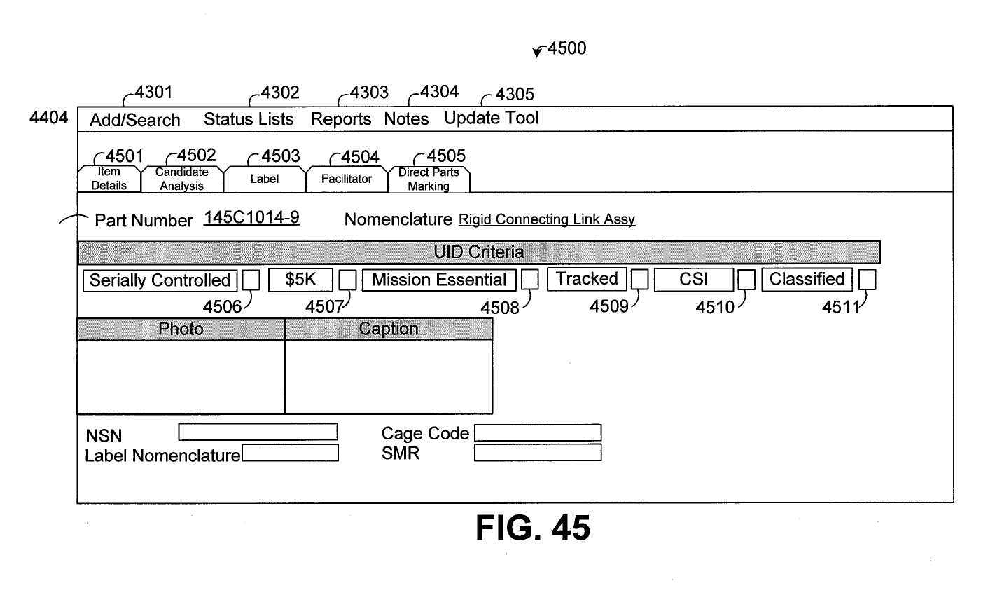

Alternatively, a user can select data in field 4308 and select a corresponding search button 4309. The PMSL 4107, in response, will retrieve from the parts marking database 4108 data related to the part number selected and display the data in GUI 4500 depicted in FIG. 45, which will be described further herein Furthermore, the GUI 4300 comprises a delete field 4316 in which the user can enter a part number, select a “Delete” button 4318, and the PMSL 4107 will delete the part number. The “Delete History” button 4310 may be selected in order to clear the historical list of recently viewed parts in search field 4308.

In addition, the user can enter a date range or a date in fields 4311-4313 and select the button 4314. In response, the PMSL 4107 displays GUI 4400 listing those parts that were entered or analyzed on the entered date or during the date range.

With respect to FIG. 44, the PMSL 4107 displays a listing of part numbers corresponding to the search initiated by the user as described with reference to FIG. 43. Thus, as an example, if the user enters the string “145C101,” the PMSL 4107 displays the GUI 4400 comprising a “145C1014-9” link 4404, which includes the string searched on, i.e., “145C101.” In addition, the GUI 4400 may display other data related to the part number, for example the nomenclature, the common name, the NSN, and/or an associated field procedure identification. Note that the PMSL 4107 may list a plurality of part number links that comprise the searched string, however, only one such link is shown in FIG. 44 for simplicity and brevity.

If the user selects the link 4404, the PMSL 4107 displays the GUI 4500 depicted in FIG. 45. In addition to the navigation buttons 4301-4305, the GUI 4500 comprises part navigation buttons 4501-4505. Note that the “Item Details” button 4501, when selected, navigates the user to the GUI 4500 displayed in FIG. 45.

The data displayed in GUI 4500 includes, for example, the part number, data indicative of the UID criteria and corresponding read-only identifier boxes 4506-4511 associated with the part and other part-identifying information. Note that the UID criteria may include boxes 4506-4511 for identifying when the part is serially controlled, over $5,000, mission essential, tracked, critical safety item (“CSI”), or classified. In addition, for example, the GUI 4500 may display the part's NSN number, the cage code, the label nomenclature, or the SMR code. The data shown in GUI 4500 is exemplary, and any other data related to the part may be shown on GUI 4500 in other embodiments.

As an example, the inventory of parts data 4109 (FIG. 42) may comprise a record (not shown) for the part number searched, e.g., 145C1014-9. When the PMSL 4107 retrieves the data associated with the part number searched, the PMSL 4107 displays to each corresponding text field available on the GUI 4500 data related to the part that is stored in the inventory of parts data 4109.

Note that an entity, e.g., the Navy, may maintain a database of all parts in its inventory. Furthermore, the entity may not desire to mark all its parts in inventory with 2-D matrices. In this regard, the entity may desire to identify those parts in its inventory of parts data 4109 that are to be marked with a 2-D matrix.

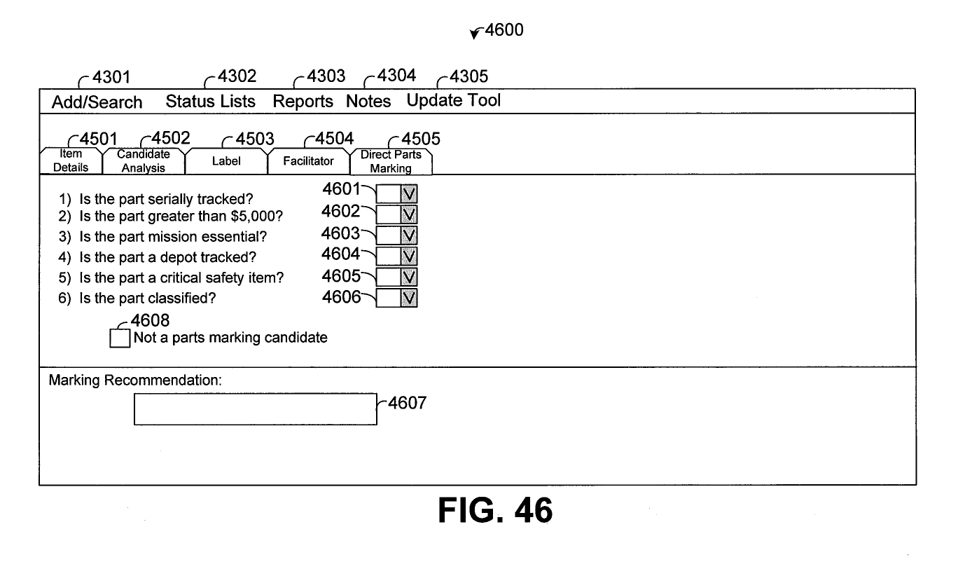

Upon retrieving data associated with a part, e.g., 145C1014-9, the user may select the “Candidate Analysis” navigation button 4502. In response, the PMSL 4107 displays a GUI 4600 depicted in FIG. 46. GUI 4600 comprises a plurality of queries 1)-6) associated with pull-down text fields 4601-4606.

Note that the plurality of queries 1)-6) is entity-specific. The queries 1)-6) provided are for exemplary purposes. The queries 1)-6) represent criteria that the entity uses to determine whether a part is to be marked with a 2-D matrix. Thus, in the example provided, if the part is serially tracked, the user selects an affirmative response in text field 4601. If the cost of the part exceeds $5,000, the user selects an affirmative response in text field 4602. If the part is mission critical, the user selects an affirmative response in text field 4603. If the part is depot tracked, the user selects an affirmative response in text field 4604. If the part is a CSI, the user selects an affirmative response in text field 4605, and if the part is classified, the user selects an affirmative response in text field 4606.

If at any time the user selects a particular response to one of the queries 1)-6) that indicates it is to be marked with a 2-D matrix, in text field 4602, the PMSL 4107 displays an identifier, e.g., “MARK PART.” In one embodiment, the identifier could also provide a justification for why the part is to be marked, e.g., the part is serially controlled. If the query responses indicate that the part is not to be marked in accordance with the entity's regulations or if the user selects a box 4608, then the PMSL 4107 displays, in text field 4607, an identifier, e.g., “DO NOT MARK PART.” Note that a text field (not shown) may be provided to enter data indicative of the reasons why the part it not to be marked.

Once the user completes the responses to the queries and the GUI 4500 (FIG. 45) is displayed, the PMSL 4107 indicates in boxes 4506-4511 (FIG. 45) the affirmative responses to the queries. Further, when it is determined that the part is to be marked in accordance with the entity's regulations, the PMSL 4107 stores the part number and its associated data, as described herein, as candidate parts data 4110 (FIG. 42).

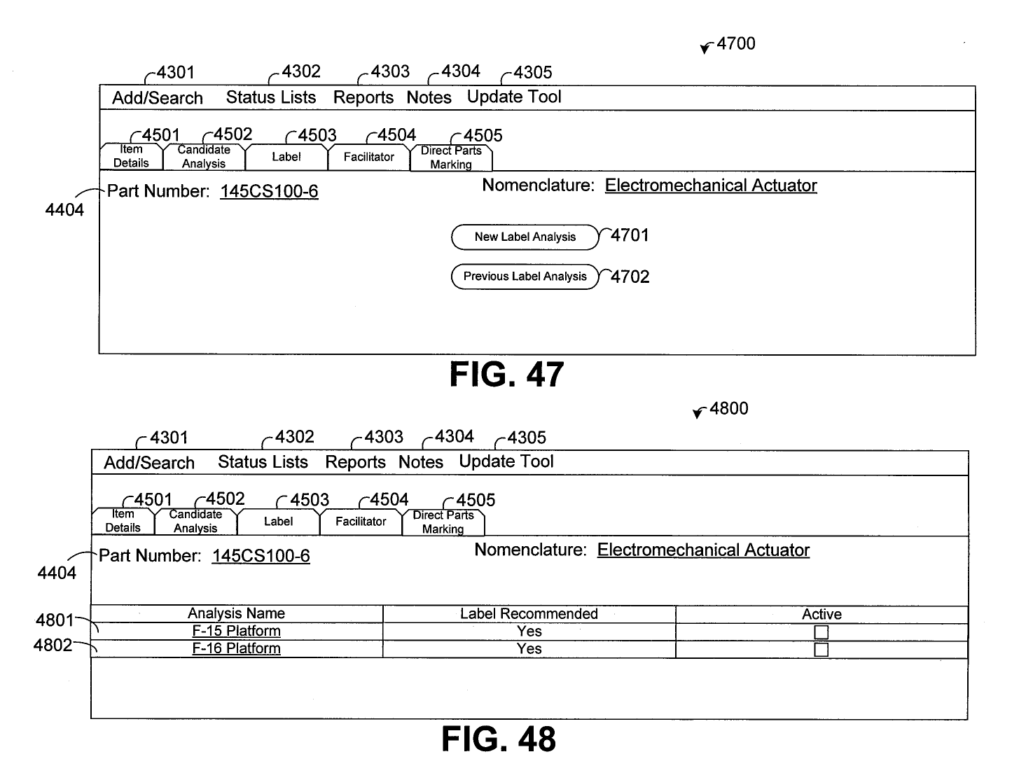

If the part is to be marked, the user may use the PMSL 4107 to determine the parts marking application. For example, the PMSL 4107 may be used to determine whether the part is to be marked with a label or DPM, Further, the PMSL 4107 may be used to determine what type of label and/or what type of DPM marking. In this regard, the user may select the “Label” navigation button 4503, and the PMSL 4107 displays a GUI 4700 as depicted in FIG. 47. GUI 4700 comprises two links, including a “New Label Analysis” link 4701 and a “Previous label Analysis” link 4702. The user may retrieve data associated with a previous analysis related to the part number indicated or the user may begin a new analysis related to the part number indicated by selecting the “New label Analysis” link 4701.

In one embodiment, the PMSL 4107 displays the GUI 4800 depicted in FIG. 48 in response to the user selecting the button 4702. GUI 4800 comprises two exemplary links, the F-15 Platform link 4801 and the F-16 Platform link 4802. In this regard, the part indicated may be used on one or more platforms, and the marking analysis is specific to the platform. Thus, the PMSL 4107 enables the user to select which platform that they will be analyzing. Note that the links 4801 and 4802 may identify multiple analyses for the same part number for systems that utilize the part associated with the part number in more than one area.

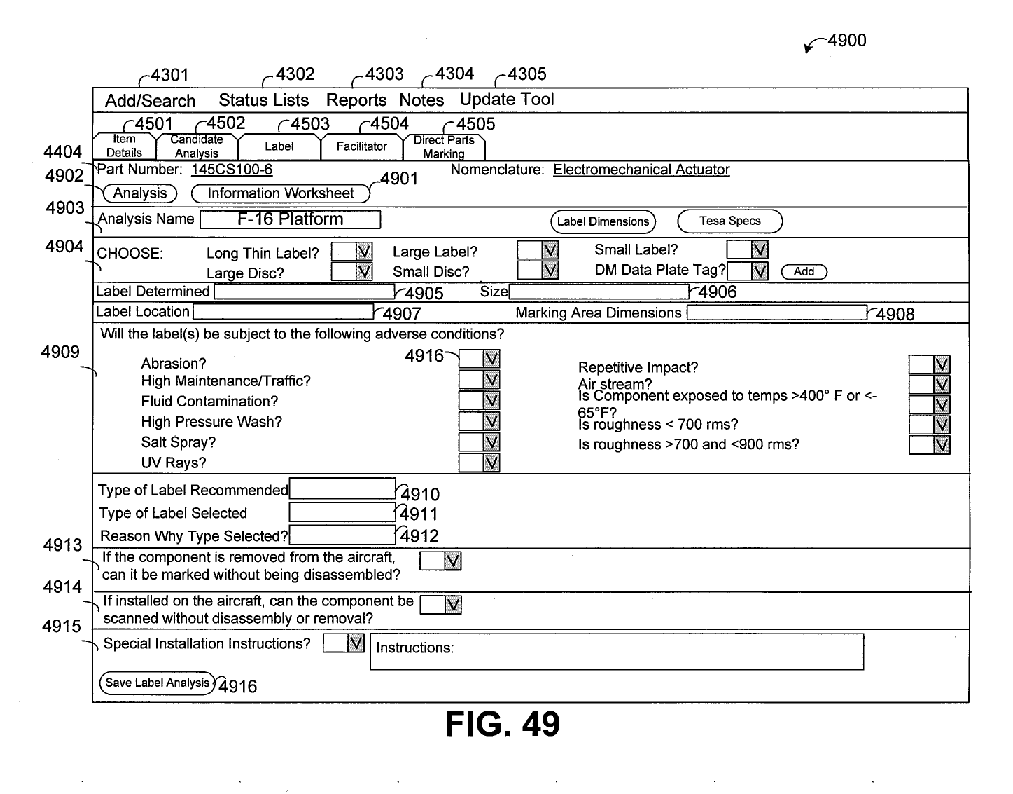

For simplicity and brevity, the present disclosure describes the process of beginning a new analysis by selecting link 4701. If the user selects link 4701 (FIG. 47), the parts marking server logic 4701 displays a GUI 4900 as depicted in FIG. 49. In one embodiment, the parts marking server logic 4710 may provide a separate GUI for providing an analysis name. Note that if the user selects a previous analysis by selecting link 4702 (FIG. 47), the GUI 4900 is pre-populated with data entered in a previous analysis.

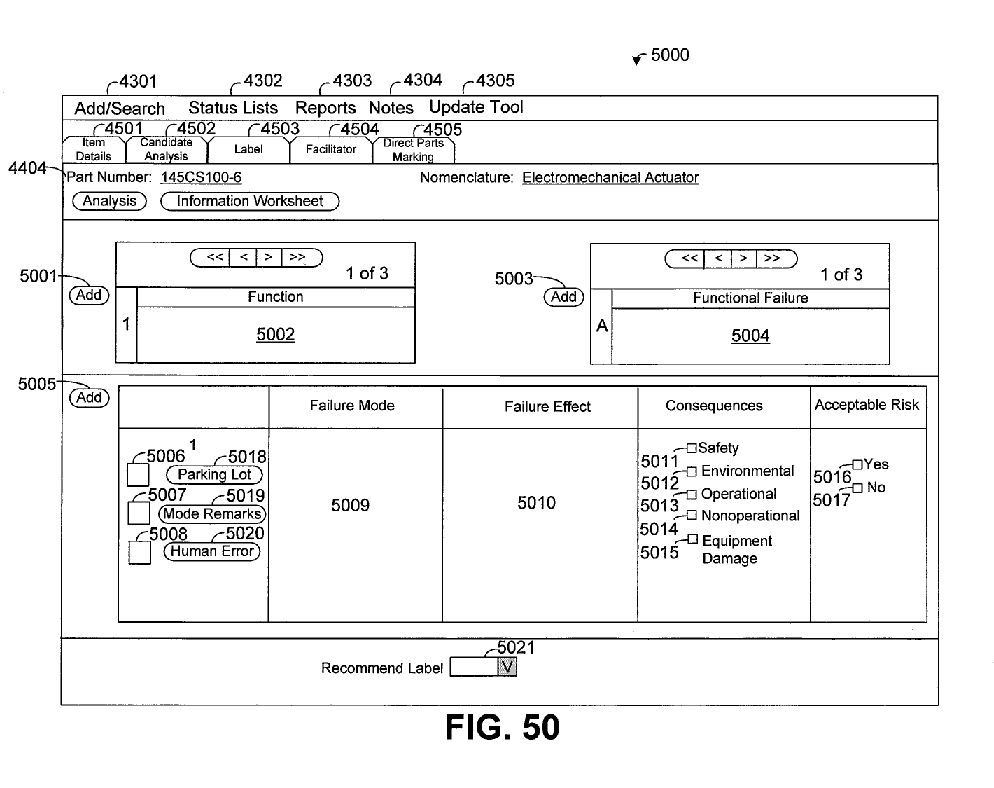

GUI 4900 comprises a plurality of fields for receiving data in order to determine whether a label is appropriate for the part and what type of label is appropriate for the part. Further, the user may navigate between GUI 4900 and a GUI 5000 depicted in FIG. 50 by selecting the “Analysis” button 4902 and the “Information Worksheet” button 4901. The Information Worksheet is described further with reference to FIG. 50.

The analysis name is displayed in box 4903, and the user may select from the pull-down boxes in box 4904 the type of label for use on the part, i.e., long thin label, large disc, large label, small disc, small label, direct marking data plate tag. Note that in the present embodiment, each type of label available for application is identified textually. However, in other embodiments, the types of labels available may be identified alpha-numerically.

Text box 4905 displays data that indicates the type of label selected, e.g., “long thin label.” Text box 4906 displays data that indicates the dimensions of the label selected, e.g., “2″×1″.” Text box 4907 receives data from the user indicative of where on the part indicated the selected label will be located, e.g., “adjacent to or near the existing data plate.” Text box 4908 receives data from the user that indicates the size of the area on which the label will be placed, e.g., “8.5″×11″ near the existing data plate.”

Box 4909 receives data related to whether a label is possible for the part under analysis. In this regard, box 4909 comprises a plurality of queries, and the user enters responses in pull-down boxes associated with each query. As an example, if the part is subject to abrasion, the user enters an affirmative response in the query's associated pull-down box. Further, if the part is subject to high traffic, fluid contamination, high pressure wash, salt spray, UV rays, repetitive impact, high temperatures, or surface roughness, the user may enter affirmative response in any of their corresponding pull-down boxes. Note that during the course of responding to the queries, the PMSL 4107 may determine, based upon one or more affirmative response in box 4909, that a label cannot be used on the part under analysis. Thus, in text field 4910, the PMSL 4107 may display “REQUIRES FURTHER ANALYSIS.”

In addition, the PMSL 4107 may determine that a particular label is best suited for the part. Thus, the PMSL 4107 may display the type of label suited for the part in text field 4910. For example, the PMSL 4107 may display “Plastic,” “Acrylic,” and/or “Metal.”

During the label analysis, the user may select the recommended label or a different label and identify the label selected in text field 4911 and a reason for its selection in text field 4912, if different than what was selected by the PMSL 4107. In addition, the user may indicate in box 4913 whether the part can be marked without disassembly, in box 4914 whether the part can be scanned without disassembly, and in box 4915 if there are special instructions.

Once the analysis is complete, the user can select the “Save Label Analysis” link 4916. In response, the PMSL 4107 saves the data as label analysis data 221 (FIG. 42).

In order to make certain decisions to enter data into the analysis GUI 4900, the user may use the “Information Worksheet” by selecting the “Information Worksheet” button 4901. In response, the PMSL 4107 displays the GUI 5000 as depicted in FIG. 50.

GUI 5000 is similar to the GUI 800 depicted in FIG. 15 and behaves similarly as well. In this regard, the GUI 5000 receives data indicative of functions, functional failures, failure modes, and failure effects. In addition, however, the GUI 5000 receives data indicative of consequences and whether the risk is an acceptable one for each failure mode displayed in text box 5009.

In this regard, GUI 5000 identifies the part under analysis, e.g., 145CS10-6. In addition, the GUI 5000 comprises three “Add” links 5001, 5003, and 5005 that, when selected, allow the user to add text identifying a new function in text box 5002, a new functional failure in text box 5004 and a new failure mode and effect in text boxes 5009 and 5010, respectively. In addition, the user may select the “Parking Lot” link 5018, the “Mode Remarks” link 5019, or the “Human Error” link 5020 and enter data related to the part describing issues that may need to be addressed or other data related to the label analysis. If such data is entered, the PMSL 4107 places an identifier in the respective boxes 5006-5008.

Further, the GUI 5000 comprises “Consequences” boxes 5011-5015. The user may select one or more of the plurality of boxes 5011-5015 to identify the type of consequences resulting from the described failure effect. For example, the failure effect described may result in consequences that affect safety, environmental, operational, non-operational, and/or equipment damage.

If the risk associated with each consequence indicated in boxes 5011-5015 is acceptable, the user may select box 5016. If the risk is not acceptable, the user may select box 5017. Additionally, if the label that was selected in text box 4911 in FIG. 49 exhibits acceptable risk in accordance with the analysis in GUI 4900 (FIG. 49) and GUI 5000, the user selects an affirmative response in a pull-down box 5021.

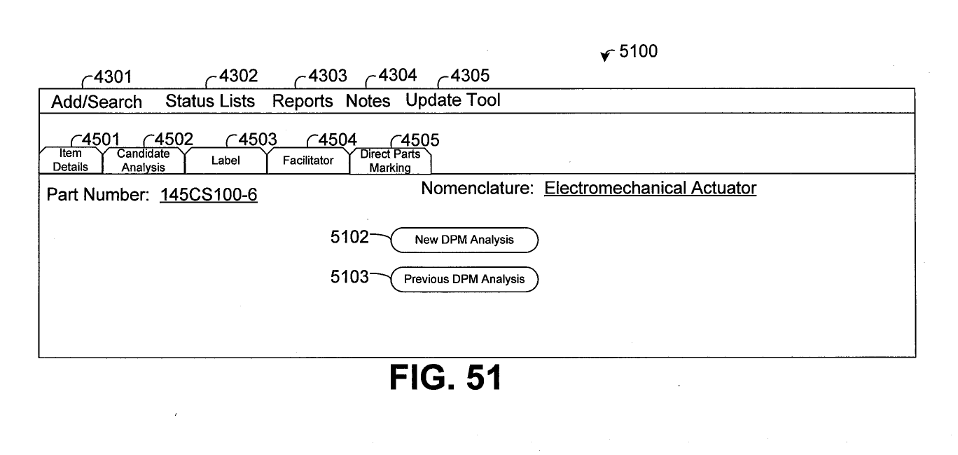

If the user determines that the part may be able to be marked with DPM, the user may select the “Direct Parts Marking” button 4505 and the PMSL 4107 displays the GUI 5100 depicted in FIG. 51. The GUI 5100 comprises a “New DPM Analysis” button 5102 and a “Previous DPM Analysis” button 5103. Such links 5102 and 5103 behave similarly to button 4701 and 4702 described with reference to FIG. 47.

If the user selects link 5102, the PMSL 4107 displays a GUI such as the one depicted in FIG. 31. Note that the GUI 9060 depicted in FIG. 31 comprises data entry fields for performing a DPM analysis, and is described with reference to FIG. 31. In this regard, FIGS. 31-38 describe a DPM analysis with respect to an identified part, including a FMEA (FIG. 38).

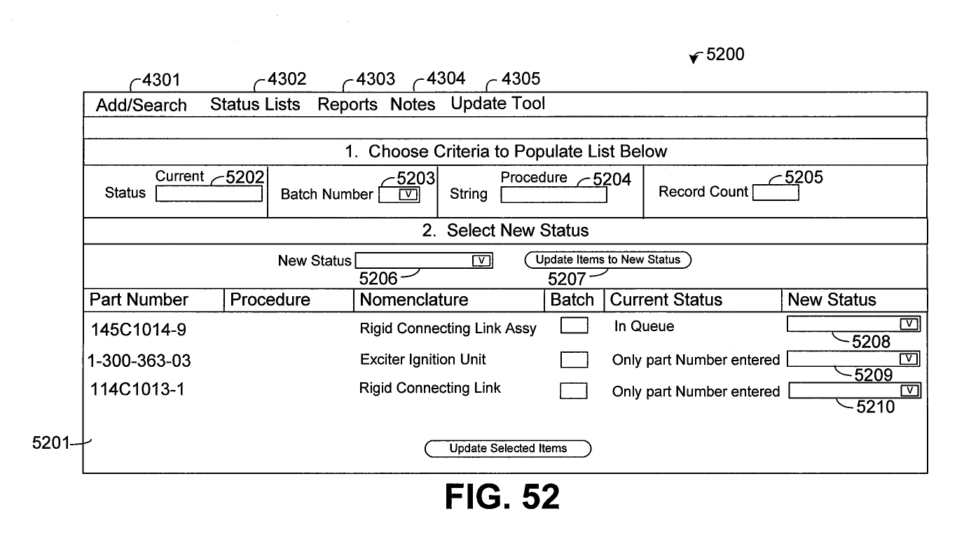

If the user selects the “Update Tool” button 4305, the PMSL 4107 displays GUI 5200 depicted in FIG. 52. The GUI 5200 enables the user to change the status of a part and/or the batch in which the part is included. In this regard, the user may retrieve a list of part numbers in box 5201 by searching the parts marking database 4108.

The user may search for parts having a particular status by entering data in text box 5202. For example, the user may desire to find all parts in the parts marking database 4108 for which only the part number has been entered. The user enters the string “Only part Number Entered,” and the PMSL 4107 displays a list of parts for which only the part number has been entered in box 5201. Likewise, the user may search on a particular group identifier, i.e., a batch number, by selecting or entering data in a pull-down field 5203 or may search for part numbers associated with a particular procedure by entering data in a text field 5204. The PMSL 4107 displays in a text field 5205 the number of records retrieved in response to any search.

The user may change the status of all the parts listed or a select number of parts listed. In this regard, the user may select a new status identifier from a pull-down box 5206 and select the “Update Items to New Status” button 5207, and the PMSL 4107 changes the “Current Status” of all parts in the list in 5201 to the new status selected.

Alternatively, the user may change each part number status by selecting from pull-down boxes 5208-5210 a new status identifier per part listed. Once the new identifiers are selected, the PMSL 4107 updates the “Current Status” identifiers to the statuses selected, when the user selects the “Update Selected Items” button 5211. In addition, other fields, e.g., the “Batch” column, associated with the parts listed may be updated using the described procedure.

Once the parts marking analysis client 4115 has performed an analysis of a part and stored the recommendations and/or analysis for the part, a parts marking client 4101 can print a label for a particular identified part in the field.

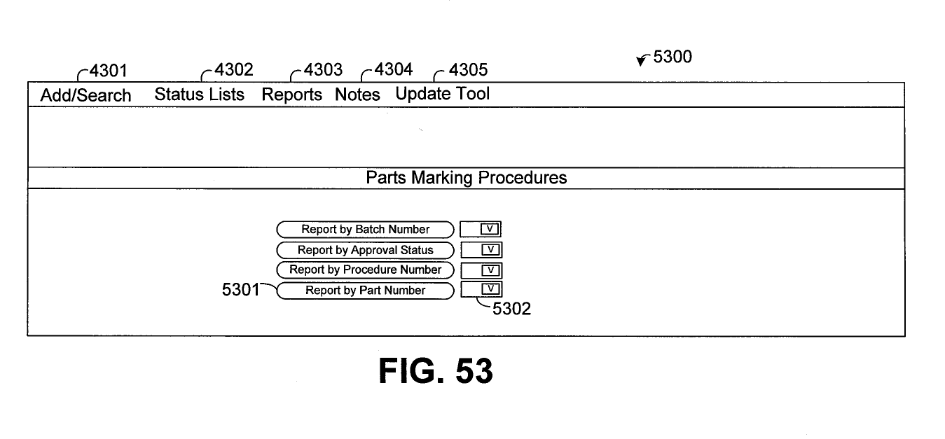

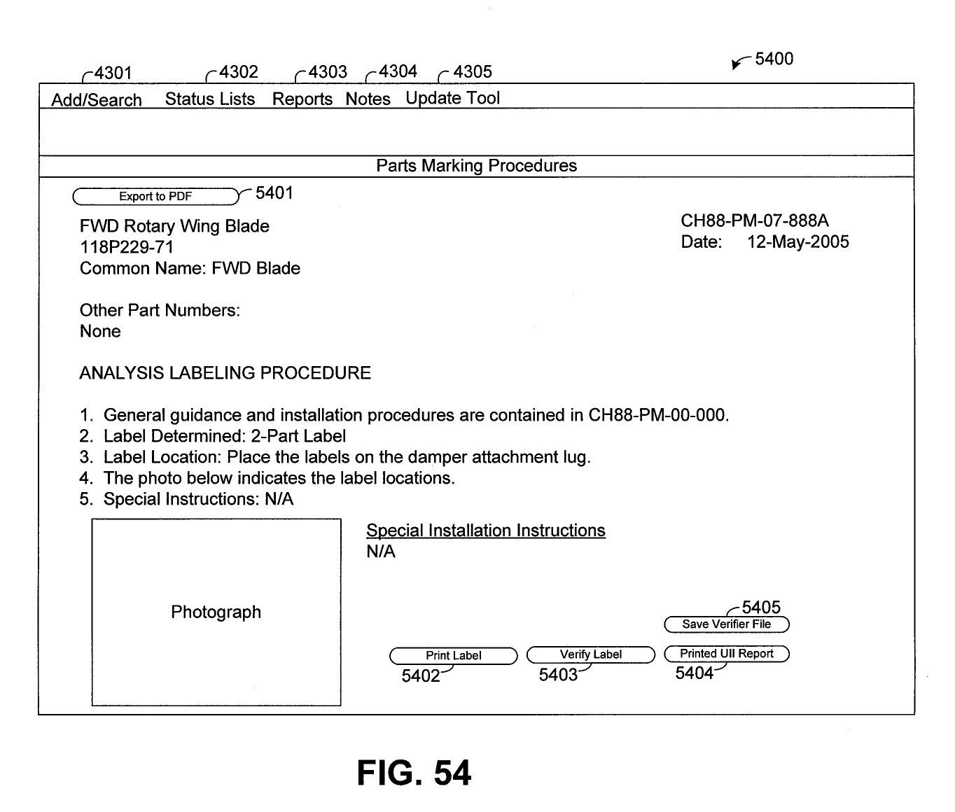

In this regard, the user may select the “Reports” button 4303, and the part marking server logic 4107 displays the GUI 5300 depicted in FIG. 53. The user may enter or select a part number in text field 5302 and select a “Report by Part Number” button 5301. In response, the PMSL 4107 displays the GUI 5400 depicted in FIG. 54.

GUI 5400 displays a field procedure for the part for which the user desires to obtain a label or other field procedures. The user may export the field procedure displayed to a PDF file by selecting button 5401.

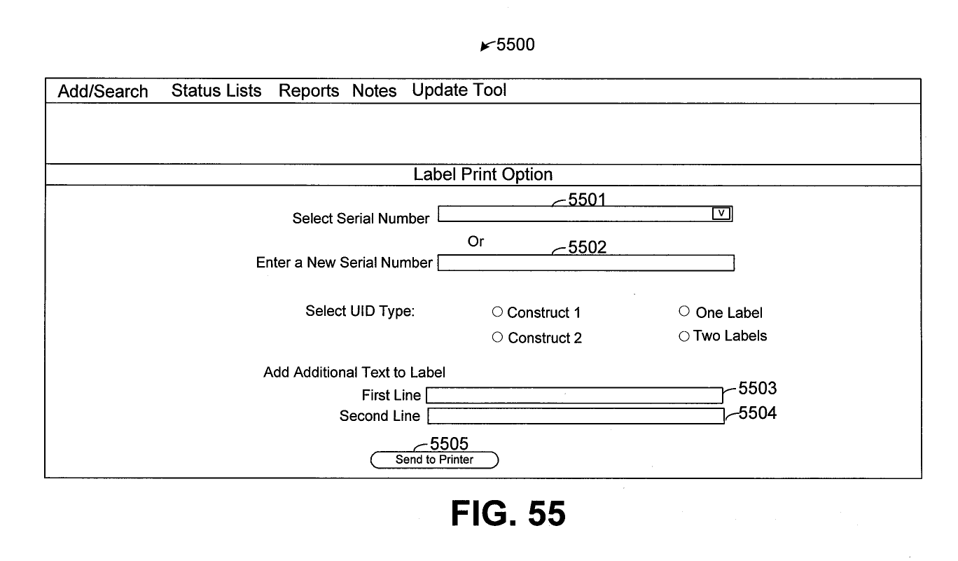

In addition, the user may desire to print a label (not shown) for application to a part (not shown). To print a label, the user selects the “Print Label” button 5402. The PMSL 4107 displays GUI 5500 depicted in FIG. 55. GUI 5500 comprises a pull-down box 5501 in which the user may search for a serial number for the part being marked or the user may enter into a text box 5502 a new serial number.

Based upon an entity's implementation data 2800 (FIG. 2), the user may select “Construct 1” or “Construct 2” select button and the user may select a one-label or a two-label select button as appropriate. In addition, the user may enter data in text boxes 5503 and 5504 that the PMSL 4107 prints to the label.

When the user selects a “Send to Printer” button 5505, the PMSL 4107 generates a UII based upon the serial number entered and other identifying parts data. The PMSL 4107 transmits the UII to the registry 4105 (FIG. 41), and the registry 4105 responds by indicating whether the UII is in the unique identifier database 4106 (FIG. 41).

If the identifier is not in the database 4106, the registry 4105 registers the UII in the database 4106 and responds to the PMSL 4107 that the UII is valid. The PMSL 4107 then enables the label to be printed by the printer 4111 (FIG. 41).

The PMSL 4107 automatically closes GUI 5500 and returns the user to GUI 5400. At the GUI 5400, the user may verify that the label printed correctly. In this regard, the user may select the “Verify Label” button 5403 and scan the identifier printed out on the label, e.g., a 2-D matrix, with the scanner 4112 (FIG. 41). In this regard, the scanner 4112 receives data indicative of the identifier and determines whether the identifier meets quality standards and is a compliant UII, e.g., exhibiting compliant syntax and/or format and are appropriately concatenated.

Further, the user may save data indicative of the verified identifier resulting from the scan by selecting the “Save Verifier File” button 5405. If the user desires, the user can print the data verifying the identifier by selecting the “Printed UII Report” link 5404, which prints data indicative of the scan verification.

With reference to the “Item Details” GUI 4500 in FIG. 45, the GUI 4500 displays a part number, e.g., “Part Number 145C1014-9,” and text fields that may be populated with data. Such text fields may include, for example, the “NSN” text field, the “Label Nomenclature” text field, etc. The text fields either exhibit or receive data that describes the part number identified. Furthermore, in one embodiment, the text fields shown, e.g., “NSN,” “Cage Code,” etc., exhibit a particular color, e.g., white.

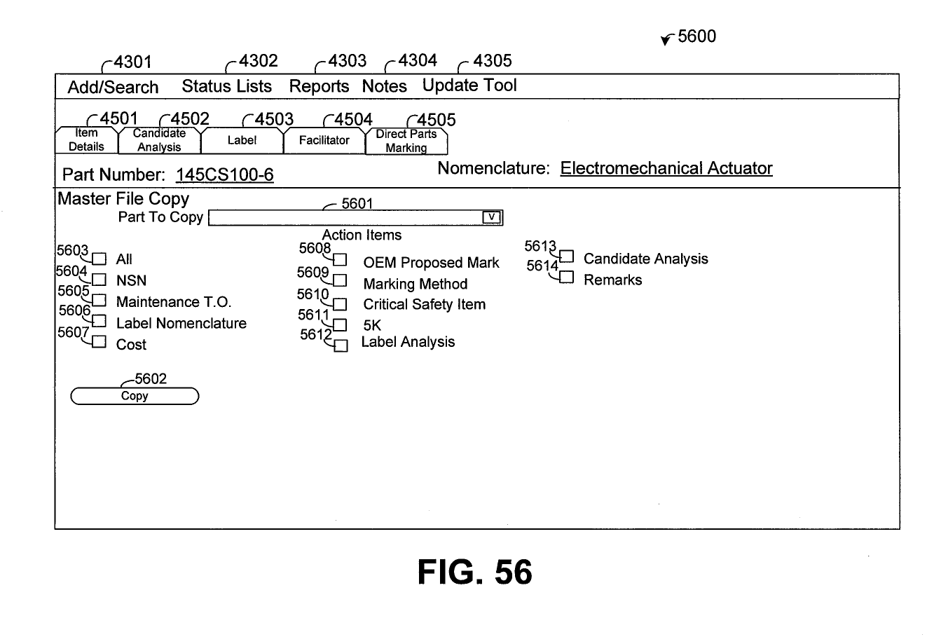

When a user selects the “Facilitator” button 4504, PMSL 4107 displays the GUI 5600 depicted in FIG. 56. Note that the GUI 5600 displays the part number from the “Item Details” GUI 4500.

The Facilitator GUI 5600 comprises a pull-down button 5601, a plurality of identifier boxes 5603-5614, and a “Copy” button 5602. When the user pulls down the pull-down button 5601, the PMSL 4107 displays a plurality of part numbers. The user selects a part number from the pull-down button 5601 and selects the “All” identifier button 5603 or one or more identifier boxes 5604-5611.

If the user selects the “All” identifier button 5603, the PMSL logic 4107 automatically places an indicator in each of the remaining boxes 5604-5614. When the user selects the “Copy” button 5602, the data associated with each of the boxes selected is copied into its respective text field, if a text field exists, in the “Item Details” GUI 4500 in FIG. 45 for part number 145C1014-9. In addition, all data stored in the database 4108 associated with the selected boxes is copied into the record of the part number, e.g., part number 145C1014-9. As an example, if the “Candidate Analysis” box 5613 is selected, either individually or by selection of the “All” button 5603, all data associated with the candidate analysis is stored in the database 4108 for the record of the part number 145C1014-9.

When data is copied to a text field when the button 5602 is selected, the text field into which the data is copied changes color and/or state, e.g., the text fields in GUI 4500 may be orange once data is copied from the “Facilitator” GUI 5600.

If the user selects one or more of the identifier boxes 5604-5611 and the “Copy” button 5602, the PMSL logic 4107 copies data associated with the one or more selected identifier boxes into their respective field in the “Item Details” GUI 4500 in FIG. 45.

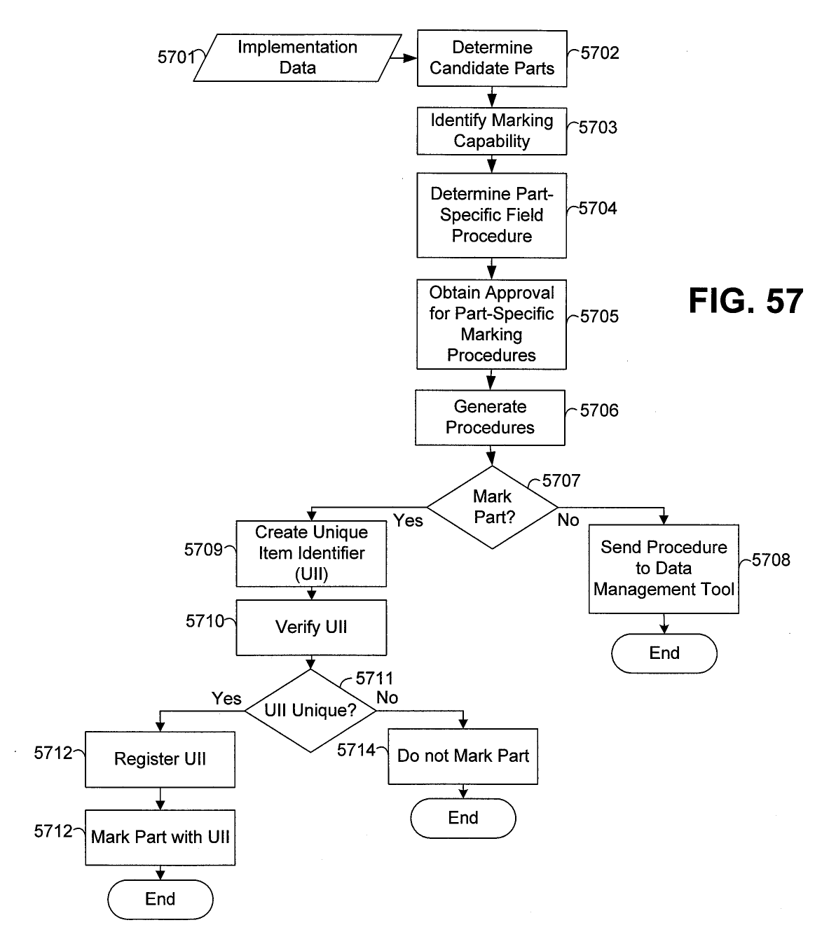

FIG. 57 is a flowchart illustrating exemplary architecture and functionality of the parts marking server system 4100 as depicted in FIG. 41. As indicated in step 5701, the parts marking server system 4100 receives implementation data 2800 (FIG. 2) that may be gathered before an analysis as performed by the parts marking server system 4100.

As described hereinabove with reference to FIG. 2, and repeated here for clarity, implementation data 2800 refers to data describing an entity's part marking strategy including, but not limited to, data identifying all parts inventory of a particular entity, the type of marking that the entity employs, e.g., labels and/or direct parts marking, and data identifying those criteria that the entity uses to determine whether a part is to be marked, e.g., whether the part is serially tracked, the cost of the part, etc.

In one embodiment, the implementation data 2800 comprises the inventory of parts data 4109 (FIG. 41), which is data identifying the parts making up the inventory of the entity for which an analysis is to be performed.

As indicated in step 5702, the parts marking server system 4100 determines from the inventory of parts data 4109 a subset that includes candidate parts data 4110. Notably, the PMSL 4107 receives data via GUI 4600 (FIG. 46) for determining per part within the inventory of parts 4109, which parts are to be marked in accordance with criteria promulgated by the entity, e.g., whether the part is serially tracked, whether the cost of the part is greater than $5,000, etc., as described with reference to FIG. 46. In this regard, in response to a user's responses to queries reflecting the entity's criteria, the parts marking server system 4100 determines whether the part under analysis is to be marked or not marked and those parts that are to be marked are stored as candidate parts data 4110.

In addition, from the implementation data 2800, the marking capability of the entity is determined, as indicated in step 5703. As an example, an entity may only select to mark candidate parts (not shown) with a label. In this regard, the parts marking server system 4100 would make available only those portions of the system 4100 that relate to a label analysis.

Thereafter, the parts marking server system 4100 determines specific parts marking field procedures, as indicated in step 5704. In this regard, the parts marking server system 4100 receives data indicative of when a part is to be marked, where on the part the part is to be marked, where, geographically, the part will be when it is to be marked, and how to mark the part, i.e., a label or DPM, for example.

Thus, in step 5704, the part-specific field procedure options may be determined by receiving data indicative of the aforedescribed marking characteristics via the GUIs described with reference to the PMS 100 in FIGS. 4-40 or the GUIs described with reference to the parts marking server system 4100 in FIGS. 41-55.

Once the field procedure is determined in step 5704, approval is obtained for the part-specific field procedure from an approving authority, as indicated in step 5705. Such approval may be tracked via the GUI 5200 depicted in FIG. 52.

Once approval is received, the parts marking server system 4100 generates field procedures, as indicated in step 5706. As described hereinabove, such field procedures may be in the form of an HTML file, as illustrated in FIG. 54.

If the part is to be marked, as indicated in step 5707, the parts marking server system 4100 creates a unique item identifier (UII), as indicated in step 5709. Note that the UII may be created by concatenating the serial number, or a portion of the serial number, with other part-identifying data, e.g., the NSN number or the CAGE code.

In step 5710, the parts marking server system 4100 verifies the UII. In this regard, the parts marking server 4104 (FIG. 41) transmits a request to the unique identifier registry server 4105 (FIG. 41) to verify the UII. The UII logic 4113 (FIG. 41) searches the UII database 4106 (FIG. 41), and if the logic 4113 finds the UII already in the database 4106, it transmits a message to the parts marking server 4104 that the UII already exists. If it does not find the UII in the database 4106, it transmits a corresponding message to the parts marking server 4104.

If the UII is unique in step 5711, the registry server 4104 registers the UII in the database 4106, as indicated in step 5712. Further, the parts marking sever 4104 enables a user to mark a part based upon the message received from the registry server 4105, as indicated in step 5713. However, if the UII is not unique, the parts marking server 4104 does not indicate to a user that the part can be marked with the UII provided, as indicated in step 5714.

If the part is not yet to be marked, as indicated in step 5707, the parts marking server system 4100 transmits the field procedure generated in step 5706 to a data management tool, as indicated in step 5708. In this regard, a data management tool refers to a system that manages parts marking for an entity, e.g., the government. Exemplary data management tools may include Lockheed martin's I-Guides™, Future Works' I²M™, A2B's UID Comply!™, and InfinID's idWorx™.

1. A parts marking system, comprising:
memory for storing data indicative of at least one algorithm associated with at least one direct parts marking (DPM) technique;
logic configured to display a graphical user interface comprising at least one text field associated with at least one function, functional failure, failure mode, and failure effect associated with the at least one DPM technique.

2. The parts marking system of claim 1, wherein the logic is further configured to receive data in response to parts marking criteria queries and display at least one DPM technique based upon the received data.

3. The parts marking system of claim 2, wherein the logic is further configured to scrollably display a plurality of DPM technique limitation queries corresponding to a plurality of DPM techniques based upon a user input.

4. The parts marking system of claim 3, wherein the logic is further configured to indicate whether at least one DPM technique is possible based upon a user response to at least one of the DPM technique limitation queries.

5. The parts marking system of claim 1, wherein the logic is further configured to receive data indicating consequences associated with the failure mode and the failure effect.

6. The parts marking system of claim 1, wherein the logic is further configured to indicate, based upon the consequences, whether a risk associated with the consequence is acceptable.

7. The parts marking system of claim 1, wherein the logic is configured to scrollably display the at least one text field associated with the at least one function, functional failure, failure mode, and failure effect associated with the at least one DPM technique based upon the area of the part under analysis.

8. The parts marking system of claim 1, wherein the logic is further configured to store data indicative of at least one consequence associated with the at least on failure mode and failure effect displayed.

9. The parts marking system of claim 1, wherein the logic is further configured to generate a parts marking procedure for at least one part based upon data received in the at least one text field associated with the at least one function, functional failure, failure mode, and failure effect associated with the at least one DPM technique.

10. The parts marking system of claim 9, wherein the logic is further configured to store a plurality of parts marking procedures associated with the at least one part and display a list of identifiers corresponding to the plurality of stored parts marking procedures based upon a user input.

11. The parts marking system of claim 10, further comprising a registry server, wherein the logic is configured to receive a serial number identifying the part, generate a unique item identifier (UII) associated with the part, and transmit a verification request for the UII generated.

12. The parts marking system of claim 11, wherein the logic is further configured to enable printing of a label if the registry indicates that the UII is verified.

13. The parts marking system of claim 11, wherein the logic is further configured to display a message indicating that the UII was not verified if the registry indicates that the UII is not valid.

14. The parts marking system of claim 1, wherein the logic is configured to retrieve data indicative of a plurality of parts and select candidate parts from the plurality of parts based upon at least one response to a query.

15. The parts marking system of claim 14, wherein the logic is configured to display a recommendation to mark one of the plurality of parts based upon the response.

16. A parts marking method, comprising:
storing data indicative of at least one algorithm associated with at least one direct parts marking (DPM) technique;
displaying a graphical user interface comprising at least one text field associated with at least one function, functional failure, failure mode, and failure effect associated with the at least one DPM technique.

17. The parts marking method of claim 15, further comprising the step of receiving data in response to parts marking criteria queries and display at least one DPM technique based upon the received data.

18. The parts marking method of claim 17, wherein further configured to scrollably display a plurality of DPM technique limitation queries corresponding to a plurality of DPM techniques based upon a user input.

19. The parts marking method of claim 18, further comprising the step of indicating whether at least one DPM technique is possible based upon a user response to at least one of the DPM technique limitation queries.

20. The parts marking method of claim 16, further comprising receiving data indicating consequences associated with the failure mode and the failure effect.

21. The parts marking method of claim 16, further comprising the step of indicating, based upon the consequences, whether a risk associated with the consequence is acceptable.

22. The parts marking method of claim 16, further comprising the step of scrollably displaying the at least one text field associated with the at least one function, functional failure, failure mode, and failure effect associated with the at least one DPM technique based upon an area of the part under analysis.

23. The parts marking method of claim 16, further comprising the step of storing data indicative of at least one consequence associated with the at least on failure mode and failure effect displayed.

24. The parts marking method of claim 16, further comprising the step of generating a parts marking procedure for at least one part based upon data received in the at least one text field associated with the at least one function, functional failure, failure mode, and failure effect associated with the at least one DPM technique.

25. The parts marking method of claim 24, wherein the logic is further configured to store a plurality of parts marking procedures associated with the at least one part and display a list of identifiers corresponding to the plurality of stored parts marking procedures based upon a user input.

26. The parts marking method of claim 25, further comprising the steps of
receiving a serial number identifying the part;
generating a unique item identifier (UII) associated with the part; and
transmitting a verification request for the UII generated.

27. The parts marking method of claim 26, further comprising the step of enabling printing of a label if a registry indicates that the UII is verified.

28. The parts marking system of claim 26, further comprising the step of displaying a message indicating that the UII was not verified if a registry indicates that the UII is not valid.
